(19) United States
(12) Patent Application Publication
(10) Pub. No.: US 2026/0059147 A1
(43) Pub. Date: Feb. 26, 2026

(54) VIDEO DECODER AND ENCODER USING A SPECIAL NEIGHBORHOOD SIGNAL, VIDEO DECODER AND ENCODER APPLYING A POST-PROCESSING ONLY TO CERTAIN INTER-PREDICTED BLOCKS, PICTURE-PROCESSING TOOL AND METHODS

(71) Applicant: FRAUNHOFER-GESELLSCHAFT ZUR FOERDERUNG DER ANGEWANDTEN FORSCHUNG E.V., Muenchen (DE)

(72) Inventors: Martin WINKEN, Berlin (DE); Philipp MERKLE, Berlin (DE); Jonathan PFAFF, Berlin (DE); Heiko SCHWARZ, Berlin (DE); Detlev MARPE, Berlin (DE); Thomas WIEGAND, Berlin (DE)

(21) Appl. No.: 19/313,981

(22) Filed: Aug. 29, 2025

Related U.S. Application Data
(63) Continuation of application No. PCT/EP2024/054854, filed on Feb. 26, 2024.

(30) Foreign Application Priority Data
Mar. 2, 2023 (EP) 23159732.9

(51) Int. Cl. H04N 19/85; H04N 19/119; H04N 19/132; H04N 19/172; H04N 19/176; H04N 19/436; H04N 19/503; H04N 19/593

(52) U.S. Cl. CPC H04N 19/85; H04N 19/119; H04N 19/132; H04N 19/172; H04N 19/176; H04N 19/436; H04N 19/503; H04N 19/593

(57) ABSTRACT

Video decoder and encoder using a neighborhood signal generated by using a contribution signal in a version not post-processed and/or substituting a contribution signal by a substitute signal generated independent from spatial signal-interdependencies. Picture-processing tool configured to polyphase-wisely split luma samples and subject a tensor of cascaded matrices of the polyphase-components to a neural network or a convolution. Video decoder and encoder applying a post-processing only to certain inter-predicted blocks.

### CROSS-REFERENCE TO RELATED APPLICATIONS

This application is a continuation of copending International Application No. PCT/EP2024/054854, filed Feb. 26, 2024, which is incorporated herein by reference in its entirety, and additionally claims priority from European Application No. EP 23159732.9, filed Mar. 2, 2023, which is also incorporated herein by reference in its entirety.

Embodiments relate to a video decoder and a video encoder using a special neighborhood signal, a video decoder and a video encoder applying a post-processing only to certain inter-predicted blocks, a picture-processing tool and methods.

### BACKGROUND OF THE INVENTION

Video sequences typically have a high degree of both spatial and temporal redundancy. All relevant approaches to the compression (i.e. efficient representation) of video signals are based on exploiting those redundancies. The temporal redundancy is exploited by motion-compensated (or inter) prediction, which is a core component of all video coding standards. In the evolution of those standards, ranging from H.261 [1], first ratified in November 1988, to Versatile Video Coding (VVC) [2], [3], inter prediction has been enhanced in many ways. Typically, these enhancements were aimed at improving the motion-compensated prediction signal and thus increasing the overall coding performance. For example, it is a well-established finding that by superimposing two individual prediction signals, the resulting prediction error variance can be reduced [4]. Thus, a simple averaging of the two predictors has been used since the introduction of the MPEG-1 standard [5] in 1991. The H.264/AVC video coding standard [6] introduced so-called weighted prediction, where a weighting factor can be transmitted at slice level for each reference picture.

In the current state-of-the-art standard VVC, several further enhancements to inter prediction have been made. The simple averaging in bi-prediction can be replaced by Bi-prediction with CU Weights (BCW) [7]. For the block-based bi-prediction, there is a sample-wise refinement called Bi-Directional Optical Flow (BDOF) [8], [9]. Furthermore, there is subblock-based inter prediction, where for each subblock an individual motion vector is derived. This includes subblock-based Temporal Motion Vector Prediction (SbTMVP) [9], Decoder-side Motion Vector Refinement (DMVR) [9], and Affine Motion Compensation (AMC) [9]. For the latter, there also is a sample-wise refinement called Prediction Refinement with Optical Flow (PROF) [9]. Moreover, the Geometric Partitioning Mode (GPM) [7] adds support for non-rectangular partitions. In order to jointly exploit temporal and spatial redundancies, VVC introduces Combined Inter/Intra Prediction (CIIP) [7], which additionally uses adjacent samples from neighboring blocks.

During the development of VVC, another method that incorporates spatially neighboring samples into a temporally predicted block has been studied in detail. This method is known as Local Illumination Compensation (LIC) [10], [11] and is conceptually based on the Illumination Compensation (IC) coding tool of the 3D extension of the High Efficiency Video Coding (HEVC) standard [12], [13]. With LIC, a scale and an offset value are derived at the decoder to adjust the luminance of an inter prediction block to that of the top and left neighboring reconstructed samples. However, due to its impact on decoding complexity, LIC has not become part of VVC.

Herein, based on previous work [14], a spatio-temporal residual network (STRN) is proposed. The main idea of STRN is to refine the inter prediction signal without any additional signaling, by using a convolutional neural network (CNN) that incorporates information from spatially neighboring blocks. The corresponding sample data are stitched together, forming the input tensor of the CNN. The output tensor contains the refined prediction signal. STRN is integrated into the VVC test model (VTM), the reference software of the VVC standard.

The main contributions of this work are as follows:
A polyphase decomposition is applied to a picture signal representation or a video signal representation. It is shown that this results in an improved trade-off between computational complexity and coding performance.
The CNN is moved out of the intra decoding loop. This enables parallel application of the CNN for all blocks within one picture at the decoder, independent of intra predicted blocks. Otherwise, i.e. with the CNN within the intra decoding loop, this would have been conceptually impossible, thus enforcing a sequential processing at the decoder, which is practically prohibitive.
The CNN is studied in detail within the context of a low-delay prediction structure. It is found that for long prediction chains, repeated application of the CNN can in some cases have negative impact on the compression efficiency. It is shown how this problem can be mitigated without impact on the random access (RA) coding performance, e.g., by using the CNN only for certain inter-predicted blocks.

For many image processing tasks, in particular those which are commonly subsumed under the term computer vision, approaches based on deep learning have been successfully applied in recent years. A particularly import class of such approaches are convolutional neural networks (CNNs). One of the earliest CNNs was the so-called LeNet, initially proposed by Y. LeCun in 1989, for the automated recognition of ZIP code numbers [15]. In the following decades, CNNs have been applied to various image processing tasks, such as object recognition, picture classification and segmentation, image restoration and denoising, and many others.

In recent years, CNNs have also been proposed for video coding. Here, two different categories have to be distinguished. The first category are so-called end-to-end optimized compression methods like [16]-[18], where the classical architecture of a hybrid video codec is replaced by a combination of encoder and decoder networks that are jointly optimized according to a common rate-distortion loss function. In the second category, the basic framework of a conventional hybrid video codec is kept, but a neural network is used for specific coding tools, like interpolation filtering [19], [20], intra prediction [21], [22], quantization [23], or loop filtering [24]-[26]. Since the herein proposed method belongs to this second category, related work from this category is discussed in more detail below, with a focus on inter prediction. An overview over various approaches of neural network based video compression can be found in [27], [28].

In [29], Huo et al. propose a CNN-based motion compensation refinement (CNNMCR) scheme. There are two variants of CNNMCR: In the simple variant, the inter prediction signal is fed into a CNN, and the output of the CNN is the refined prediction signal. In the extended variant, an enlarged block, also consisting of already reconstructed neighboring samples, is used as the input of the CNN. For each quantization parameter (QP), a distinct model is trained.

In [30], Wang et al. describe a neural network based inter prediction (NNIP) algorithm, employing a combination of a fully connected network (FCN) and a CNN. Similar to [29], the output of the networks is the refined inter prediction signal, and reconstructed neighboring samples are incorporated into the input of the networks. However, [30] additionally uses neighboring samples of the temporal reference block for the input. An improved version of NNIP is presented in [31]. Here, the network architecture is changed, such that three instead of two neural networks are used in combination. In [30] and [31], a distinct model is trained for each combination of QP and block shape.

In [32], Zhao et al. propose a CNN-based fusion scheme. It is applied only for bi-prediction and replaces the averaging of the two predictors. Input to the network are the two constituent motion-compensated prediction signals and its output is the combined inter prediction signal. For each QP, a distinct model is trained.

In [33], Mao et al. present a CNN-based bi-prediction utilizing spatial information, called SICNN. Conceptually, SICNN can be viewed as a combination of ideas originating from [30], [31] and [32]: Like [32], the two constituent prediction signals of bi-prediction are used for the input of the CNN. Like [30], [31], the corresponding blocks are enlarged to also include top/left spatially neighboring samples. The output of the CNN is the refined bi-prediction signal. Again, for each QP, a distinct model is trained for SICNN. In [34], Mao and Yu extend their work of [33] to also include temporal distance information in the input of the CNN.

In [35], Zhang et al. describe a CNN-based inter prediction refinement method for the AVS3 standard [36]. This work is based on the work [30], but uses a CNN instead of the FCN, in order to allow application of the network to all block shapes. Furthermore, no spatially neighboring samples are used in [35]. Still, for each QP, a distinct model is trained.

In [37], Jin et al. propose a deep affine motion compensation network (DAMC-Net) which is based on the AMC method of VVC. Input to the network are the AMC prediction, the initial motion vector field, and the reference block. Output of the network is the refined AMC prediction signal. Like in [29]-[31], [33], [34], the input block is enlarged to also include top/left neighboring samples. For each combination of block shape and QP, a distinct network model is trained.

In previous work [14], an intra-inter prediction residual convolutional neural network (IPRN) is presented. The architecture of IPRN is based on [33], [34]. Accordingly, the input to the network includes the inter prediction signal together with the two constituent prediction signals of bi-prediction and is likewise extended by top/left neighboring samples. Other than most related work, IPRN is based on VVC and uses a single network model for all block shapes and QP values. In addition, different training loss functions are studied in [14]. It is found that the sum of absolute transformed differences (SATD), i.e. the ‘1-norm in the DCT domain, results in a better coding performance than the commonly used sum of squared differences (SSD) and sum of absolute differences (SAD), which operate in the spatial domain.

Most of the methods discussed above, namely [29]-[31], [33], [34], [37], as well as previous work [14], use reconstructed top/left neighboring samples for the input of the neural network. This has big implications for practical implementation of the decoder. Firstly, and most significantly, the network cannot be applied in parallel to the affected blocks of one picture. Instead, the blocks have to be fed sequentially through the network. This is caused by the fact that the input of the network depends on the reconstructed neighboring samples, and therefore on the output of the network for these blocks. Secondly, by referring to reconstructed neighboring samples, a CNN refined inter block may now depend on the output of intra prediction, if at least one of its top/left neighboring blocks happens to be intra predicted. Both aforementioned aspects have the effect that the CNN-based inter prediction becomes part of the so-called intra decoding loop. This is a complete break with existing video codec design principles. In all video coding standards, including VVC, the inter prediction can be performed in parallel at the decoder for all inter blocks of one picture, after the corresponding motion vectors have been determined. This becomes impossible with such a change.

Herein, STRN is proposed, a spatio-temporal residual CNN for enhanced inter prediction. As a distinct feature, while still incorporating neighboring samples, the network is moved out of the intra decoding loop. Therefore, the herein described solution allows parallel processing of the CNN for all affected blocks of one picture at the decoder. Intra prediction and CNN processing can also be done in parallel at the decoder with STRN. This aspect, which has a significant impact on practical implementation, has not been addressed before in the literature related to CNN-based inter prediction. Moreover, most of the previously discussed methods employ a separate CNN model for each block shape and/or QP value. In contrast, STRN uses a single CNN model for all block sizes and QP values.

### SUMMARY

An embodiment may have a picture-processing tool configured to polyphase-wisely split luma samples of a picture portion into polyphase-components to obtain a matrix per polyphase-component, and form a tensor by cascading the matrices of the polyphase-components, and subject the tensor to a neural network or a convolution with associating the matrices as different channels so as to obtain an output tensor composed of a concatenation of output matrices including one output matrix per polyphase-component, and form, by inverse polyphase decomposition, a processed picture portion based on the output tensor.

According to another embodiment, a method for processing a picture may have the steps of: polyphase-wisely splitting luma samples of a picture portion into polyphase-components to obtain a matrix per polyphase-component, and forming a tensor by cascading the matrices of the polyphase-components, and subjecting the tensor to a neural network or a convolution with associating the matrices as different channels so as to obtain an output tensor composed of a concatenation of output matrices including one output matrix per polyphase-component, and forming, by inverse polyphase decomposition, a processed picture portion based on the output tensor.

Another embodiment may have a non-transitory digital storage medium having a computer program stored thereon to perform the inventive method when said computer program is run by a computer.

In accordance with a first aspect of the present invention, the inventors of the present application realized that one problem encountered when processing a current picture portion depending on preceding picture portions stems from the fact that the neighboring picture portion has to be processed before the current picture portion can be processed. According to the first aspect of the present application, this difficulty is overcome by generating a neighborhood signal, which is independent from spatial signal-interdependencies, e.g., by excluding signals with a spatial signal-interdependency and/or by substituting signals with a spatial signal-interdependency with a substitute signal being independent from spatial signal-interdependencies and/or by using signals in a version not post-processed dependent from spatial signal-interdependencies. The inventors found, that it is advantageous to form or generate the neighborhood signal with the constrained spatial reference samples, since this enables to decouple the processing of the current picture portion from a sequential spatial processing of picture portions, which depends on already reconstructed neighboring samples. Thus, it is possible to process a plurality of picture portions, for which the respective neighborhood signal is generated independent from spatial signal-interdependencies, in parallel instead of sequentially. This is based on the idea that the herein introduced neighborhood signal enables a processing of the current picture portion dependent on its spatial neighborhood without the spatial neighborhood having to be fully reconstructed before the current picture portion is processed. By being able to consider the spatial neighborhood at a parallel processing of picture portions a high encoding/decoding efficiency and especially a high coding performance can be achieved.

Accordingly, in accordance with a first aspect of the present application, a video decoder/encoder comprising a plurality of decoding/encoding tools is configured to block-wisely apply, e.g., controlled by a data stream, the plurality of decoding/encoding tools onto a current picture of a video. A reconstructed signal of the currently decoded/encoded picture is derivable, e.g., the video decoder is configured to derive the reconstructed signal, by a sample-wise combination of contribution signals generated by the plurality of decoding/encoding tools. The plurality of decoding/encoding tools comprises a first predetermined decoding/encoding tool configured to, based on a neighborhood signal in a spatial neighborhood of a current block, perform a post-processing of a signal associated with the current block or perform a generation of a signal associated with the current block. At the post-processing, the first predetermined decoding/encoding tool is configured to post-process a contribution signal of one or more second predetermined decoding tools within the current block, or post-process an intermediate signal within the current block, corresponding to a partial combination out of the sample-wise combination. The intermediate signal, for example, may correspond to a sample-wise combination of two or more of the contribution signals generated by the plurality of decoding/encoding tools. These two or more contribution signals may be generated by the one or more second decoding/encoding tools, but it is also possible that they are generated by one or more other decoding/encoding tools of the plurality of decoding/encoding tools. At the generation, the first predetermined decoding/encoding tool is configured to generate a contribution signal of the first predetermined decoding/encoding tool for the current block. Further, the video decoder/encoder is configured to generate the neighborhood signal in the spatial neighborhood by using a contribution signal of the one or more second predetermined decoding/encoding tools or an intermediate signal within the spatial neighborhood in a version not post-processed by the first predetermined decoding/encoding tool and/or substituting a contribution signal of one or more third predetermined decoding/encoding tools within the spatial neighborhood, by a substitute signal generated independent from spatial signal-interdependencies, and/or excluding from the spatial neighborhood samples for which the sample-wise combination for the derivation of the reconstructed signal involves the contribution signal of the one or more third predetermined decoding/encoding tools.

This, first aspect is applicable to different decoding/encoding tools, like a spatio-temporal residual network (STRN) tool, a local illumination compensation (LIC) tool, a combined inter/intra prediction (CIIP) tool, a residual sign prediction (RSP) tool and/or a template matching (TM) tool. It is possible that that two or more of these decoding/encoding tools are used or comprised by the video decoder/encoder.

According to an embodiment, the first predetermined decoding/encoding tool may be a STRN tool configured to post-process the contribution signal, i.e. an inter-prediction signal, of the one or more second predetermined decoding/encoding tools, i.e. one or more inter-prediction tools, or post-process the intermediate signal, i.e. a sample-wise combination of two or more inter-prediction signals generated by the one or more inter-prediction tools. The post-processing may be performed by using a neural-network or a convolution, e.g., by subjecting a tensor to the neural-network or to a convolution. For example, the STRN tool may be configured to post-process the contribution signal or the intermediate signal based on a 3D tensor comprising one or more matrices derived from corresponding portions in one or more references pictures and comprising one or more matrices derived from the contribution signal accompanied by the neighborhood signal or derived from the intermediate signal accompanied by the neighborhood signal. The 3D tensor may represent an input to the neural-network or to the convolution. The corresponding portions in the one or more references pictures, for example, represent portions being similar to the current block, i.e. a current portion, which can be found in the reference pictures. The corresponding portions in the one or more references pictures may be indicated or derived using one or more motion vectors derived/encoded from/into a data stream. It might be that there is only one corresponding portion present within a reference picture or that there are two or more corresponding portions present within a reference picture. Further, the video decoder/encoder comprising the STRN tool may be configured to generate the neighborhood signal in the spatial neighborhood of the current block by
using a contribution signal, i.e. an inter-prediction signal, of the one or more second predetermined decoding/encoding tools, i.e. the one or more inter-prediction tools, or an intermediate signal, i.e. a sample-wise combination of two or more inter-prediction signals generated by the one or more inter-prediction tools, within the spatial neighborhood, in a version not post-processed by the STRN tool and/or
substituting a contribution signal, i.e. an intra-prediction signal, of one or more third predetermined decoding/encoding tools, i.e. one or more intra-prediction tools, within the spatial neighborhood, by a substitute signal generated independent from spatial signal-interdependencies, and/or
excluding from the spatial neighborhood samples for which the sample-wise combination for the derivation of the reconstructed signal involves the contribution signal, i.e. the intra-prediction signal, of the one or more third predetermined decoding/encoding tools, i.e. the one or more intra-prediction tools, within the spatial neighborhood.

The substitute signal may be generated using inter-prediction, e.g., the one or more second predetermined decoding/encoding tools, i.e. the one or more inter-prediction tools, may be configured to generate the substitute signal. For example, the inter-prediction signal of the current block may be extended to obtain the substitute signal.

An embodiment relates to a video decoder/encoder comprising a plurality of decoding tools, configured to block-wisely apply, e.g., controlled by a data stream, the plurality of decoding/encoding tools onto a current picture of a video, wherein the plurality of decoding/encoding tools comprises a first set of prediction tools, and the video decoder/encoder is configured to, in block-wisely applying the plurality of decoding/encoding tools onto the current picture, perform a block-wise selection of exactly one prediction tool out of the first set of prediction tools. A reconstructed signal of the currently decoded picture is derivable by a sample-wise combination of prediction signals generated by the first set of prediction tools and a prediction residual signal, e.g., derived from the data stream. The plurality of decoding/encoding tools comprises a first predetermined decoding/encoding tool configured to, based on a neighborhood signal in a spatial neighborhood, post-process a prediction signal of one or more inter-prediction tools of the first set of prediction tools. The video decoder/encoder is configured to generate the neighborhood signal in the spatial neighborhood by using the prediction signal of the one or more inter-prediction tools in a version not post-processed by the first predetermined decoding/encoding tool and/or substituting the prediction signal of one or more intra-prediction tools of the plurality of prediction tools by a substitute signal generated by inter-prediction. The video decoder/encoder, for example, is configured to, in substituting the prediction signal of the one or more intra-prediction tools of the plurality of prediction tools by the substitute signal generated by inter-prediction, disregard a prediction residual signal in generating the neighborhood signal.

A further embodiment relates to a video decoder/encoder, configured to decode/encode a video from/into a data stream using block-based prediction and transform-based prediction residual coding, perform the block-based prediction for predicted blocks, and apply a post-processing tool to a predetermined predicted block and a neighboring block spatially neighboring the predetermined predicted block and overlapping a spatial neighborhood of the predetermined predicted block, wherein the post-processing tool is configured to
post-process a prediction signal of the predetermined predicted block based on a neighborhood signal within the spatial neighborhood of the predetermined predicted block to obtain a post-processed prediction signal of the predetermined predicted block and
post-process a prediction signal of the neighboring block based on a further neighborhood signal within a further spatial neighborhood of the neighboring block to obtain a post-processed prediction signal of the neighboring block, wherein the neighboring block overlaps the spatial neighborhood.

The neighboring block is reconstructable by a sample-wise combination of the post-processed prediction signal and a prediction residual signal, e.g., obtained from the data stream. The video decoder/encoder is configured to form the neighborhood signal within the neighboring block by a sample-wise combination of the prediction signal of the neighboring block and the prediction residual signal.

An even further video decoder/encoder is configured to decode/encode a video from/into a data stream using block-based prediction and transform-based prediction residual coding, perform the block-based prediction by use of motion-compensated prediction for inter-predicted blocks and intra-prediction of intra-predicted blocks, and apply a post-processing tool to a predetermined inter-predicted block, wherein the post-processing tool is configured to post-process an inter-prediction signal of the predetermined inter-predicted block based on a neighborhood signal within a spatial neighborhood of the predetermined inter-predicted block to obtain a post-processed inter-prediction signal of the predetermined inter-predicted block. A neighboring block which overlaps the spatial neighborhood and is one of the intra-predicted blocks, is reconstructable by a sample-wise summation of an intra-prediction signal of the neighboring block and a prediction residual signal, e.g., obtained from the data stream. The decoder/encoder is configured to form the neighborhood signal within the neighboring block by generating a substitute signal within the spatial neighborhood and neighboring block by inter-prediction.

According to an embodiment, the first predetermined decoding/encoding tool may be a LIC tool configured to post-process the contribution signal, i.e. an inter-prediction signal, of the one or more second predetermined decoding/encoding tools, i.e. one or more inter-prediction tools, or post-process the intermediate signal, i.e. a sample-wise combination of two or more inter-prediction signals generated by the one or more inter-prediction tools. The post-processing may be performed by adapting or generating a scaling value and an offset value based on the neighborhood signal and using the scaling value and the offset value to post-process the inter-prediction signal within the current block or the intermediate signal within the current block. Further, the video decoder/encoder comprising the LIC tool may be configured to generate the neighborhood signal in the spatial neighborhood of the current block by
using a contribution signal, i.e. an inter-prediction signal, of the one or more second predetermined decoding/encoding tools, i.e. the one or more inter-prediction tools, or an intermediate signal, i.e. a sample-wise combination of two or more inter-prediction signals generated by the one or more inter-prediction tools, within the spatial neighborhood, in a version not post-processed by the LIC tool and/or
substituting a contribution signal, i.e. an intra-prediction signal, of one or more third predetermined decoding/encoding tools, i.e. one or more intra-prediction tools, within the spatial neighborhood, by a substitute signal generated independent from spatial signal-interdependencies, and/or
excluding from the spatial neighborhood samples for which the sample-wise combination for the derivation of the reconstructed signal involves the contribution signal, i.e. the intra-prediction signal, of the one or more third predetermined decoding/encoding tools, i.e. the one or more intra-prediction tools, within the spatial neighborhood.

The substitute signal may be generated using inter-prediction, e.g., the one or more second predetermined decoding/encoding tools, i.e. the one or more inter-prediction tools, may be configured to generate the substitute signal. For example, the inter-prediction signal of the current block may be extended to obtain the substitute signal.

An embodiment relates to a Video decoder/encoder comprising a plurality of decoding/encoding tools, configured to decode/encode a video from/into a data stream using block-based prediction and transform-based prediction residual coding, perform the block-based prediction by use of intra-prediction of intra-predicted blocks to obtain an intra prediction signal for the respective block, and motion-compensated prediction for inter-predicted blocks to obtain an inter prediction signal for the respective block. For a current block being one of the inter-predicted blocks, the video decoder/encoder is configured to apply a post-processing tool, e.g., for a subblock of the current block, configured to, based on a neighborhood signal in a spatial neighborhood of the current block or of the subblock, post-process the inter prediction signal of the current block. Additionally, the video decoder/encoder is configured to form the neighborhood signal by excluding from the spatial neighborhood samples associated with a neighboring intra-predicted block overlapping the spatial neighborhood and/or using within the spatial neighborhood an inter-prediction signal of a neighboring inter-predicted block overlapping the spatial neighborhood in a version not post-processed by the post-processing tool.

According to an embodiment, the first predetermined decoding/encoding tool may be a CIIP tool configured to generate an inter-intra prediction signal as the contribution signal of the first predetermined decoding/encoding tool for the current block. The CIIP tool may be configured to generate the inter-intra prediction signal by a weighted combination of an intra-prediction signal and an inter-prediction signal within the current block. The CIIP tool may be configured to perform an intra prediction using the neighborhood signal to obtain the intra prediction signal within the current block and perform an inter prediction to obtain the inter prediction signal within the current block. The CIIP tool, for example, comprises an intra-prediction decoding tool configured to generate the intra-prediction signal of the current block and an inter-prediction decoding tool configured to generate the inter-prediction signal of the current block. Further, the video decoder/encoder comprising the CIIP tool may be configured to generate the neighborhood signal in the spatial neighborhood of the current block by
substituting a contribution signal, i.e. an intra-prediction signal, of one or more third predetermined decoding/encoding tools, i.e. one or more intra-prediction tools, within the spatial neighborhood, by a substitute signal, e.g., a first substitute signal, generated independent from spatial signal-interdependencies, or
substituting a contribution signal, i.e. an inter-intra prediction signal, of a third predetermined decoding/encoding tool corresponding to the first predetermined decoding/encoding tool, i.e. the CIIP tool, within the spatial neighborhood, by a substitute signal, e.g., a second substitute signal, generated independent from spatial signal-interdependencies.

The substitute signal may be generated using inter-prediction, e.g., one or more second predetermined decoding/encoding tools, i.e. one or more inter-prediction tools, may be configured to generate the substitute signal or an inter-prediction component of the CIIP tool may be configured to generate the substitute signal. For example, the CIIP tool may be configured to extend the inter-prediction signal of the current block to obtain the first substitute signal. The inter-intra prediction signal within the spatial neighborhood, for example, is generated by the CIIP tool by a weighted combination of an intra-prediction signal within the spatial neighborhood and an inter-prediction signal within the spatial neighborhood and the CIIP tool may be configured to use the inter-prediction signal within the spatial neighborhood as the second substitute signal.

An embodiment relates to Video decoder/encoder, configured to decode/encode a video from/into a data stream using block-based prediction and transform-based prediction residual coding, perform the block-based prediction by use of motion-compensated prediction for inter-predicted blocks and intra-prediction of intra-predicted blocks and applying an inter-intra prediction tool onto inter-intra predicted blocks, and apply the inter-intra prediction tool to a predetermined inter-intra predicted block, wherein same is configured to generate an inter-intra prediction signal of the predetermined inter-intra predicted block based on a neighborhood signal within a spatial neighborhood of the predetermined inter-intra predicted block. A first neighboring block which overlaps the spatial neighborhood and is one of the intra-predicted blocks is reconstructable by a sample-wise combination of an intra-prediction signal of the first neighboring block and a first prediction residual signal, e.g., obtained from the data stream. The decoder/encoder is configured to form the neighborhood signal within the first neighboring block by generating a first substitute signal within the spatial neighborhood and first neighboring block by inter-prediction.

According to an embodiment, the first predetermined decoding/encoding tool may be an RSP tool configured to generate a prediction residual signal as the contribution signal of the first predetermined decoding/encoding tool for the current block. The RSP tool may be configured to generate the prediction residual signal by deriving/generating residual values for the current block and by predicting signs of the residual values based on the neighborhood signal in the spatial neighborhood of the current block. Further, the video decoder/encoder comprising the RSP tool may be configured to generate the neighborhood signal in the spatial neighborhood of the current block by substituting a contribution signal, i.e. an intra-prediction signal, of one or more third predetermined decoding/encoding tools, i.e. one or more intra-prediction tools, within the spatial neighborhood, by a substitute signal generated independent from spatial signal-interdependencies. The substitute signal may be generated using inter-prediction, e.g., one or more second predetermined decoding/encoding tools, i.e. one or more inter-prediction tools, may be configured to generate the substitute signal. If the current block is an inter-predicted block, for example, the one or more second predetermined decoding/encoding tools may be configured to extend an inter-prediction signal of the current block to obtain the substitute signal. If the current block is an intra-predicted block, for example, the one or more second predetermined decoding/encoding tools are configured to predict a motion vector and generate an inter-prediction signal within the spatial neighborhood using the motion vector.

An embodiment relates to video decoder/encoder, configured to decode/encode a video from/into a data stream using block-based prediction and transform-based prediction residual coding, perform the block-based prediction for predicted blocks, and generate a prediction residual signal for a predetermined predicted block of the predicted blocks by performing the transform-based prediction residual coding to derive residual values for the predetermined predicted block, e.g., from the data stream, and predicting signs of the derived residual values based on a neighborhood signal in a spatial neighborhood of the predetermined predicted block. An intra-predicted neighboring block which overlaps the spatial neighborhood is reconstructable by a sample-wise combination of an intra-prediction signal of the intra-predicted neighboring block and an intra-prediction residual signal, e.g., obtained from the data stream, and/or an inter-predicted neighboring block which overlaps the spatial neighborhood is reconstructable by a sample-wise combination of an inter-prediction signal of the inter-predicted neighboring block and an inter-prediction residual signal, e.g., obtained from the data stream. Further the video decoder/encoder is configured to form the neighborhood signal within the intra-predicted neighboring block by generating a first substitute signal, e.g., for an intra-predicted reconstructed signal of the intra-predicted neighboring block, i.e. for the sample-wise combination of the intra-prediction signal and the intra-prediction residual signal, within the spatial neighborhood and first neighboring block by inter-prediction and/or within the inter-predicted neighboring block by using the inter-prediction signal of the inter-predicted neighboring block.

According to an embodiment, the first predetermined decoding/encoding tool may be a TM tool configured to generate a prediction signal as the contribution signal of the first predetermined decoding/encoding tool for the current block. The TM tool may be configured to generate the prediction signal using template matching, wherein the neighborhood signal in the spatial neighborhood of the current block represents a template for the template matching. Further, the video decoder/encoder comprising the TM tool may be configured to generate the neighborhood signal in the spatial neighborhood of the current block by substituting a contribution signal, i.e. an intra-prediction signal, of one or more third predetermined decoding/encoding tools, i.e. one or more intra-prediction tools, within the spatial neighborhood, by a substitute signal generated independent from spatial signal-interdependencies. The substitute signal may be generated using inter-prediction, e.g., one or more second predetermined decoding/encoding tools, i.e. one or more inter-prediction tools, may be configured to generate the substitute signal. For example, the one or more second predetermined decoding/encoding tools are configured to predict a motion vector and generate an inter-prediction signal within the spatial neighborhood using the motion vector.

An embodiment relates to a video decoder/encoder, configured to decode/encode a video from/into a data stream using block-based prediction and transform-based prediction residual coding, perform the block-based prediction for predicted blocks, and generate a prediction signal for a predetermined predicted block of the predicted blocks by performing template matching using a neighborhood signal in a spatial neighborhood of the predetermined predicted block as a template to locate an error minimizing template match, and using a template matched block, which is associated with the error minimizing template match, as the prediction signal of the predetermined predicted block. An intra-predicted neighboring block which overlaps the spatial neighborhood is reconstructable by a sample-wise combination of an intra-prediction signal of the intra-predicted neighboring block and an intra-prediction residual signal, e.g., obtained from the data stream, and/or an inter-predicted neighboring block which overlaps the spatial neighborhood is reconstructable by a sample-wise combination of an inter-prediction signal of the inter-predicted neighboring block and an inter-prediction residual signal, e.g., obtained from the data stream. Further the video decoder/encoder is configured to form the neighborhood signal within the intra-predicted neighboring block by generating afirst substitute signal, e.g., for an intra-predicted reconstructed signal of the intra-predicted neighboring block, i.e. for the sample-wise combination of the intra-prediction signal and the intra-prediction residual signal, within the spatial neighborhood and first neighboring block by inter-prediction and/or within the inter-predicted neighboring block by generating a second substitute signal within the spatial neighborhood and inter-predicted neighboring block by inter-prediction in a manner independent from a generation of the inter-prediction signal of the inter-predicted neighboring block and a sample-wise summation of the second substitute signal and the inter-prediction residual signal.

In accordance with a second aspect of the present invention, the inventors of the present application realized that one problem encountered when processing a picture using a neural network stems from the fact that large matrices and/or tensors have to undergo multiple convolutions resulting in a high computational complexity. According to the second aspect of the present application, this difficulty is overcome by a polyphase decomposition of an input of the neural network. The inventors found, that a polyphase decomposition compared to using an input, which is not polyphase-wisely split, leads either to a dramatic complexity reduction with a slightly lower coding gain (for the same number of feature channels), or to a significant increase in coding gain with about the same complexity (for twice the number of feature channels). Thus, polyphase-wisely splitting of samples of a picture portion into polyphase-components improves a trade-off between computational complexity and coding performance.

Accordingly, in accordance with a second aspect of the present application, a picture-processing tool comprising a neural network, like a convolutional neural network, or a convolution is configured to polyphase-wisely split luma samples of a picture portion into polyphase-components to obtain a matrix per polyphase-component, and form a tensor by cascading the matrices of the polyphase-components. The picture-processing tool is configured to subject the tensor to the neural network or the convolution with associating the matrices as different channels so as to obtain an output tensor composed of a concatenation of output matrices comprising one output matrix per polyphase-component. Additionally, the picture-processing tool is configured to form, by inverse polyphase decomposition, a processed picture portion based on the output tensor.

Of course, both of the above-outlined aspects may be combined in a favorable way.

A third aspect of the present invention relates to a video codec offering post-processing for inter-predicted blocks. The inventors of the present application realized that one problem encountered when activating a post-processing tool for certain inter-predicted blocks the coding efficiency decreases in fact rather than improving same. In particular, the inventors found a way to find, distinguish or identify those blocks out of the inter-predicted blocks for which the post-processing tool might be applied, for which blocks the disablement of the processing-tool is favorable in terms of coding efficiency. To be more precise, the inventors found a way to perform this identification in a manner which does not require the explicit transmission of a switching flag or the like to control the activation and inactivation of the post-processing tool. The way of identification is defined by rules including disablement of the post-processing tool for certain inter-predicted blocks, like inter-predicted blocks with one or more zero-motion-vectors, inter-predicted blocks with one or more full-pel motion vectors, inter-predicted blocks associated with an uni-prediction mode, a merge mode or a bi-prediction mode using coding unit weights, inter-predicted blocks with a certain block shape, inter-predicted blocks associated with a certain quantization parameter. These rules avoid, most probably, that especially for long prediction chains, repeated application of the post-processing tool might have negative impact on the compression efficiency. By this measure, the inventors found a way to avoid the frequent provision of random access points (RAP) which would represent another possibility, but detrimental in terms of coding efficiency, as to how this repeated application of the processing-tool could be.

Accordingly, in accordance with a third aspect of the present application, a video decoder/encoder is configured to decode/encode a video from/into a data stream using block-based prediction and transform-based prediction residual coding and perform the block-based prediction by use of motion-compensated prediction controlled via motion vectors. The video decoder is configured to derive the motion vectors from the data stream for inter-predicted blocks and the video encoder is configured to encode the motion vectors into the data stream for inter-predicted blocks. The video decoder/encoder is configured to apply a post-processing tool for post-processing an inter-prediction signal of predetermined inter-predicted blocks. Additionally, the video decoder/encoder is configured to identify the predetermined inter-predicted blocks out of the inter-predicted blocks by excluding from the predetermined inter-predicted blocks
first inter-predicted blocks which have, e.g., according to the data stream, one or more motion vectors associated therewith among which a number which fulfills a first predetermined criterion is zero, and/or
second inter-predicted blocks which have, e.g., according to the data stream, one or more motion vectors associated therewith among which a number which fulfills a second predetermined criterion are full-pel motion vectors, and/or
third inter-predicted blocks which have, e.g., according to the data stream, one out of a set of predetermined inter-prediction modes associated therewith, wherein the set of predetermined inter-prediction modes includes one or more of uni-prediction modes, a merge mode, and a bi-prediction mode using coding unit weights, and/or
fourth inter-predicted blocks whose block shape fulfills a predetermined criterion, and/or
fifth inter-predicted blocks for which a quantization parameter has a value which fulfills a further predetermined criterion, wherein the quantization parameter may be signaled in the data stream.

Again, even the latter aspect may be combined with any of the previously identified aspects of the present application or with both aspects.

In accordance with a fourth aspect of the present invention, the inventors of the present application realized that one problem encountered when processing a current picture portion depending on preceding picture portions stems from the fact that the neighboring picture portion has to be processed before the current picture portion can be processed. According to the fourth aspect of the present application, this difficulty is overcome by generating a constrained neighborhood signal for intra-predicting an intra-predicted block. The inventors found, that it is advantageous to decouple an application of a post-processing of inter-prediction signals, a CIIP-prediction tool and/or an RSP tool from an intra-prediction loop. This enables to intra-predict intra-predicted blocks of a picture parallel to a post-processing of inter-prediction signals and/or a generation of an inter-intra prediction signal and/or a residual sign prediction. This is based on the idea that the herein introduced neighborhood signal enables a processing of an intra-predicted block dependent on its spatial neighborhood without the spatial neighborhood having to be fully reconstructed before the intra-predicted block is processed. By being able to consider the spatial neighborhood at a parallel processing of picture portions a high encoding/decoding efficiency and especially a high coding performance can be achieved.

Accordingly, in accordance with a fourth aspect of the present application, a video decoder/encoder is configured to decode/encode a video from/into a data stream using block-based prediction and transform-based prediction residual coding and perform the block-based prediction by use of motion-compensated prediction for inter-predicted blocks and by use of intra-prediction for intra-predicted blocks. The video decoder/encoder is configured to intra-predict an intra-predicted block using a neighborhood signal in a spatial neighborhood of the intra-predicted block. Further the video decoder/encoder is configured to apply a post-processing tool onto a first neighboring block which overlaps the spatial neighborhood and is one of the inter-predicted blocks, wherein the post-processing tool is configured to post-process an inter-prediction signal of the first neighboring block to obtain a post-processed inter-prediction signal. The first neighboring block is reconstructable by a sample-wise combination of the post-processed inter-prediction signal of the first neighboring block and a first prediction residual signal, e.g., obtained from the data stream. Additionally, video decoder/encoder is configured to form the neighborhood signal within the spatial neighborhood by using, within the first neighboring block, the inter-prediction signal of the first neighboring block in a version not post-processed by the post-processing tool.

A further embodiment, in accordance with a fourth aspect of the present application, relates to a video decoder/encoder configured to decode/encode a video from/into a data stream using block-based prediction and transform-based prediction residual coding, perform the block-based prediction by use of intra-prediction for intra-predicted blocks and by use of inter-intra prediction for inter-intra predicted blocks, and intra-predict an intra-predicted block using a neighborhood signal in a spatial neighborhood of the intra-predicted block. Further the video decoder/encoder is configured to inter-intra predict a first neighboring block which overlaps the spatial neighborhood and is one of the inter-intra predicted blocks to obtain an inter-intra prediction signal of the first neighboring block, wherein the inter-intra prediction signal corresponds to a weighted combination of an intra-prediction signal and an inter-prediction signal of the first neighboring block. The first neighboring block is reconstructable by a sample-wise combination of the inter-intra prediction signal of the first neighboring block and a first prediction residual signal, e.g., obtained from the data stream. Additionally, the video decoder/encoder is configured to form the neighborhood signal within the spatial neighborhood by using, within the first neighboring block, the inter-prediction signal of the first neighboring block and not the intra-prediction signal of the first neighboring block.

A further embodiment, in accordance with a fourth aspect of the present application, relates to a video decoder/encoder configured to decode a video from a data stream using block-based prediction and transform-based prediction residual coding, perform the block-based prediction by use of intra-prediction for intra-predicted blocks, and intra-predict an intra-predicted block using a neighborhood signal in a spatial neighborhood of the intra-predicted block. Further the video decoder/encoder is configured to apply a residual-sign-prediction tool onto a first neighboring block which overlaps the spatial neighborhood, to obtain a prediction residual signal of the first neighboring block. The first neighboring block is reconstructable by a sample-wise combination of a prediction signal of the first neighboring block and the prediction residual signal of the first neighboring block. Additionally, the video decoder/encoder is configured to form the neighborhood signal within the spatial neighborhood by using, within the first neighboring block, the prediction signal of the first neighboring block uncombined with the prediction residual signal of the first neighboring block.

Again, even the latter aspect may be combined with any of the previously identified aspects of the present application or with two or more of the previously identified aspects.

### BRIEF DESCRIPTION OF THE DRAWINGS

Embodiments of the present invention will be detailed subsequently referring to the appended drawings, in which:

FIG. 1 shows an embodiment of an encoding into a data stream;

FIG. 2 shows an embodiment of an encoder;

FIG. 3 shows an embodiment of a reconstruction of a picture;

FIG. 4 shows an embodiment of a decoder;

FIG. 5 shows an embodiment of a relationship between a reconstructed signal and a combination of a prediction residual signal and a prediction signal;

FIG. 6 shows an embodiment of a decoder configured to constrain a neighborhood signal;

FIG. 7 shows an embodiment of a decoder/encoder with an STRN tool using a constrained neighborhood signal;

FIG. 8 shows an embodiment of a decoder/encoder with a LIC tool using a constrained neighborhood signal;

FIG. 9 shows an embodiment of a decoder/encoder with a CIIP tool using a constrained neighborhood signal;

FIG. 10 shows an embodiment of a decoder/encoder with an RSP tool using a constrained neighborhood signal;

FIG. 11 shows an embodiment of a decoder/encoder with a TM tool using a constrained neighborhood signal;

FIG. 12 shows an embodiment of a decoder/encoder configured to constrain a neighborhood signal for an intra-prediction;

FIG. 13 shows an embodiment of a picture-processing tool performing a polyphase-wise splitting of a picture portion;

FIG. 14 shows an embodiment of a decoder configured to apply a post-processing only to certain inter-predicted blocks;

FIG. 15 shows an embodiment of a neural network usable by a herein described decoder, encoder and/or picture-processing tool;

FIG. 16 shows a comparison between an IPRN architecture without and an STRN architecture with polyphase decomposition;

FIG. 17 shows a relation between learning rate decay and average SATD training loss for the first 20 epochs (IPRN and STRN models with B=4, N=6, and F=64 and F=128, respectively, both using the same training dataset);

FIG. 18 shows an influence of spatial reference samples in the input on the output (example of a simple CNN with N=6 layers and a kernel size of 3×3, where every output value depends on a 13×13 area of input values);

FIGS. 19A-D show an average position-wise MSE reduction after inference with 32×32 blocks for different models with N=6: (A) IPRN with B=4, (B) STRN with B=4, (C) STRN with B=0, and (D) colormap (using a logarithmic scale);

FIGS. 20A-C show an inter decoding process (prediction and reconstruction with residual R): (A) inter slice with inter, intra, and STRN blocks, (B) decoding process with STRN in intra loop, and (C) proposed decoding process with constrained spatial reference samples, decoupling STRN from intra loop;

FIG. 21 shows an example for a model, training and dataset configuration;

FIG. 22 shows a coding performance and complexity analysis of different IPRN and STRN configurations;

FIG. 23 shows a coding performance of STRN using constrained spatial reference samples;

FIG. 24 shows an overall coding performance of STRN variants;

FIG. 25 shows a coding performance of STRN variants as average MAC per pixel and luma BD-rate for VTM-15.0 CTC RA (variations of N, F, B, and K are each connected by a line, with labels for variants included in Table V);

FIG. 26 shows a coding performance for STRN with and without the zero-MV constraint (ZMC) as picture order count (POC) and luma BD-rate of frames [0 . . . POC] for VTM-15.0 CTC LP; and

FIG. 27 shows a coding performance difference for STRN without and with the zero-MV constraint.

### DETAILED DESCRIPTION OF THE INVENTION

In the following description, embodiments are discussed in detail, however, it should be appreciated that the embodiments provide many applicable concepts that can be embodied in a wide variety of decoding applications, encoding applications, picture processing applications and video processing applications. The specific embodiments discussed are merely illustrative of specific ways to implement and use the present concept, and do not limit the scope of the embodiments.

In the following description of embodiments, the same or similar elements or elements that have the same functionality are provided with the same reference sign or are identified with the same name, and a repeated description of elements provided with the same reference number or being identified with the same name is typically omitted. Hence, descriptions provided for elements having the same or similar reference numbers or being identified with the same names are mutually exchangeable or may be applied to one another in the different embodiments.

In the following description, a plurality of details is set forth to provide a more thorough explanation of embodiments of the disclosure. However, it will be apparent to one skilled it the art that other embodiments may be practiced without these specific details. In other instances, well-known structures and devices are shown in block diagram form rather than in detail in order to avoid obscuring examples described herein. In addition, features of the different embodiments described herein may be combined with each other, unless specifically noted otherwise.

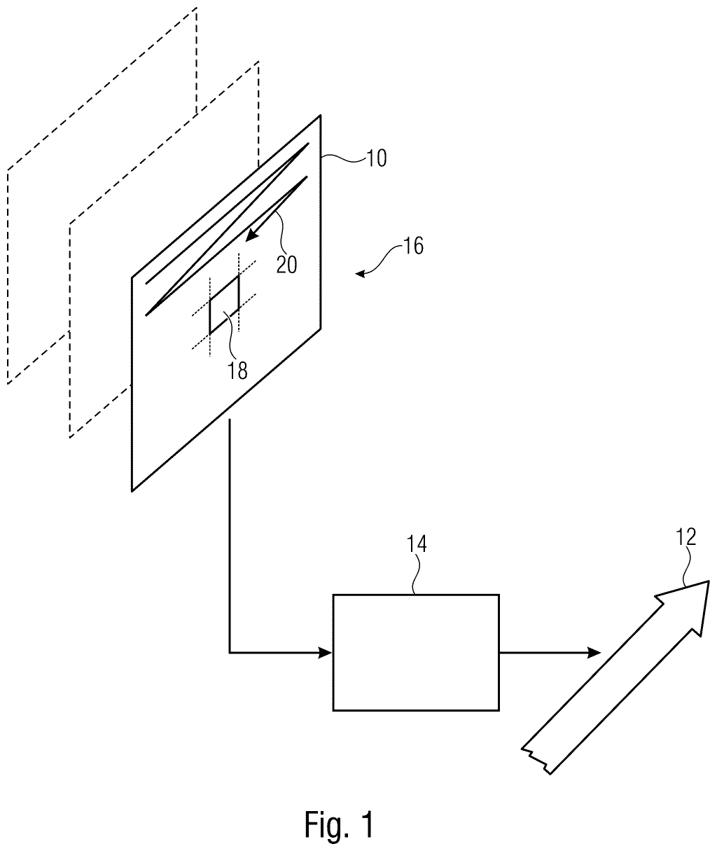

In order to ease the understanding of the following examples of the present application, the description starts with a presentation of possible encoders and decoders fitting thereto into which the subsequently outlined examples of the present application could be built. FIG. 1 shows an apparatus for block-wise encoding a picture 10 into a data stream 12. The apparatus is indicated using reference sign 14 and may be a still picture encoder or a video encoder. In other words, picture 10 may be a current picture out of a video 16 when the encoder 14 is configured to encode video 16 including picture 10 into data stream 12, or encoder 14 may encode picture 10 into data stream 12 exclusively.

As mentioned, encoder 14 performs the encoding in a block-wise manner or block-based. To this, encoder 14 subdivides picture 10 into blocks, units of which encoder 14 encodes picture 10 into data stream 12. Examples of possible subdivisions of picture 10 into blocks 18 are set out in more detail below. Generally, the subdivision may end-up into blocks 18 of constant size such as an array of blocks arranged in rows and columns or into blocks 18 of different block sizes such as by use of a hierarchical multi-tree subdivisioning with starting the multi-tree subdivisioning from the whole picture area of picture 10 or from a pre-partitioning of picture 10 into an array of tree blocks wherein these examples shall not be treated as excluding other possible ways of subdivisioning picture 10 into blocks 18.

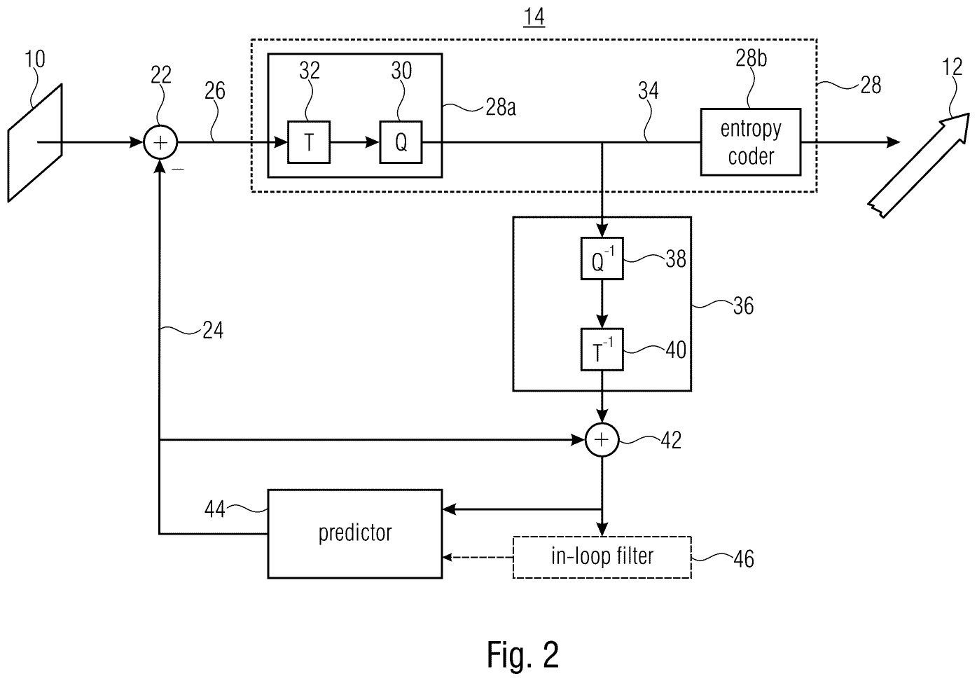

Further, encoder 14 is a predictive encoder configured to predictively encode picture 10 into data stream 12. For a certain block 18 this means that encoder 14 determines a prediction signal (see reference numeral 24 in FIG. 2) for block 18 and encodes the prediction residual (see reference numeral 26 in FIG. 2), i.e. the prediction error at which the prediction signal deviates from the actual picture content within block 18, into data stream 12.

Encoder 14 may support different prediction modes so as to derive the prediction signal for a certain block 18. The prediction modes, which are of importance in the following examples, are intra-prediction modes according to which the inner of block 18 is predicted spatially from neighboring, already encoded samples of picture 10. The encoding of picture 10 into data stream 12 and, accordingly, the corresponding decoding procedure, may be based on a certain coding order 20 defined among blocks 18. For instance, the coding order 20 may traverse blocks 18 in a raster scan order such as row-wise from top to bottom with traversing each row from left to right, for instance, but other scan orders, like a diagonal scan order, are also possible. In case of hierarchical multi-tree based subdivisioning, raster scan ordering or another scan ordering may be applied within each hierarchy level, wherein a depth-first traversal order may be applied, i.e. leaf nodes within a block of a certain hierarchy level may precede blocks of the same hierarchy level having the same parent block according to coding order 20. Depending on the coding order 20, neighboring, already encoded samples of a block 18 may be located usually at one or more sides of block 18. In case of the examples presented herein, for instance, neighboring, already encoded samples of a block 18 are located to the top of, and to the left of block 18.

Intra-prediction modes may not be the only ones supported by encoder 14. In case of encoder 14 being a video encoder, for instance, encoder 14 may also support inter-prediction modes according to which a block 18 is temporarily predicted from a previously encoded picture of video 16. Such an inter-prediction mode may be a motion-compensated prediction mode according to which a motion vector is signaled for such a block 18 indicating a relative spatial offset of the portion from which the prediction signal of block 18 is to be derived as a copy. Inter-predicted blocks would be inter-predicted from reference pictures by determining a motion vector and copying the prediction signal for this block from a location in the reference picture pointed to by the motion vector. Additionally, or alternatively, other non-intra-prediction modes may be available as well such as inter-prediction modes in case of encoder 14 being a multi-view encoder, or non-predictive modes according to which the inner of block 18 is coded as is, i.e. without any prediction.

Additionally, or alternatively, the encoder 14 can support a Combined Inter-Intra Prediction (CIIP) mode according to which a block 18 is temporarily predicted from a previously encoded picture of video 16 to obtain an inter-prediction signal and the block 18 is spatially predicted using samples neighboring the block 18 to obtain an intra-prediction signal and the inter-prediction signal and the intra-prediction signal are combined by a weighted combination, e.g., a weighted averaging process is applied to combine both predictions.

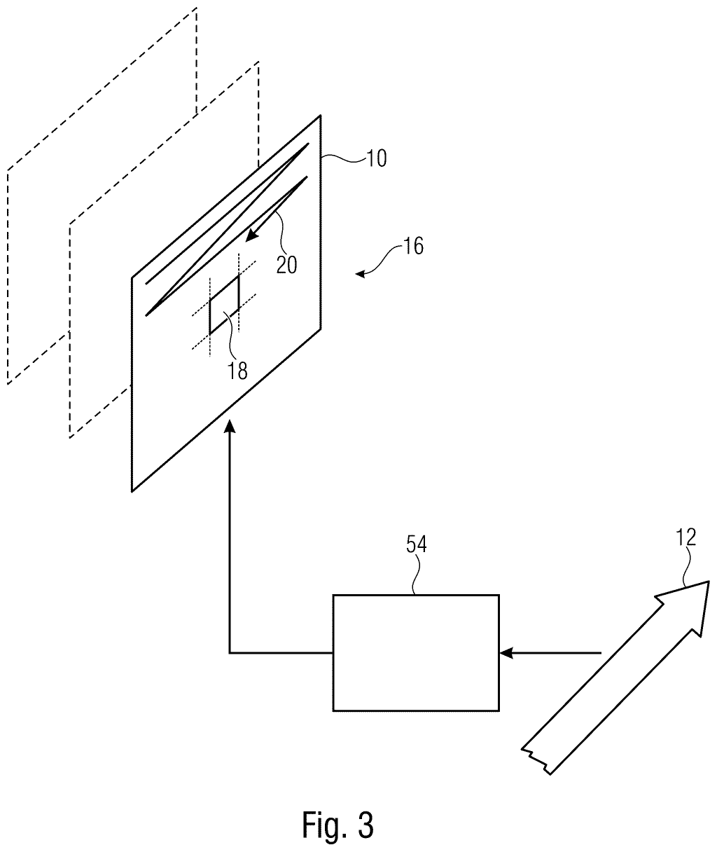

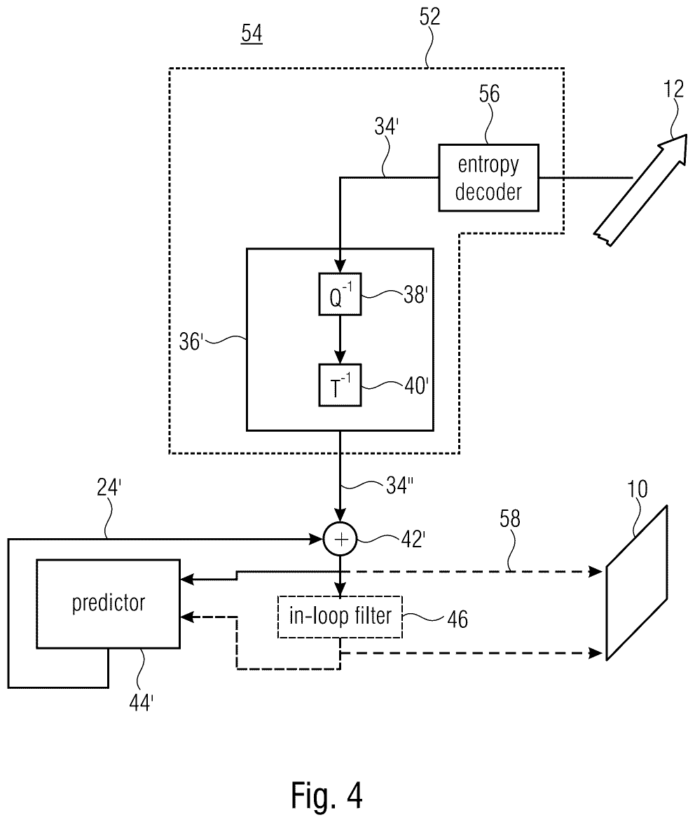

Before starting with focusing the description of the present application onto constraining samples within the neighborhood of a block 18 for a processing of block 18 or post-processing an inter or intra prediction signal of a block 18, a more specific example for a possible block-based encoder, i.e. for a possible implementation of encoder 14, as described with respect to FIG. 2 is presented with then presenting in FIG. 3 and FIG. 4 two corresponding examples for a decoder fitting to FIGS. 1 and 2, respectively.

FIG. 2 shows a possible implementation of encoder 14 of FIG. 1, namely one where the encoder 14 is configured to use transform coding for encoding the prediction residual 26 although this is nearly an example and the present application is not restricted to that sort of prediction residual coding. According to FIG. 2, encoder 14 comprises a subtractor 22 configured to subtract from the inbound signal, i.e. picture 10 or, on a block basis, current block 18, the corresponding prediction signal 24 so as to obtain the prediction residual signal 26 which is then encoded by a prediction residual encoder 28 into a data stream 12. The prediction residual encoder 28 is composed of a lossy encoding stage 28a and a lossless encoding stage 28b. The lossy stage 28a receives the prediction residual signal 26 and comprises a quantizer 30 which quantizes the samples of the prediction residual signal 26. As already mentioned above, the present example uses transform coding of the prediction residual signal 26 and accordingly, the lossy encoding stage 28a comprises a transform stage 32 connected between subtractor 22 and quantizer 30 so as to transform such a spectrally decomposed prediction residual 26 with a quantization of quantizer 30 taking place on the transformed coefficients where presenting the residual signal 26. The transform may be a DCT, DST, FFT, Hadamard transform or the like. The transformed and quantized prediction residual signal 34 is then subject to lossless coding by the lossless encoding stage 28b which is an entropy coder entropy coding quantized prediction residual signal 34 into data stream 12. Encoder 14 further comprises the prediction residual signal reconstruction stage 36 connected to the output of quantizer 30 so as to reconstruct from the transformed and quantized prediction residual signal 34 the prediction residual signal in a manner also available at the decoder (see reference numeral 54 in FIG. 3 and FIG. 4), i.e. taking the coding loss of quantizer 30 into account. To this end, the prediction residual reconstruction stage 36 comprises a dequantizer 38 which performs the inverse of the quantization of quantizer 30, followed by an inverse transformer 40 which performs the inverse transformation relative to the transformation performed by transformer 32 such as the inverse of the spectral decomposition such as the inverse to any of the above-mentioned specific transformation examples. Encoder 14 comprises an adder 42 which adds the reconstructed prediction residual signal as output by inverse transformer 40 and the prediction signal 24 so as to output a reconstructed signal, i.e. reconstructed samples. This output is fed into a predictor 44 of encoder 14 which then determines the prediction signal 24 based thereon. It is predictor 44 which supports all the prediction modes already discussed above with respect to FIG. 1. FIG. 2 also illustrates that in case of encoder 14 being a video encoder, encoder 14 may also comprise an in-loop filter 46 with filters completely reconstructed pictures which, after having been filtered, form reference pictures for predictor 44 with respect to an inter-predicted block.

As already mentioned above, encoder 14 operates block-based. For the subsequent description, the block bases of interest is the one subdividing picture 10 into blocks for which the intra-prediction mode is selected out of a set or plurality of intra-prediction modes supported by predictor 44 or encoder 14, respectively, and the selected intra-prediction mode performed individually or the block bases of interest is the one subdividing picture 10 into blocks for which the inter-prediction mode is selected out of a set or plurality of inter-prediction modes supported by predictor 44 or encoder 14, respectively, and the selected inter-prediction mode performed individually or the block bases of interest is the one subdividing picture 10 into blocks for which the CIIP mode is selected out of a set or plurality of CIIP modes supported by predictor 44 or encoder 14, respectively, and the selected CIIP mode performed individually. Other sorts of blocks into which picture 10 is subdivided may, however, exist as well. For instance, the above-mentioned decision whether picture 10 is inter-coded, intra-coded or CIIP-coded may be done at a granularity or in units of blocks deviating from blocks 18. For instance, the mode decision may be performed at a level of coding blocks into which picture 10 is subdivided, and each coding block is subdivided into prediction blocks. The predictor 44 or encoder 14 may support a plurality of inter-coding modes, a plurality of intra-coding modes and/or a plurality of CIIP modes. At the level of the coding blocks, for example, it is decided whether the respective block is inter-coded, intra-coded or CIIP-coded and at the level of the prediction blocks into which the coding block is subdivided, it is individually decided which actual mode is to be selected out of the plurality of modes supported for the respective coding by the predictor 44 or encoder 14. These prediction blocks will form blocks 18 which are of interest here. Another block subdivisioning pertains the subdivisioning into transform blocks at units of which the transformations by transformer 32 and inverse transformer 40 are performed. Transformed blocks may, for instance, be the result of further subdivisioning coding blocks. The subdivisioning into the transform blocks may differ from the subdivisioning into the prediction blocks. Naturally, the examples set out herein should not be treated as being limiting and other examples exist as well. For the sake of completeness only, it is noted that the subdivisioning into coding blocks may, for instance, use multi-tree subdivisioning, and prediction blocks and/or transform blocks may be obtained by further subdividing coding blocks using multi-tree subdivisioning, as well. For the specific embodiments discussed herein the prediction blocks are of main interest.

A decoder 54 or apparatus for block-wise decoding fitting to the encoder 14 of FIG. 1 is depicted in FIG. 3. This decoder 54 does the opposite of encoder 14, i.e. it decodes from data stream 12 picture 10 in a block-wise manner and supports, to this end, a plurality of intra-prediction modes, inter-prediction modes and/or CIIP modes. The decoder 54 may comprise a residual provider 52, for example. All the other possibilities discussed above with respect to FIG. 1 are valid for the decoder 54, too. To this, decoder 54 may be a still picture decoder or a video decoder and all the prediction modes and prediction possibilities are supported by decoder 54 as well. The difference between encoder 14 and decoder 54 lies, primarily, in the fact that encoder 14 chooses or selects coding decisions according to some optimization such as, for instance, in order to minimize some cost function which may depend on coding rate and/or coding distortion. One of these coding options or coding parameters may involve a selection of the intra-prediction mode to be used for a current block 18 among available or supported intra-prediction modes or a selection of the inter-prediction mode to be used for a current block 18 among available or supported inter-prediction modes or a selection of the CIIP mode to be used for a current block 18 among available or supported CIIP modes. The selected mode may then be signaled by encoder 14 for current block 18 within data stream 12 with decoder 54 redoing the selection using this signalization in data stream 12 for block 18. Likewise, the subdivisioning of picture 10 into blocks 18 may be subject to optimization within encoder 14 and corresponding subdivision information may be conveyed within data stream 12 with decoder 54 recovering the subdivision of picture 10 into blocks 18 on the basis of the subdivision information. Summarizing the above, decoder 54 may be a predictive decoder operating on a block-basis and besides intra-prediction modes, decoder 54 may support other prediction modes such as inter-prediction modes or CIIP modes in case of, for instance, decoder 54 being a video decoder. In decoding, decoder 54 may also use the coding order 20 discussed with respect to FIG. 1 and as this coding order 20 is obeyed both at encoder 14 and decoder 54, the same neighboring samples are available for a current block 18 both at encoder 14 and decoder 54. Accordingly, in order to avoid unnecessary repetition, the description of the mode of operation of encoder 14 shall also apply to decoder 54 as far the subdivision of picture 10 into blocks is concerned, for instance, as far as prediction is concerned and as far as the coding of the prediction residual is concerned. Differences lie in the fact that encoder 14 chooses, by optimization, some coding options or coding parameters and signals within, or inserts into, data stream 12 the coding parameters which are then derived from the data stream 12 by decoder 54 so as to redo the prediction, subdivision and so forth.

FIG. 4 shows a possible implementation of the decoder 54 of FIG. 3, namely one fitting to the implementation of encoder 14 of FIG. 1 as shown in FIG. 2. As many elements of the encoder 54 of FIG. 4 are the same as those occurring in the corresponding encoder of FIG. 2, the same reference signs, provided with an apostrophe, are used in FIG. 4 in order to indicate these elements. In particular, adder 42′, optional in-loop filter 46′ and predictor 44′ are connected into a prediction loop in the same manner that they are in encoder of FIG. 2. A dequantized and retransformed prediction residual signal 34″ applied to adder 42′ is derived by a sequence of entropy decoder 56 which inverses the entropy encoding of entropy encoder 28b to obtain a quantized and transformed prediction residual signal 34′, followed by the residual signal reconstruction stage 36′ which is composed of dequantizer 38′ and inverse transformer 40′ just as it is the case on encoding side. The decoder's output is the reconstruction of picture 10, i.e. a reconstructed signal 58 or a part of the reconstructed signal 58. The reconstruction of picture 10 may be available directly at the output of adder 42′ or, alternatively, at the output of in-loop filter 46′. Some post-filter may be arranged at the decoder's output in order to subject the reconstruction of picture 10 to some post-filtering in order to improve the picture quality, but this option is not depicted in FIG. 4.

Again, with respect to FIG. 4 the description brought forward above with respect to FIG. 2 shall be valid for FIG. 4 as well with the exception that merely the encoder performs the optimization tasks and the associated decisions with respect to coding options. However, all the description with respect to block-subdivisioning, prediction, dequantization and retransforming is also valid for the decoder 54 of FIG. 4.

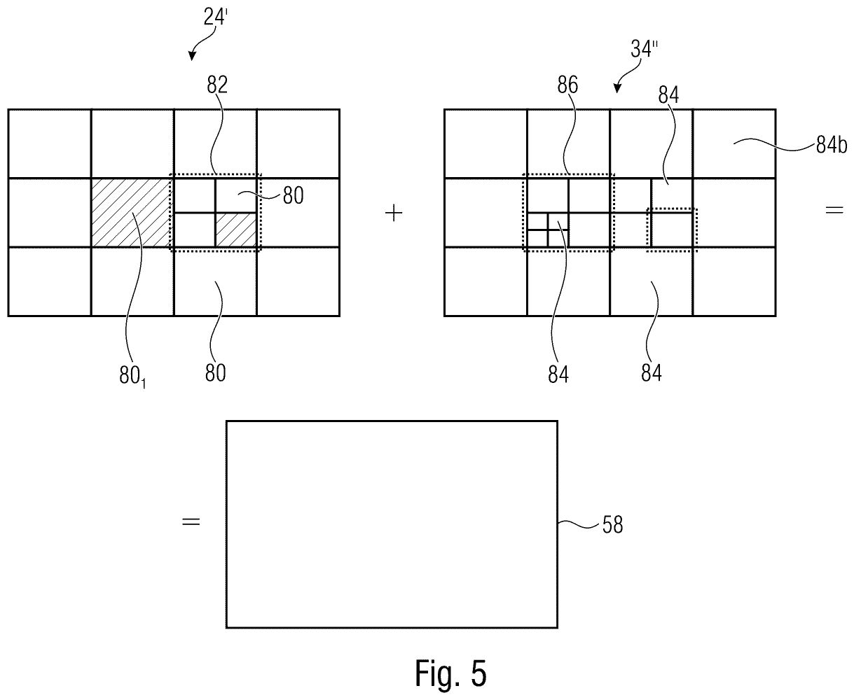

FIG. 5 illustrates the relationship between the reconstructed signal 58, i.e. the reconstructed picture, on the one hand, and the combination of the dequantized and retransformed prediction residual signal 34″ and the prediction signal 24′ on the other hand. As already denoted above, the combination may be an addition, e.g., performed by the adder 42′ or 42. The prediction signal 24′ is illustrated in FIG. 5 as a subdivision of a picture area into prediction blocks 80 of varying size, although this is merely an example. The subdivision may be any subdivision, such as a regular subdivision of the picture area into rows and columns of blocks, or a multi-tree subdivision of picture 10 into leaf blocks of varying size, such as a quadtree subdivision or the like, wherein a mixture thereof is illustrated in FIG. 5 where the picture area is firstly subdivided into rows and columns of tree-root blocks 82 which are then further subdivided in accordance with a recursive multi-tree subdivisioning to result into prediction blocks 80. It is also possible that one or more tree-root blocks 82 are not further subdivided, in which case the respective block 82 represents a prediction block 80.

The prediction residual signal 34″ in FIG. 5 is also illustrated as a subdivision of the picture area into blocks 84 of varying size. These blocks 84 might be called transform blocks or transform coefficient blocks in order to distinguish same from the prediction blocks 80. In effect, FIG. 5 illustrates that encoder 14 and decoder 54 may use two different subdivisions of picture 10, into blocks, namely one subdivisioning into prediction blocks 80 and another subdivision into blocks 84. Both subdivisions might be the same, i.e. each prediction block 80, may concurrently form a transform block 84 and vice versa, but FIG. 5 illustrates the case where, for instance, a subdivision into transform blocks 84 forms an extension of the subdivision into prediction blocks 80 so that any border between two prediction blocks 80 overlays a border between two blocks 84, or alternatively speaking each prediction block 80 either coincides with one of the transform blocks 84 or coincides with a cluster of transform blocks 84 (compare prediction block 80₁ with the corresponding tree-root block 86, which is further subdivided into blocks 84). However, the subdivisions may also be determined or selected independent from each other so that transform blocks 84 could alternatively cross block borders between prediction blocks 80. As far as the subdivision into transform blocks 84 is concerned, similar statements are thus true as those brought forward with respect to the subdivision into prediction blocks 80, i.e. the blocks 84 may be the result of a regular subdivision of picture area into blocks 86, arranged in rows and columns, or the result of the subdivision of picture area into blocks 86 and a further subdivision of one or more blocks 86. The blocks 84 may be the result of a recursive multi-tree subdivisioning of the picture area or any other sort of segmentation. Just as an aside, it is noted that prediction blocks 80 and 84 are not restricted to being quadratic, rectangular or any other shape. Further, the subdivision of a current picture 10 into prediction blocks 80 at which the prediction signal 24′ is formed, and the subdivision of a current picture 10 into blocks 84 at which the prediction residual 34″ is coded, may not the only subdivision used for coding/decoding. These subdivisions from a granularity at which prediction signal determination and residual coding is performed, but firstly, the residual coding may alternatively be done without subdivisioning, and secondly, at other granularities than these subdivisions, encoder and decoder may set certain coding parameters which might include some of the aforementioned parameters such as prediction parameters, prediction signal composition control signals and the like.

FIG. 5 illustrates that the combination of the prediction signal 24′ and the prediction residual signal 34″ directly results in the reconstructed signal 58. However, it should be noted that more than one prediction signal 24′ may be combined with the prediction residual signal 34″ to result into picture 10 in accordance with alternative embodiments such as prediction signals obtained from other views or from other coding layers which are coded/decoded in a separate prediction loop with separate DPB, for instance.

In FIG. 5, the transform blocks 84 shall have the following significance. Transformer 32 and inverse transformer 40/40′ perform their transformations in units of these transform blocks 84. For instance, many codecs use some sort of DST or DCT for all transform blocks 84. Some codecs allow for skipping the transformation so that, for some of the transform blocks 84, the prediction residual signal 34″ is coded in the spatial domain directly. However, in accordance with embodiments described herein, encoder 14 and decoder 54 are configured in such a manner that they support several transforms.

In the following, embodiments will be described by which the coding efficiency for block-based picture and/or video coding can be improved and/or by which the compression efficiency can be improved. The embodiments in the following will mostly illustrate the features and functionalities in view of a decoder 54. However, it is clear that the same or similar features and functionalities can be comprised by an encoder 14, e.g., a decoding performed by a decoder 54 can correspond to an encoding by the encoder 14. Furthermore, the encoder 14 might comprise the same features as described with regard to the decoder 54 in a feedback loop, e.g., in the prediction stage 36.

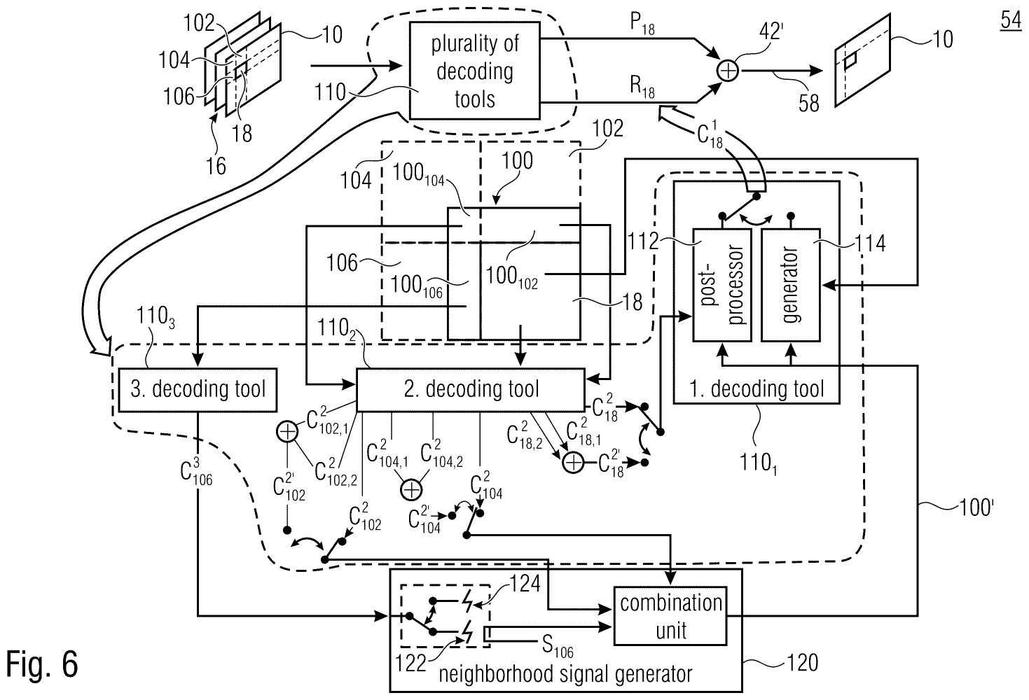

FIG. 6 shows an embodiment of a video decoder 54 comprising a plurality of decoding tools 110 configured to block-wisely apply the plurality of decoding tools 110 onto a current picture 10 of a video 16. FIG. 6 shows exemplarily a first predetermined decoding tool 110₁, a second predetermined decoding tool 110₂ and a third predetermined decoding tool 110₃, which are, for example, comprised by the plurality of decoding tools 110. Similarly a corresponding encoder 14 comprises a plurality of encoding tools comprising a first predetermined encoding tool, a second predetermined encoding tool and a third predetermined encoding tool, which have the functions and/or features as described with regard to the decoding tools 110₁, 110₂ and 110₃ of the plurality of decoding tools 110. Further the video decoder 54, shown in FIG. 6, and a corresponding video encoder 14 can both comprise the neighborhood signal generator 120, shown in FIG. 6. According to an embodiment, the neighborhood signal generator 120 may be part of the first predetermined decoding tool 110₁ in case of the video decoder and part of the first predetermined encoding tool in case of the video encoder.

The blocks onto which the plurality of decoding tools 110 are applied can have a different granularity. The plurality of decoding tools 110 can be applied to blocks of different dimensions.

The video decoder 54 may be configured to select for a block or for subblocks of a block individually one or more decoding tools out of the plurality of decoding tools 110. For example, one out of one or more second predetermined decoding tools comprising the second predetermined decoding tool 110₂ or one out of one or more third predetermined decoding tools comprising the third predetermined decoding tool 110₁ may be selected for the respective block or subblock. The first predetermined decoding tool 110₁ may be selectable in addition or alternatively to one out of the one or more second predetermined decoding tools or one out of the one or more third predetermined decoding tools.

The plurality of decoding tools 110 can be configured to generate contribution signals, see C¹, C² and C³. The contribution signals, for example, comprise prediction signals P and prediction residual signals R, wherein decoding tool of one type generate either prediction signals P or prediction residual signals R. FIG. 6, for example, shows a first predetermined decoding tool 110₁, a second predetermined decoding tool 110₂ and a third predetermined decoding tool 110₃. However, it is also possible that the plurality of decoding tools 110 comprises two or more first predetermined decoding tools 110₁, two or more second predetermined decoding tools 110₂ and/or two or more third predetermined decoding tools 110₃, wherein all first predetermined decoding tools generate either a prediction signal P or a prediction residual signal R, all second predetermined decoding tools generate either a prediction signal P or a prediction residual signal R and all third predetermined decoding tools generate either a prediction signal P or a prediction residual signal R. It might be that the decoding tools 110₁, 110₂ and 110₃ shown in FIG. 6 may all generate prediction signals P, in which case the plurality of decoding tools 110, for example, comprises at least one further decoding tool configured to generate a prediction residual signal R.

A reconstructed signal 58 of the currently decoded picture 10 is derivable by a sample-wise combination of the contribution signals generated by the plurality of decoding tools 110, e.g., using the adder 42′. FIG. 6 shows exemplarily a prediction signal P₁₈ and a prediction residual signal R₁₈ associated with a current block 18 within the current picture 10 for reconstructing the current block 18. However, it is clear that the plurality of decoding tools 110, for example, generates further contribution signals for further blocks of the current picture, so that the reconstructed signal 58 of the currently decoded picture 10 is derivable.

The first predetermined decoding tool 110₁ is configured to, based on a neighborhood signal 100′ in a spatial neighborhood, see 100₁₀₂, 100₁₀₄ and 100₁₀₆, of a current block 18, either perform a post processing, e.g., using the post-processor 112, or a generation, e.g., using the generator 114. For example, the first predetermined decoding tool 110₁ is configured to generate a contribution signal

$${C}_{18}^{1} ,$$

e.g., corresponding to P₁₈ or R₁₈, of the first predetermined decoding tool 110₁ for the current block 18. Alternatively, the first predetermined decoding tool 110₁, for example, is configured to post-process a contribution signal

$${C}_{18}^{2}$$

of one or more second predetermined decoding tools 110₂ within the current block 18, or post-process an intermediate signal

$${C}_{18}^{2 ′}$$

within the current block 18, e.g., to obtain a post-processed contribution signal as the contribution signal

$${C}_{18}^{1}$$

of the first predetermined decoding tool 110₁.

The second predetermined decoding tool 110₂, for example, is configured to generate the contribution signal

$${C}_{18}^{2}$$

for the current block 18 or generate two or more contribution signals, see

$${C}_{18 , 1}^{2} and {C}_{18 , 2}^{2} ,$$

for the current block 18, wherein the intermediate signal

$${C}_{18}^{2 ′}$$

within the current block 18 corresponds to a combination, e.g., by performing a sample-wise summation, a weighting operation, a shifting operation and/or an averaging operation, of the two or more contribution signals

$${C}_{18 , 1}^{2} and {C}_{18 , 2}^{2}$$

within the current block 18. Alternatively, the intermediate signal within the current block 18 corresponds to a sample-wise combination of two or more contribution signals generated by another decoding tool, e.g., a fourth predetermined decoding tool, of the plurality of decoding tools 110.

According to an embodiment, the plurality of decoding tools 110 comprises two or more second predetermined decoding tools comprising the second predetermined decoding tool 110₂. The video decoder 54, for example, is configured to select for each block of the current picture 10, for which a second decoding is selected, one of the two or more second predetermined decoding tools to generate the contribution signal within the respective block. Therefore, the first predetermined decoding tool 110₁, for example, is configured to post-process a contribution signal

$${C}_{18}^{2}$$

of two or more second predetermined decoding tools within the current block 18, e.g., the contribution signal

$${C}_{18}^{2}$$

of the second predetermined decoding tool 110₂ comprised by the two or more second predetermined decoding tools.

According to an embodiment, the current block 18 is subdivided into subblocks. For example, the plurality of decoding tools 110 can be configured to generate for each subblock a contribution signal. According to an embodiment, a second decoding may be selected for the current block 18 and the video decoder 54 may be configured to select for each subblock of the current block 18 one of two or more second predetermined decoding tools to determine a contribution signal for the respective subblock. The determined contribution signals are, for example, combined to form the intermediate signal within the current block 18.

The video decoder 54 is configured to generate the neighborhood signal 100′ in the spatial neighborhood 100, see 100₁₀₂, 100₁₀₄ and 100₁₀₆, by
using a contribution signal, see

$${C}_{102}^{2} and {C}_{104}^{2} ,$$

of the one or more second predetermined decoding tools or an intermediate signal, see

$${C}_{102}^{{2}^{′}} and {C}_{104}^{{2}^{′}} ,$$

within the spatial neighborhood, see 100₁₀₂ and 100₁₀₄, in a version not post-processed by the first predetermined decoding tool 110₁ and/or
substituting 122 a contribution signal

$${C}_{106}^{3}$$

of the third predetermined decoding tool 110₃ within the spatial neighborhood 106, by a substitute signal S₁₀₆ generated independent from spatial signal-interdependencies, e.g., an inter-prediction signal for the spatial neighborhood 106, and/or
excluding 124 from the spatial neighborhood 100 samples for which the sample-wise combination for the derivation of the reconstructed signal 58 involves the contribution signal

$${C}_{106}^{3}$$

of the third predetermined decoding tools 110₃, e.g., excluding 124 the contribution signal

$${C}_{106}^{3}$$

of the third predetermined decoding tool 110₃.

This generation of the neighborhood signal 100′ may be performed by the neighborhood signal generator 120.

Although FIG. 6 shows that the contribution signal

$${C}_{102}^{2}$$

or the intermediate signal

$${C}_{102}^{{2}^{′}}$$

associated with the spatial neighborhood 100₁₀₂ and the contribution signal

$${C}_{104}^{2}$$

or the intermediate signal

$${C}_{104}^{{2}^{′}}$$

associated with the spatial neighborhood 100₁₀₄ are considered for the generation of the neighborhood signal 100′, it is clear that the neighborhood signal generator 120 may also consider only one not post-processed contribution signal or intermediate signal, e.g., in case of blocks 104 and 102 forming one common block.

With regard to the generation of the intermediate signals

$${C}_{102}^{{2}^{′}} and {C}_{104}^{{2}^{′}}$$

within the spatial neighborhood 102 and 104 the same considerations as described with regard to the generation of the intermediate signal

$${C}_{18}^{{2}^{′}}$$

within the current block 18 may apply.

Optionally, the plurality of decoding tools 110 comprises two or more third predetermined decoding tools comprising the third predetermined decoding tool 110₃. The video decoder 54, for example, is configured to select for each block of the current picture 10, for which a third decoding is selected, one of the two or more third predetermined decoding tools to generate the contribution signal within the respective block.

According to an embodiment, the third predetermined decoding tool 110₃ may correspond to the first predetermined decoding tool 110₁. This can, for example, be the case, if the first predetermined decoding tool 110₁ generates the contribution signal for a block and performs no post-processing.

FIG. 6 shows exemplarily a picture area of the current picture 10 comprising two blocks 102 and 104 associated with a second decoding and one block 106 associated with a third decoding. The second predetermined decoding tool 110₂ may be configured to generate a contribution signal for the whole block 102 and a contribution signal for the whole block 104 and the third predetermined decoding tool 110₃ may be configured to generate a contribution signal for the whole block 106. However, the contribution signals, see

$${C}_{102}^{2} , {C}_{102}^{{2}^{′}} , {C}_{104}^{2} , {C}_{104}^{{2}^{′}} and {C}_{106}^{3} ,$$

further processed by the neighborhood signal generator 120 are only associated with the part, see 100₁₀₂, 100₁₀₄ and 100₁₀₆, of the respective block, see 102, 104 and 106, which overlaps the neighborhood 100 of the current block 18. In other words, for the generation of the neighborhood signal 100′, for example, only contribution signals associated with samples within the spatial neighborhood 100 of the current block 18 are considered.

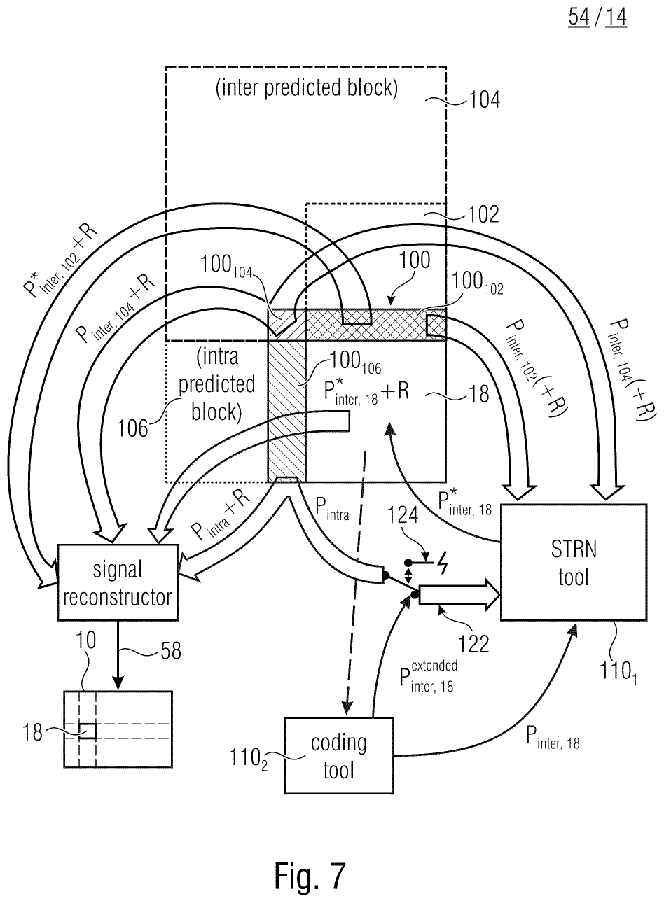

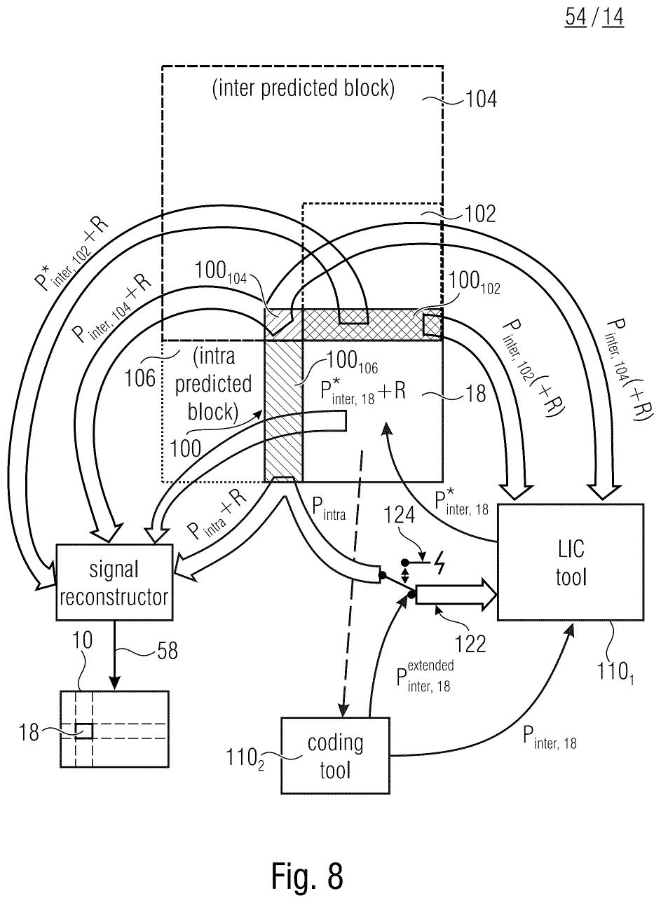

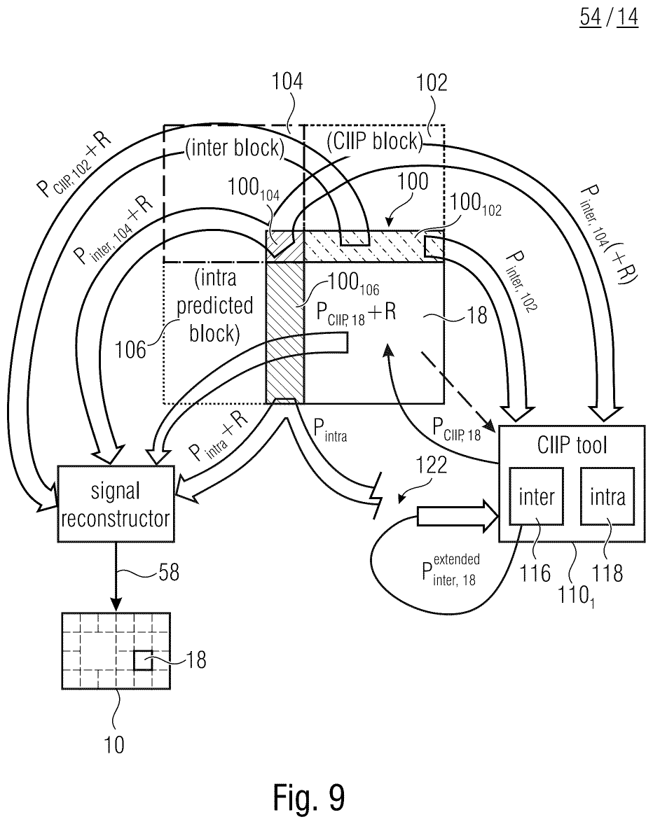

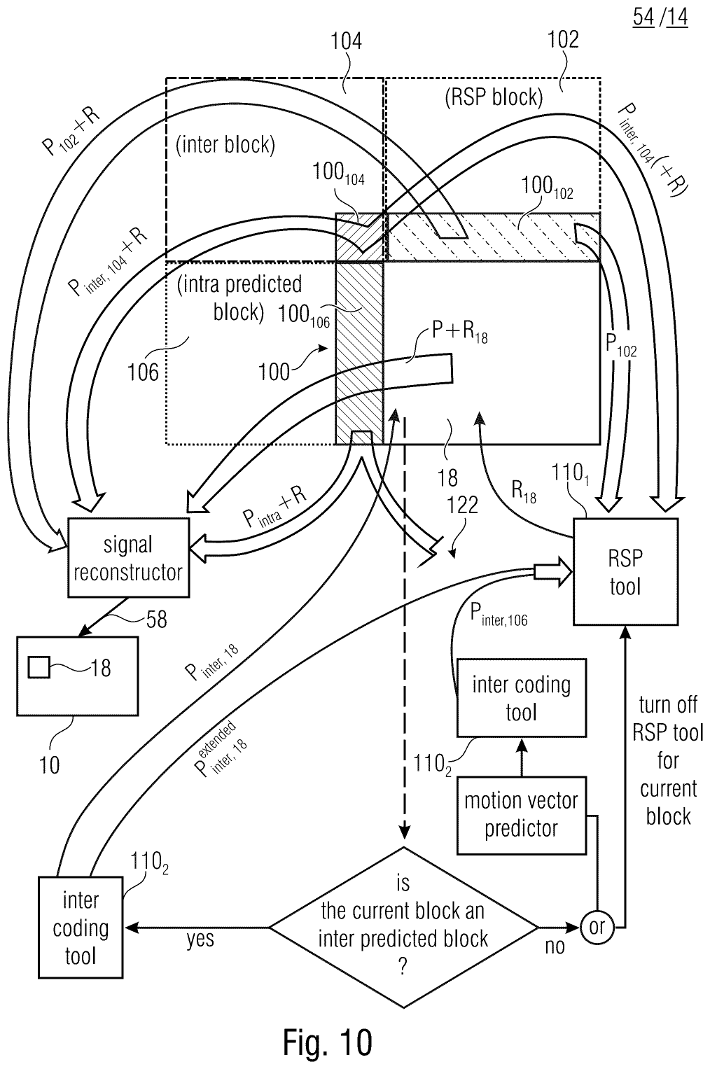

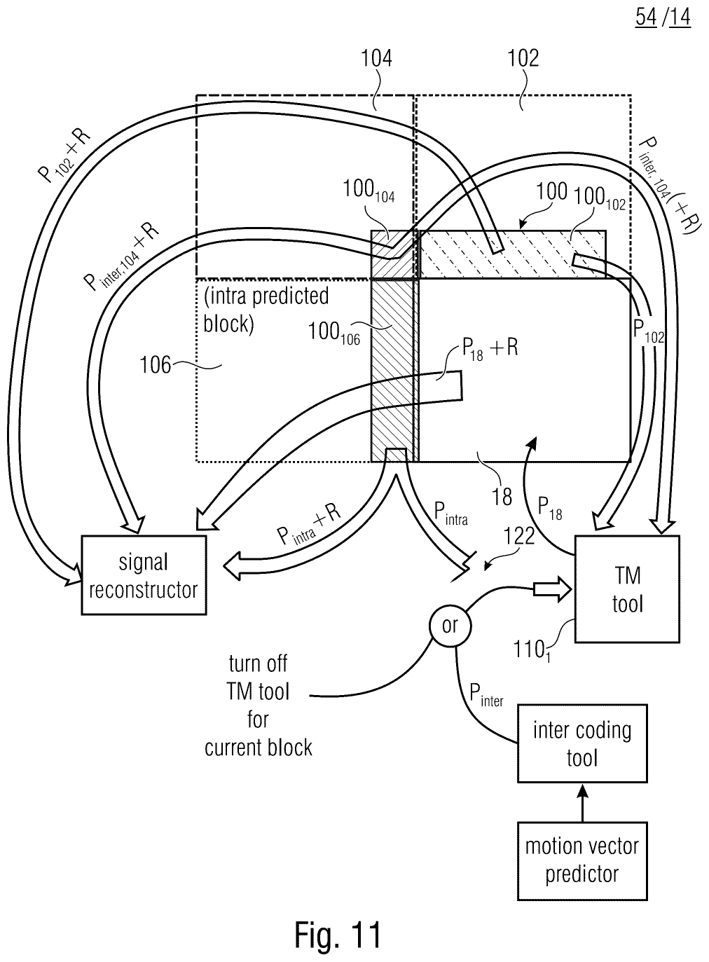

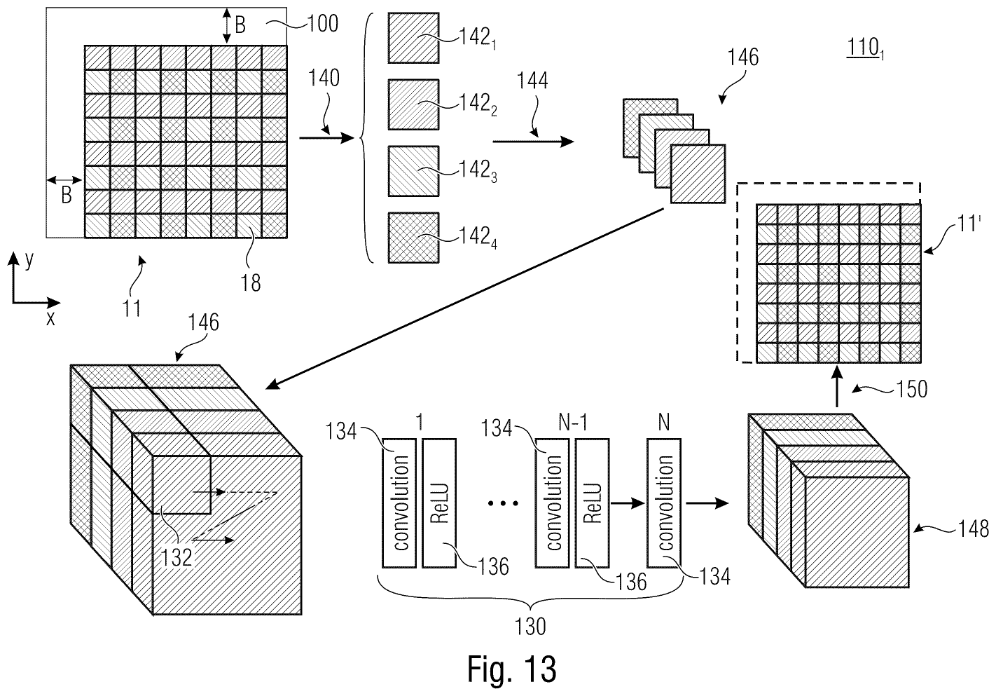

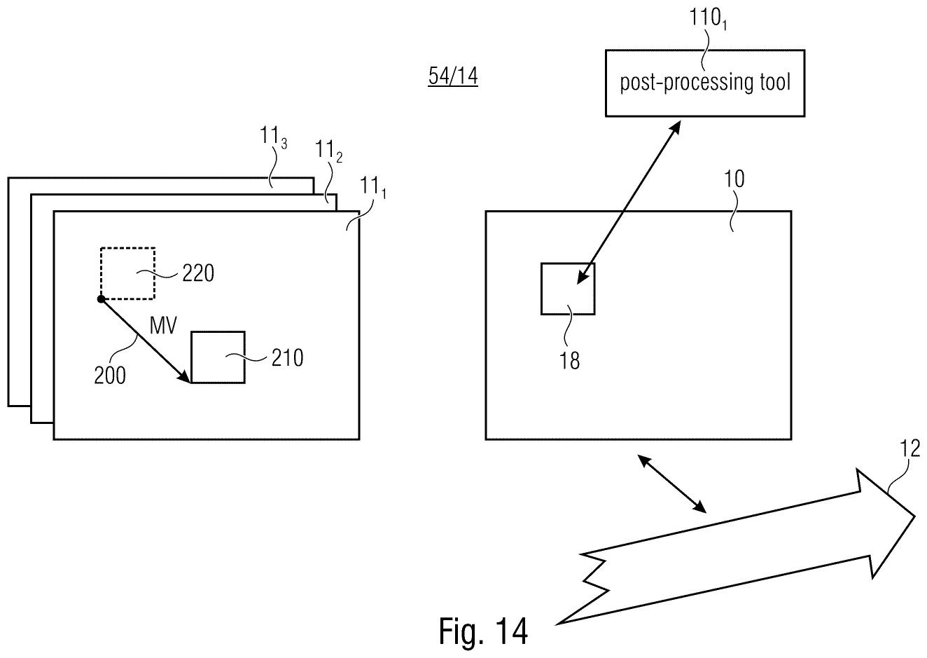

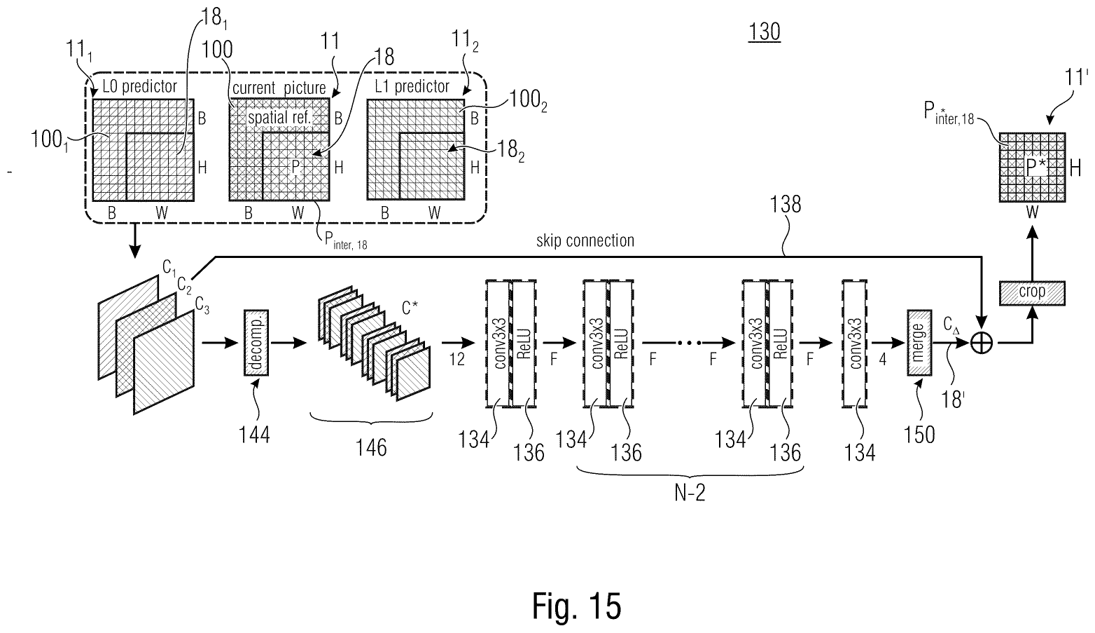

The decoder 54 of FIG. 6 and/or a corresponding encoder 14 can comprise features and/or functionalities as described with regard to FIG. 7 to 15. According to an embodiment, the first predetermined decoding tool 110₁ and/or a corresponding first predetermined encoding tool can be an STRN tool, e.g., as described in detail with regard to FIG. 7, FIG. 13 or FIG. 15, a LIC tool, e.g., as described in detail with regard to FIG. 8, a CIIP tool, e.g., as described in detail with regard to FIG. 9, an RSP tool, e.g., as described in detail with regard to FIG. 10, and/or a TM tool, e.g., as described in detail with regard to FIG. 11. According to an embodiment, the first predetermined decoding tool 110₁ and/or a corresponding first predetermined encoding tool can be configured to apply the post-processing, e.g., using the post-processor 112, only to certain inter-predicted blocks as described with regard to FIG. 14.

The second predetermined decoding tool 110₂ may be an inter-prediction tool configured to generate inter-prediction signals as the contribution signals, see

$${C}_{102}^{2} , {C}_{102 , 1}^{2} , {C}_{102 , 2}^{2} , {C}_{102}^{{2}^{′}} , {C}_{104}^{2} , {C}_{104 , 1}^{2} , {C}_{104 , 2}^{2} , {C}_{104}^{{2}^{′}} ,$$

of the second predetermined decoding tool 110₂. Therefore, blocks, for which a second decoding, i.e. an inter-prediction, is selected may represent inter-predicted blocks. In case of two or more second predetermined decoding tools, i.e. two or more inter-prediction tools, a selection among the two or more inter-prediction tools may be enabled for each block, for which the inter-prediction is selected.

The third predetermined decoding tool 110₃ may be an intra-prediction tool configured to generate intra-prediction signals as the contribution signals, see

$${C}_{106}^{3} ,$$

of the third predetermined decoding tool 110₃. Therefore, blocks, for which a third decoding, i.e. an intra-prediction, is selected may represent intra-predicted blocks. In case of two or more third predetermined decoding tools, i.e. two or more intra-prediction tools, a selection among the two or more intra-prediction tools may be enabled for each block, for which the intra-prediction is selected.

Alternatively, the third predetermined decoding tool 110₃ may be the first predetermined decoding tool 110₁, e.g., in case of the first predetermined decoding tool 110₁ being the CIIP tool, the RSP tool or the TM tool.

FIG. 9 to 11 describe both alternatives, wherein the case of the third predetermined decoding tool 110₃ being an intra-prediction tool is described with regard to the neighboring block 106 and the case of the third predetermined decoding tool 110₃ being the CIIP tool, the RSP tool or the TM tool, respectively, is described with regard to the neighboring block 102. However, it is clear that it is still possible that the neighborhood signal generator 120 considers both blocks 102 and 106 for the neighborhood signal 100′. This, is for example realized by a video decoder comprising one or more fourth predetermined decoding tools being one or more intra-prediction tools and by the third predetermined decoding tool 110₃ being the CIIP tool, the RSP tool or the TM tool. In this case, the video decoder 54 is configured to generate the neighborhood signal 100′ in the spatial neighborhood 100 by
substituting the contribution signal of the third predetermined decoding tool 110₃ within the spatial neighborhood 100₁₀₂, by a substitute signal generated independent from spatial signal-interdependencies and further by substituting the contribution signal of the one or more fourth predetermined decoding tools within the spatial neighborhood 100₁₀₆, by a further substitute signal generated independent from spatial signal-interdependencies,
or
excluding from the spatial neighborhood 100 samples for which the sample-wise combination for the derivation of the reconstructed signal 58 involves the contribution signal of the third predetermined decoding tool, i.e. samples in the neighborhood 100₁₀₂, and excluding from the spatial neighborhood 100 samples for which the sample-wise combination for the derivation of the reconstructed signal 58 involves the contribution signal of the one or more fourth predetermined decoding tools, i.e. samples in the neighborhood 100₁₀₆.

The one or more fourth predetermined decoding tools may be comprised by the plurality of decoding tools 110.

FIG. 7 shows an embodiment of a decoder 54/encoder 14 with an STRN tool 110₁, as the first predetermined decoding/encoding tool.

The STRN tool 110₁ is configured to post-process an inter-prediction signal P_{inter,18} of the current block 18, based on a neighborhood signal in a spatial neighborhood 100, see 100₁₀₂, 100₁₀₄ and 100₆, of the current block 18 to obtain a post-processed inter-prediction signal

$${P}_{i n ter , 18}^{*}$$

for the current block 18. The inter-prediction signal P_{inter,18} of the current block 18, for example, is generated by an inter-prediction tool 110₂, which may correspond to the second predetermined decoding/encoding tool. The current block 18 may be reconstructable by a sample-wise combination of the post-processed inter-prediction signal

$${P}_{i n ter , 18}^{*}$$

with a prediction residual signal R associated with the current block 18. Blocks onto which the STRN tool is applied may be referred to as STRN blocks in the following.

The STRN tool 110₁, for example, is configured to, using a neural-network or a convolution, post-process the inter-prediction signal P_{inter,18} of the current block 18 based on a 3D tensor comprising one or more matrices derived from corresponding portions in one or more references pictures, and one or more matrices derived from the inter-prediction signal P_{inter,18} of the current block 18 accompanied by the neighborhood signal. Optionally, the one or more matrices derived from the corresponding portions in the one or more references pictures may be derived from the corresponding portions in the one or more references pictures accompanied by a respective spatial neighborhood, i.e. a spatial neighborhood of a corresponding portion. Optionally, the 3D tensor may comprise one or more further matrices. The STRN tool 110₁ may be configured to perform a neural network based prediction filtering. The application of a neural network to the prediction signal of a block, e.g., to the inter-prediction signal P_{inter,18} of the current block 18, enhances the quality of the prediction signal, therefore improving the coding efficiency. The neighborhood signal as additional input further enhances the quality of the inter-prediction signal P_{inter,18} of the current block 18. The STRN tool 110₁ may be configured to perform the post-processing as described in detail with regard to FIG. 13 or FIG. 15.

FIG. 7 shows exemplarily a picture area of a current picture 10 with an inter-predicted block 104 and an intra-predicted block 106 positioned adjacent to the current block, i.e. on the left and on the top of the current block 18. The inter-predicted block 104 overlaps with the spatial neighborhood 100 of the current block 18 in a first spatially neighboring portion 100₁₀₂ and in a second spatially neighboring portion 100₁₀₄ and the intra-predicted block 106 overlaps with the spatial neighborhood 100 of the current block 18 in a third spatially neighboring portion 100₁₀₆. The inter-predicted block 104 can be reconstructed by a sample-wise combination of an inter-prediction signal P_{inter,104} of the inter-predicted block 104 and a prediction residual signal of inter-predicted block 104 and the intra-predicted block 106 can be reconstructed by a sample-wise combination of an intra-prediction signal Pᵢₙₜᵣₐ of the intra-predicted block 106 and a prediction residual signal of the intra-predicted block 106.

A plurality of decoding/encoding tools of the decoder 54/encoder 14 comprises one or more inter-prediction tools, e.g., as the one or more second predetermined decoding/encoding tools, configured to generate inter-prediction signals, e.g., as contribution signals of the one or more second predetermined decoding/encoding tools. The inter-prediction signal P_{inter,104} of the inter-predicted block 104 is an inter-prediction signal of the one or more inter-prediction tools. The plurality of decoding/encoding tools of the decoder 54/encoder 14 may comprise, additionally or alternatively, one or more intra-prediction tools, e.g., as the one or more third predetermined decoding/encoding tools, configured to generate intra-prediction signals, e.g., as contribution signals of the one or more third predetermined decoding/encoding tools. The intra-prediction signal Pᵢₙₜᵣₐ of the intra-predicted block 106 is an intra-prediction signal of the one or more intra-prediction tools.

Optionally, the inter-predicted block 104 is further subdivided into subblocks comprising the subblock indicated in FIG. 7 by the reference numeral 102. According to an embodiment, a post-processing by the STRN-tool 110₁ is enabled for the subblock 102 and the STRN tool 110₁ is configured to post-process the inter-prediction signal P_{inter,102} of the subblock 102 to obtain a post-processed inter-prediction signal

$${P}_{i n ter , 102}^{*}$$

for the subblock 102. The subblock 102 is reconstructable by a sample-wise combination of the post-processed inter-prediction signal

$${P}_{i n ter , 102}^{*}$$

of the subblock 102 and a prediction residual signal R of the subblock 102.

In the following a generation of the neighborhood signal in the spatial neighborhood 100 of the current block 18 for the post-processing of the STRN tool 110₁ is described in more detail.

As can be seen in FIG. 7, an inter-prediction signal, e.g. P_{inter,102} combined with P_{inter,104}, generated by the one or more inter-prediction tools within the spatial neighborhood, i.e. within the first spatially neighboring portion 100₁₀₄ and the second spatially neighboring portion 100₁₀₄, is used in a version not post-processed by the STRN tool for the generation of the neighborhood signal. Thus, independent whether the complete inter-predicted block 104 or only a subblock 102 of the inter-predicted block 104 is post-processed by the STRN tool, for the generation of the neighborhood signal only the inter-prediction signal generated by the one or more inter-prediction tools is used and not the post-processed version of this inter-prediction signal. Generally speaking, contribution signals of the one or more second predetermined decoding/encoding tools within the spatial neighborhood 100 are only considered in a version not post-processed by the STRN tool for the generation of the neighborhood signal.

Specifically in case of the example shown in FIG. 7, the video decoder 54/encoder 14 would be configured to, for the generation of the neighborhood signal for the current block 18,
use the inter-prediction signal P_{inter,102} of the subblock 102 within the first spatially neighboring portion 100₁₀₂, wherein the first spatially neighboring portion 100₁₀₂ corresponds to a portion of the subblock 102 of the inter-predicted block 104, for which a post-processing by the STRN tool 110₁ is enabled and which overlaps the spatially neighborhood 100 of the current block 18, and
use the inter-prediction signal P_{inter,104} of the inter-predicted block 104 within the second spatially neighboring portion 100₁₀₄, wherein the second spatially neighboring portion 100₁₀₄ corresponds to a portion of the inter-predicted block 104, which is not post-processed by the STRN tool 110₁ and overlaps the spatially neighborhood 100 of the current block 18.

The video decoder 54/encoder 14 is configured to, at the generation of the neighborhood signal for the current block 18, either use the inter-prediction signal, e.g. P_{inter,102} combined with P_{inter,104}, and disregard a prediction residual signal within the overlap region/area, see 100₁₀₂ and 100₁₀₄, or use a sample-wise combination of the inter-prediction signal, e.g. P_{inter,102} combined with P_{inter,104}, generated by the one or more inter-prediction tools within the spatial neighborhood, i.e. within the first spatially neighboring portion 100₁₀₂ and the second spatially neighboring portion 100₁₀₄, with the prediction residual signal R. FIG. 7, for example, shows that the decoder 54/encoder 14 is configured to generate the neighborhood signal by using the inter prediction signal P_{inter,102} of the subblock 102 within the first spatially neighboring portion 100₁₀₂ combined with the prediction residual signal R of the subblock 102 within the first spatially neighboring portion 100₁₀₂ and by using the inter prediction signal P_{inter,104} of the subblock 104 within the second spatially neighboring portion 100₁₀₄ combined with the prediction residual signal R of the subblock 104 within the second spatially neighboring portion 100₁₀₄.

For neighboring intra-predicted blocks, see intra-predicted block 106, overlapping with the spatial neighborhood 100, see the third spatially neighboring portion 100₁₀₆, the respective intra-prediction signal is excluded 124 or substituted 122 by a substitute signal at the generation of the neighborhood signal. Further, the prediction residual signal R within the third spatially neighboring portion 100₁₀₆ may be disregarded at the generation of the neighborhood signal. The video decoder 54/encoder 14, for example, is configured to exclude from the spatial neighborhood 100 samples, i.e., the third spatially neighboring portion 100₁₀₆, for which the sample-wise combination for the derivation of the reconstructed signal 58 involves the intra-prediction signal Pᵢₙₜᵣₐ. Alternatively, the video decoder 54/encoder 14, for example, is configured to use an extended inter-prediction signal

$${P}_{i n ter , 18}^{e x t e n d e d}$$

of the current block 18, i.e. the substitute signal, at the generation of the neighborhood signal. The extended inter-prediction signal

$${P}_{i n ter , 18}^{e x t e n d e d}$$

corresponds to an extension of the inter-prediction signal P_{inter,18} of the current block 18 onto the third spatially neighboring portion 100₁₀₆, wherein the third spatially neighboring portion 100₁₀₆ corresponds to a portion of the intra-predicted block 106 overlapping with the spatial neighborhood 100 of the current block 18. In other words, for example, samples for which the sample-wise combination for the derivation of the reconstructed signal 58 involves the intra-prediction signal, i.e. the contribution signal of the one or more third predetermined decoding/encoding tools within the spatial neighborhood, may be substituted with samples generated by inter-prediction, e.g., by the one or more second predetermined decoding/encoding tools. An inter-prediction signal P_{inter,18} of a current block 18 can be extended onto a portion 100₁₀₆ of the spatial neighborhood 100, for which the derivation of the reconstructed signal 58 involves an intra-prediction signal, e.g., the contribution signal of the one or more third predetermined decoding/encoding tools within the spatial neighborhood, and this extended inter-prediction signal

$${P}_{i n ter , 18}^{e x t e n d e d}$$

can then function as the substitute signal.

Above, the neighboring blocks, see 102, 104 and 106, are discussed individually in terms of what signals associated with the respective block are considered for the generation of the neighborhood signal. But it is clear that the whole spatial neighborhood 100 is considered at the generation. Therefore, for example, within the spatial neighborhood all inter-prediction signals, i.e. of inter-predicted blocks and in a version not post-processed of STRN blocks, are considered and all intra-prediction signals are either excluded 124 or substituted by the substitute signal, which is instead considered. Optionally, a deblocking filter can be applied within the spatial neighborhood 100, so that edges between areas that contain different signal types, e.g. an edge between the second spatially neighboring portion 100₁₀₄ and the third spatially neighboring portion 100₁₀₆, are smoothened or reduced.

This special generation of the neighborhood enables a parallelization of coding processes and increases therefore a coding efficiency. For example, the exclusion or substitution of intra-prediction signals within the neighborhood 100 of the current block 18 enables to process STRN-blocks independent of a processing of intra-blocks and/or to process STRN-blocks parallel to intra-blocks. Further, the usage of prediction signals of STRN blocks in a version not post-processed by the STRN tool 110₁, i.e. P and not P*, within the neighborhood 100, enables to process all STRN-block of a picture 10 in parallel.

The basic idea involved with this concept is to apply a neural network or a convolution to the prediction signal of a block, e.g., to the inter-prediction signal P_{inter,18} of the current block 18, in order to enhance its quality, therefore improving the coding efficiency and use neighboring reconstructed (i.e., top/left) samples as additional input to the neural network to further improve the quality of the prediction signal. However, a problem involved with this idea is that the input of the neural network for one block depends on the output of the neural network for preceding blocks, because the reconstructed neighboring samples can only be obtained after application of the network, e.g., see the neighboring samples within the first spatially neighboring portion 100₁₀₂.

This problem can be solved the following way:
Use neighboring predicted samples, e.g., before application of the neural network, instead of the neighboring reconstructed samples within the border extension, e.g., use the prediction signal, e.g., P_{inter,102}, in a version not post-processed by the neural network.
Also, do not use samples from neighboring intra blocks, see the intra-predicted block 106. Instead, use the, e.g., enlarged, prediction signal of the current block, i.e. the extended inter-prediction signal

$${P}_{i n ter , 18}^{e x t e n d e d}$$

of the current block 18.
   In different embodiments, the decision to use the enlarged current prediction signal, i.e. the extended inter-prediction signal

$${P}_{i n ter , 18}^{e x t e n d e d} ,$$

instead of the reconstructed samples of neighboring intra predicted blocks can e made at different granularities within the border extension region, i.e. within the spatial neighborhood 100:
   decide for each (sub)block individually (e.g. using 4×4 areas).
   decide once for larger contiguous areas (e.g. only distinguishing between top, left, and top-left area).
This would allow a two-staged (inter) reconstruction process, wherein each stage can be performed in parallel for all blocks:
   a) do the regular inter-prediction (i.e., motion-compensation, sub-pel filtering etc.),
   b) apply the NN to the output signals of the 1st stage for each block.

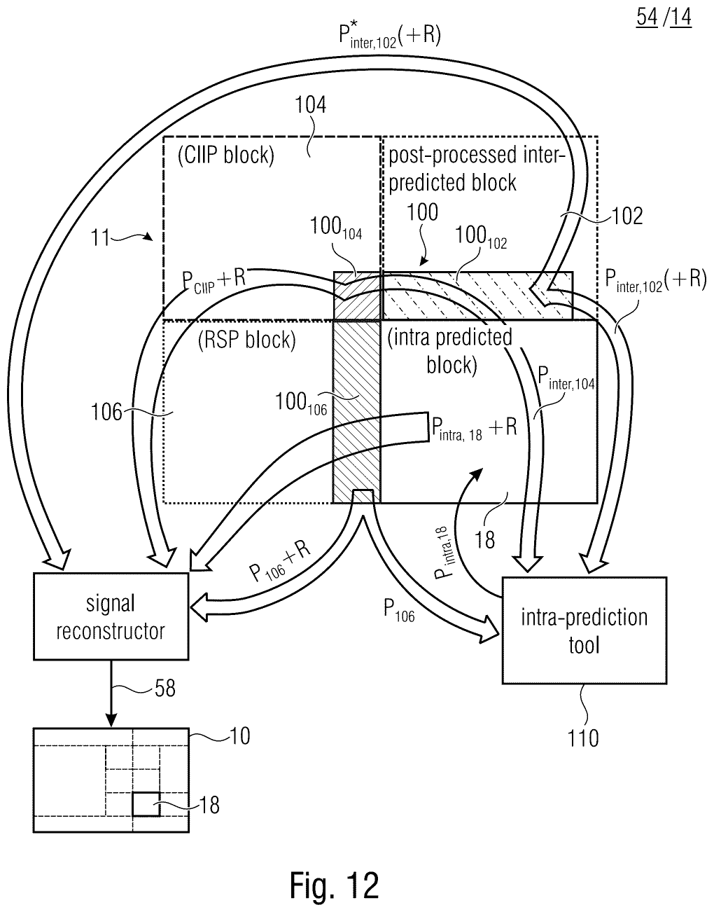

An alternative solution would be like the solution above, but with the following differences:
Use the sum of the initial neighboring prediction signal, see P_{inter,102}, (before application of the NN) and the (neighboring) residual signal R in the border extension region, see the first spatially neighboring portion 100₁₀₂. The resulting “intermediate reconstruction” signal might be closer to the actual reconstructed signal, but would still allow block-parallel application of the NN in the 2-staged process.
For intra prediction, also use the “intermediate reconstruction” signal as the input. This would allow to do the intra prediction in parallel to the 2nd step of the 2-stage approach (e.g., see FIG. 12).

Generally, the following may apply:
Consider the prediction process as a composition of a primary, low-complexity stage (e.g., motion-compensation using FIR filters) and a secondary, higher complexity stage (e.g., application of a neural network).
Let the input of the secondary stage only depend on outcomes of the primary stage of preceding blocks.
A generalization into a higher number of stages may also be possible: Let the input of stage N only depend on outcomes of stages N′ from preceding blocks with N′<N.

Optionally, the usage of two or more neural networks or convolutions may be allowed. For example, the STRN tool 110₁ may be configured to select for each STRN-block a neural network out of a set of two or more neural networks or a convolution out of a set of two or more convolutions. The STRN tool 110₁ in FIG. 7, for example, may be configured to select, for the current block 18, the neural network out of a set of two or more neural networks or a convolution out of a set of two or more convolutions and use the selected neural network or the selected convolution to determine the post-processed inter-prediction signal

$${P}_{i n ter , 18}^{*}$$

for the current block 18. The neural network or the convolution used by the STRN-tool, for example, is selected per STRN-block, per picture, per sequence of pictures or once for the complete video.

The neural networks of the set of two or more neural networks may differ from each other in their parameters, such as (learned) weights and/or (learned) biases, and/or in their structure, such as number of layers, type of layers (e.g., 2D convolution, 3D convolution, fully connected layer, etc.) and/or an input tensor format (e.g., number of channels, type of channels, border size, etc.). Similarly the convolutions of the set of two or more convolutions may differ from each other in their parameters, such as (learned) weights and/or (learned) biases, and/or in their structure, such as type of the respective convolution (e.g., 2D convolution, 3D convolution, fully connected layer, etc.) and/or an input tensor format (e.g., number of channels, type of channels, border size, etc.).

The neural network or the convolution selected for the current block 18 may be explicitly signaled in a data stream per sequence and/or per segment of a sequence (e.g., group of pictures, random access point, etc.) and/or per picture and/or per slice and/or per block (e.g., CTU, prediction block, etc.). In other words, the video encoder 14 may be configured to select the neural network or the convolution for the current block 18 and indicate same in the data stream, i.e. encode an information indicating the selected neural network or convolution, e.g., information pointing to a neural network within the set of two or more neural networks or to a convolution within the set of two or more convolutions. The video decoder 54 may be configured to select, controlled by the data stream, the neural-network or the convolution, e.g., by deriving the information indicating the selected neural network or convolution from the data stream.

Alternatively, or in combination with the explicit signaling, the video encoder 14/video decoder 54 may be configured to select the neural network or the convolution for the current block 18 depending on
a block shape, e.g., number of samples within the current block 18, aspect ratio of the current block 18, max(width,height), min(width,height), etc., and/or
the coding/prediction mode associated with the current block 18, e.g., the neural network or the convolution may be different for uni- and bi-prediction, different for tools that don't use simple averaging for bi-prediction such as BIO and BCW, etc., and/or
the temporal layer of the current picture 10, e.g., the neural network or the convolution may be different for reference and non-reference pictures, and/or
the quantization parameter, e.g., slice QP or block QP, associated with the current block 18, and/or
the residual signal, e.g., the neural network or the convolution may be different for blocks with and without transmitted residual signal, and/or
the POC difference between current and reference picture(s), e.g., the neural network or the convolution may be different for smaller and larger POC differences, different for symmetrical and asymmetrical POC differences, etc., and/or
the motion vector, e.g., the accuracy of the motion vector, e.g., different for blocks with zero and non-zero motion vectors.

Optionally, all or parts of the network/convolution parameters are transmitted in the bitstream/data stream. According to an embodiment, the video encoder 14/video decoder 54 is configured to encode/decode one or more parameters of the neural network or the convolution selected for the current block 18 into/from the data stream. At the decoder side, the STRN tool 110₁ may be configured to reconstruct the neural network or the convolution based on the one or more parameters of the neural network or the convolution. For example, a subset of parameters or a full set of parameters are transmitted at the very beginning of the bitstream, of a sequence of pictures or of a random access point. According to an embodiment, an update of parameters, i.e. indicating the selected neural network or convolution, may be transmitted in the data stream. For example, a full update, e.g., a new full set of parameters, and/or a partial update, e.g., only biases, only weights, only parameters of one or more specific layers, etc., and/or, a differential update, e.g., only correction values to the current parameter values, may be transmitted in the data stream.

FIG. 8 shows an embodiment of a decoder 54/encoder 14 with a LIC tool 110₁, as the first predetermined decoding/encoding tool, and may comprise features and or functionalities as described with regard to decoder 54/encoder 14 in FIG. 7

The LIC tool 110₁ is configured to post-process an inter-prediction signal P_{inter,18} of the current block 18, based on a neighborhood signal in a spatial neighborhood 100, see 100₁₀₂, 100₁₀₄ and 100₆, of the current block 18 to obtain a post-processed inter-prediction signal

$${P}_{i n ter , 18}^{*}$$

for the current block 18. The inter-prediction signal P_{inter,18} of the current block 18, for example, is generated by an inter-prediction tool 110₂, which may correspond to the second predetermined decoding/encoding tool. The current block 18 may be reconstructable by a sample-wise combination of the post-processed inter-prediction signal

$${P}_{i nter , 18}^{*}$$

with a prediction residual signal R associated with the current block 18. Blocks onto which the LIC tool is applied may be referred to as LIC blocks in the following.

The LIC tool 110₁ is configured to post-process the inter-prediction signal P_{inter,18} of the current block 18 by determining or adapting a scaling value and an offset value based on the neighborhood signal and by using the scaling value and the offset value to post-process the inter-prediction signal P_{inter,18} of the current block 18. The video decoder 54/encoder 14, for example, is configured to, e.g., using the neighborhood signal, derive a scaling value and an offset value to adjust the luminance of the current block 18, e.g., an inter prediction block, to that of the top and left neighboring, e.g., reconstructed, samples.

The neighborhood signal for the post-processing of the inter-prediction signal P_{inter,18} of the current block 18 may be generated as described with regard to FIG. 7, with the only difference that the subblock 102 represents a LIC block and thus inter-prediction signals within the spatial neighborhood 100, see the first spatially neighboring portion 100₁₀₂ and/or the second spatially neighboring portion 100₁₀₄, are considered in a version not post-processed by the LIC tool 110₁.

This special generation of the neighborhood enables a parallelization of coding processes and increases therefore a coding efficiency. For example, the exclusion or substitution of intra-prediction signals within the neighborhood 100 of the current block 18 enables to process LIC-blocks independent of a processing of intra-blocks and/or to process LIC-blocks parallel to intra-blocks. Further, the usage of prediction signals of LIC blocks in a version not post-processed by the LIC tool 110₁, i.e. P and not P*, within the neighborhood 100, enables to process all LIC-block of a picture 10 in parallel.

FIG. 9 shows an embodiment of a decoder 54/encoder 14 with a CIIP tool 110₁, as the first predetermined decoding/encoding tool.

The CIIP tool 110₁ is configured to generate an inter-intra prediction signal P_{CIIP,18} of the current block 18, based on a neighborhood signal in a spatial neighborhood 100, see 100₁₀₂, 100₁₀₄ and 100₆, of the current block 18. The current block 18 may be reconstructable by a sample-wise combination of the inter-intra prediction signal P_{CIIP,18} with a prediction residual signal R associated with the current block 18. Blocks onto which the CIIP tool is applied may be referred to as CIIP blocks in the following.

The CIIP tool 110₁, for example, is configured to, generate the inter-intra prediction signal P_{CIIP,18} of the current block 18 using inter-prediction, e.g., see the inter part 116 of the CIIP tool 110₁, and using intra-prediction, e.g., see the intra part 118 of the CIIP tool 110₁. The CIIP tool uses the neighborhood signal for the intra-prediction. For example, the CIIP tool 110₁ generates the inter-intra prediction signal P_{CIIP,18} of the current block 18 by a weighted combination of an, e.g., planar, intra predictor (e.g., using the neighborhood signal/neighboring signal) and a motion-compensated temporal predictor, i.e. an inter-predictor, e.g., of a selected merge candidate.

FIG. 9 shows exemplarily a picture area of a current picture 10 with an CIIP block 102, an inter-predicted block 104 and an intra-predicted block 106 positioned adjacent to the current block 18, i.e. on the left and on the top of the current block 18. The CIIP block 102 overlaps with the spatial neighborhood 100 of the current block 18 in a first spatially neighboring portion 100₁₀₂, the inter-predicted block 104 overlaps with the spatial neighborhood 100 of the current block 18 in a second spatially neighboring portion 100₁₀₄ and the intra-predicted block 106 overlaps with the spatial neighborhood 100 of the current block 18 in a third spatially neighboring portion 100₁₀₆. The CIIP block 102 can be reconstructed by a sample-wise combination of an inter-intra prediction signal P_{CIIP,102} within the CIIP block 102 and a prediction residual signal within the CIIP block 102, the inter-predicted block 104 can be reconstructed by a sample-wise combination of an inter-prediction signal P_{inter,104} within the inter-predicted block 104 and a prediction residual signal R within the inter-predicted block 104 and the intra-predicted block 106 can be reconstructed by a sample-wise combination of an intra-prediction signal Pᵢₙₜᵣₐ within the intra-predicted block 106 and a prediction residual signal within the intra-predicted block 106.

A plurality of decoding/encoding tools of the decoder 54/encoder 14 comprises one or more inter-prediction tools, e.g., as the one or more second predetermined decoding/encoding tools, configured to generate inter-prediction signals, e.g., as contribution signals of the one or more second predetermined decoding/encoding tools. The inter-prediction signal P_{inter,104} of the inter-predicted block 104 is an inter-prediction signal of the one or more inter-prediction tools. The plurality of decoding/encoding tools of the decoder 54/encoder 14 may comprise, additionally or alternatively, one or more intra-prediction tools, e.g., as the one or more third predetermined decoding/encoding tools or as the one or more fourth predetermined decoding/encoding tools, configured to generate intra-prediction signals, e.g., as contribution signals of the one or more third predetermined decoding/encoding tools. The intra-prediction signal Pᵢₙₜᵣₐ of the intra-predicted block 106 is an intra-prediction signal of the one or more intra-prediction tools.

In the following a generation of the neighborhood signal in the spatial neighborhood 100 of the current block 18 for the intra-prediction by the CIIP tool 110₁ is described in more detail.

For CIIP blocks, see CIIP block 102, overlapping with the spatial neighborhood 100, see the first spatially neighboring portion 100₁₀₂, the respective inter-prediction signal within the spatial neighborhood, e.g., generated by the inter part 116 of the CIIP tool 110₁, may be used for the generation of the neighborhood signal and not the inter-intra prediction signal P_{CIIP,102} within the first spatially neighboring portion 100₁₀₂. In other words, the video decoder 54/encoder 14 may be configured to generate the neighborhood signal by substituting the inter-intra prediction signal P_{CIIP,102}, e.g., a contribution signal of a third predetermined decoding/encoding tool corresponding to the first predetermined decoding/encoding tool, within the spatial neighborhood, by the inter-prediction signal P_{inter,102}, e.g., a substitute signal generated independent from spatial signal-interdependencies, generated by the CIIP tool 110₁ within the spatial neighborhood, i.e. within the first spatially neighboring portion 100₁₀₂. Further, the prediction residual signal R within the first spatially neighboring portion 100₁₀₂ may be disregarded at the generation of the neighborhood signal.

No special constraints apply to inter-predicted blocks, like the inter-predicted block 104. For inter-predicted blocks the respective inter-prediction signal P_{inter,104} within the spatial neighborhood 100 is usable for the generation of the neighborhood signal. The video decoder 54/encoder 14, for example, is configured to, at the generation of the neighborhood signal, within the second spatially neighboring portion 100₁₀₄, either use the inter-prediction signal P_{inter,104} and disregard a prediction residual signal R or use a sample-wise combination of the inter-prediction signal P_{inter,104} with the prediction residual signal R.

For intra-predicted blocks, e.g., see intra-predicted block 106, overlapping with the spatial neighborhood 100, see the third spatially neighboring portion 100₁₀₆, the respective intra-prediction signal is substituted 122 by a substitute signal, see

$${P}_{inter , 18}^{extended} ,$$

at the generation of the neighborhood signal. Further, the prediction residual signal R within the third spatially neighboring portion 100₁₀₆ may be disregarded at the generation of the neighborhood signal. The video decoder 54/encoder 14, for example, is configured to use an extended inter-prediction signal

$${P}_{inter , 18}^{extended}$$

of the current block 18 at the generation of the neighborhood signal. The extended inter-prediction signal

$${P}_{inter , 18}^{extended}$$

corresponds to an extension of the inter-prediction signal of the current block 18, e.g., generated by the inter part 116 of the CIIP tool 110₁, onto the third spatially neighboring portion 100₁₀₆, wherein the third spatially neighboring portion 100₁₀₆ corresponds to a portion of the intra-predicted block 106 overlapping with the spatial neighborhood 100 of the current block 18. In other words, for example, samples for which the sample-wise combination for the derivation of the reconstructed signal 58 involves the intra-prediction signal, i.e. the contribution signal of the one or more third predetermined decoding/encoding tools within the spatial neighborhood, may be substituted 122 with samples generated by inter-prediction, e.g., by the inter part 116 of the CIIP tool 110₁. An inter-prediction signal P_{inter,18} of a current block 18 can be extended onto a portion 100₁₀₆ of the spatial neighborhood 100, for which the derivation of the reconstructed signal 58 involves an intra-prediction signal, e.g., the contribution signal of the one or more third predetermined decoding/encoding tools within the spatial neighborhood, and this extended inter-prediction signal

$${P}_{inter , 18}^{extended}$$

can then function as the substitute signal.

Above, the neighboring blocks, see 102, 104 and 106, are discussed individually in terms of what signals associated with the respective block are considered for the generation of the neighborhood signal. But it is clear that the whole spatial neighborhood 100 is considered at the generation. Therefore, for example, within the spatial neighborhood all inter-prediction signals, i.e. inter-prediction signals of inter-predicted blocks and the inter-prediction signals generated by the inter part 116 of the CIIP tool 110₁ for CIIP blocks, are considered and all intra-prediction signals of intra-predicted blocks are substituted 122 by the extended inter-prediction signal, which is instead considered. Optionally, a deblocking filter can be applied within the spatial neighborhood 100, so that edges between areas that contain different signal types, e.g. an edge between the second spatially neighboring portion 100₁₀₄ and the third spatially neighboring portion 100₁₀₆, are smoothened or reduced.

This special generation of the neighborhood enables a parallelization of coding processes and increases therefore a coding efficiency. For example, the substitution of intra-prediction signals within the neighborhood 100 of the current block 18 enables to process CIIP-blocks independent of a processing of intra-blocks and/or to process CIIP-blocks parallel to intra-blocks. Further, the usage of only the inter-prediction signals of CIIP blocks and the disregarding of the intra-prediction signals of the CIIP blocks within the neighborhood 100 enables to process all CIIP-block of a picture 10 in parallel.

FIG. 10 shows an embodiment of a decoder 54/encoder with an RSP tool 110₁, as the first predetermined decoding/encoding tool.

The RSP tool 110₁ is configured to generate a prediction residual signal R₁₈ of the current block 18, based on a neighborhood signal in a spatial neighborhood 100, see 100₁₀₂, 100₁₀₄ and 100₆, of the current block 18. The current block 18 may be reconstructable by a sample-wise combination of a prediction signal P, e.g. an inter-prediction signal, an intra-prediction signal or an inter-intra prediction signal, with the prediction residual signal R₁₈ of the current block 18. Blocks onto which the RSP tool is applied may be referred to as RSP blocks in the following.

The RSP tool 110₁, for example, is configured to generate the prediction residual signal R₁₈, e.g., as the contribution signal of the first predetermined decoding/encoding tool, for the current block 18 by deriving residual values for the current block 18, e.g., from a data stream, and predicting signs of the derived residual values based on the neighborhood signal in the spatial neighborhood of the current block. The RSP tool 110₁, for example, is configured to, generate the prediction residual signal R₁₈ by estimating the signs of a residual block from the neighborhood signal. Optionally, the RSP tool 110₁ is configured generate the prediction residual signal R₁₈ for the current block 18 by deriving residual values for the current block 18 and differences between predicted signs and true signs of the residual values, e.g., from a data stream, predicting signs of the residual values based on the neighborhood signal in the spatial neighborhood of the current block to obtain the predicted signs and reconstructing the signs by combining the predicted signs and the differences. If the signs are well estimated, the differences tends to be zero, and they are efficiently entropy-coded by CABAC.

FIG. 10 shows exemplarily a picture area of a current picture 10 with an RSP block 102, an inter-predicted block 104 and an intra-predicted block 106 positioned adjacent to the current block 18, i.e. on the left and on the top of the current block 18. The RSP block 102 overlaps with the spatial neighborhood 100 of the current block 18 in a first spatially neighboring portion 100₁₀₂, the inter-predicted block 104 overlaps with the spatial neighborhood 100 of the current block 18 in a second spatially neighboring portion 100₁₀₄ and the intra-predicted block 106 overlaps with the spatial neighborhood 100 of the current block 18 in a third spatially neighboring portion 100₁₀₆. The RSP block 102 can be reconstructed by a sample-wise combination of a prediction signal P₁₀₂, e.g. an inter-prediction signal, an intra-prediction signal or an inter-intra prediction signal, within the RSP block 102 and a prediction residual signal, e.g., generated by the RSP tool 110₁, within the RSP block 102, the inter-predicted block 104 can be reconstructed by a sample-wise combination of an inter-prediction signal P_{inter,104} within the inter-predicted block 104 and a prediction residual signal R within the inter-predicted block 104 and the intra-predicted block 106 can be reconstructed by a sample-wise combination of an intra-prediction signal Pᵢₙₜᵣₐ within the intra-predicted block 106 and a prediction residual signal within the intra-predicted block 106.

A plurality of decoding/encoding tools of the decoder 54/encoder 14 comprises one or more inter-prediction tools, e.g., as the one or more second predetermined decoding/encoding tools, configured to generate inter-prediction signals, e.g., as contribution signals of the one or more second predetermined decoding/encoding tools. The inter-prediction signal P_{inter,104} of the inter-predicted block 104 is an inter-prediction signal of the one or more inter-prediction tools. The plurality of decoding/encoding tools of the decoder 54/encoder 14 may comprise, additionally or alternatively, one or more intra-prediction tools, e.g., as the one or more third predetermined decoding/encoding tools or as the one or more fourth predetermined decoding/encoding tools, configured to generate intra-prediction signals, e.g., as contribution signals of the one or more third predetermined decoding/encoding tools. The intra-prediction signal Pᵢₙₜᵣₐ of the intra-predicted block 106 is an intra-prediction signal of the one or more intra-prediction tools.

In the following a generation of the neighborhood signal in the spatial neighborhood 100 of the current block 18 for the RSP tool 110₁ is described in more detail.

No special constraints apply to inter-predicted blocks, like the inter-predicted block 104. The following considerations apply independent of whether the current block 18 is an inter-predicted block or not. For inter-predicted blocks the respective inter-prediction signal P_{inter,104} within the spatial neighborhood 100 is usable for the generation of the neighborhood signal. The video decoder 54/encoder 14, for example, is configured to, at the generation of the neighborhood signal, within the second spatially neighboring portion 100₁₀₄, use the inter-prediction signal P_{inter,104} and disregard a prediction residual signal R, if the inter-predicted block 104 is a RSP-block. The video decoder 54/encoder 14, for example, is configured to, at the generation of the neighborhood signal, within the second spatially neighboring portion 100₁₀₄, use a sample-wise combination of the inter-prediction signal P_{inter,104} with the prediction residual signal R, if the inter-predicted block 104 is not a RSP-block.

For intra-predicted blocks, e.g., see intra-predicted block 106, overlapping with the spatial neighborhood 100, see the third spatially neighboring portion 100₁₀₆, the respective intra-prediction signal is substituted by a substitute signal, see

$${P}_{inter , 18}^{extended} ,$$

at the generation of the neighborhood signal, if the current block 18 is an inter-predicted block. Further, the prediction residual signal R within the third spatially neighboring portion 100₁₀₆ may be disregarded at the generation of the neighborhood signal. The video decoder 54/encoder 14, for example, is configured to use an extended inter-prediction signal

$${P}_{inter , 18}^{extended}$$

of the current block 18 at the generation of the neighborhood signal. The extended inter-prediction signal

$${P}_{inter , 18}^{extended}$$

corresponds to an extension of the inter-prediction signal of the current block 18, e.g., generated by the inter coding tool 110₂, onto the third spatially neighboring portion 100₁₀₆, wherein the third spatially neighboring portion 100₁₀₆ corresponds to a portion of the intra-predicted block 106 overlapping with the spatial neighborhood 100 of the current block 18. In other words, for example, samples for which the sample-wise combination for the derivation of the reconstructed signal 58 involves the intra-prediction signal, i.e. the contribution signal of the one or more third predetermined decoding/encoding tools within the spatial neighborhood, may be substituted with samples generated by inter-prediction. An inter-prediction signal P_{inter,18} of a current block 18 can be extended onto a portion 100₁₀₆ of the spatial neighborhood 100, for which the derivation of the reconstructed signal 58 involves an intra-prediction signal, e.g., the contribution signal of the one or more third predetermined decoding/encoding tools within the spatial neighborhood, and this extended inter-prediction signal

$${P}_{inter , 18}^{extended}$$

can then function as the substitute signal.

Alternatively, if the current block 18 is not an inter-predicted block,
the video decoder 54/encoder 14 may be configured to disable the RSP tool 110₁ for the current block 18, if an intra-predicted block, e.g., see intra-predicted block 106, overlaps with the spatial neighborhood 100, see the third spatially neighboring portion 100₁₀₆, of the current block 18,
or
the video decoder 54/encoder 14 may be configured to predict a motion vector for the third spatially neighboring portion 100₁₀₆, use the motion vector to determine an inter-prediction signal P_{inter,106} within the spatial neighborhood, i.e. within the third spatially neighboring portion 100₁₀₆, and use the determined inter-prediction signal P_{inter,106}, e.g., as substitute signal, at the generation of the neighborhood signal and disregard the prediction residual signal R within the third spatially neighboring portion 100₁₀₆.

For RSP blocks, see RSP block 102, overlapping with the spatial neighborhood 100, see the first spatially neighboring portion 100₁₀₂, the respective inter-prediction signal within the spatial neighborhood is used at the generation of the neighborhood signal, if the RSP block 102 is an inter-predicted block. Further, the prediction residual signal R within the first spatially neighboring portion 100₁₀₂ may be disregarded at the generation of the neighborhood signal. Alternatively, if the RSP block 102 is not an inter-predicted block, the RSP block 102 is considered like the intra-predicted block 106 described above at the generation of the neighborhood signal.

Above, the neighboring blocks, see 102, 104 and 106, are discussed individually in terms of what signals associated with the respective block are considered for the generation of the neighborhood signal. But it is clear that the whole spatial neighborhood 100 is considered at the generation. Optionally, a deblocking filter can be applied within the spatial neighborhood 100, so that edges between areas that contain different signal types, e.g. an edge between the second spatially neighboring portion 100₁₀₄ and the third spatially neighboring portion 100₁₀₆, are smoothened or reduced.

This special generation of the neighborhood enables a parallelization of coding processes and increases therefore a coding efficiency. For example, the substitution of intra-prediction signals within the neighborhood 100 of the current block 18 or the disabling of the RSP tool 110₁, if one or more intra-blocks are comprised by the neighborhood 100 or overlap with the neighborhood 100, enables to process RSP-blocks independent of a processing of intra-blocks and/or to process RSP-blocks parallel to intra-blocks. Further, the disregarding of prediction residual signals of inter-predicted blocks comprised by the neighborhood 100 or overlapping with the neighborhood 100 enables to process all RSP-blocks of a picture 10 in parallel.

FIG. 11 shows an embodiment of a decoder 54/encoder 14 with a TM tool 110₁, as the first predetermined decoding/encoding tool.

The TM tool 110₁ is configured to generate a prediction signal P₁₈, e.g., an inter-prediction signal, an intra-prediction signal or an inter-intra prediction signal, of the current block 18, based on a neighborhood signal in a spatial neighborhood 100, see 100₁₀₂, 100₁₀₄ and 100₆, of the current block 18. The current block 18 may be reconstructable by a sample-wise combination of the prediction signal P₁₈ with a prediction residual signal R of the current block 18. Blocks onto which the TM tool is applied may be referred to as TM blocks or TM-predicted blocks in the following. The prediction signal P₁₈ may be called TM-prediction signal and a prediction residual signal may be called TM-prediction residual signal.

The TM tool 110₁, for example, is configured to, generate the prediction signal P₁₈, e.g., as the contribution signal of the first predetermined decoding/encoding tool, for the current block 18 using template matching, wherein the neighborhood signal in the spatial neighborhood 100 of the current block 18 represents a template for the template matching.

FIG. 11 shows exemplarily a picture area of a current picture 10 with an inter-predicted block 104 and an intra-predicted block 106 positioned adjacent to the current block 18, i.e. on the left and on the top of the current block 18, as described with regard to FIG. 9 and FIG. 10, and additionally with a TM block 102 positioned adjacent to the current block 18. The TM block 102 overlaps with the spatial neighborhood 100 of the current block 18 in a first spatially neighboring portion 100₁₀₂. The TM block 102 can be reconstructed by a sample-wise combination of a prediction signal P₁₀₂, e.g. an inter-prediction signal, an intra-prediction signal or an inter-intra prediction signal, within the TM block 102, e.g., generated by the TM tool 110₁, and a prediction residual signal within the TM block 102.

In the following a generation of the neighborhood signal in the spatial neighborhood 100 of the current block 18 for the TM tool 110₁ is described in more detail.

No special constraints apply to inter-predicted blocks, like the inter-predicted block 104. For inter-predicted blocks the respective inter-prediction signal P_{inter,104} within the spatial neighborhood 100 is usable for the generation of the neighborhood signal. The video decoder 54/encoder 14, for example, is configured to, at the generation of the neighborhood signal, within the second spatially neighboring portion 100₁₀₄, either use the inter-prediction signal P_{inter,104} and disregard a prediction residual signal R or use a sample-wise combination of the inter-prediction signal P_{inter,104} with the prediction residual signal R.

The video decoder 54/encoder 14 may be configured to disable the TM tool 110₁ for the current block 18, if a TM block, e.g., see TM block 102, overlaps with the spatial neighborhood 100, see the first spatially neighboring portion 100₁₀₂, of the current block 18.

The video decoder 54/encoder 14 may, additionally, or alternatively, be configured to disable the TM tool 110₁ for the current block 18, if an intra-predicted block, e.g., see intra-predicted block 106, overlaps with the spatial neighborhood 100, see the third spatially neighboring portion 100₁₀₆, of the current block 18.

Alternatively, instead of disabling, it is also possible that the video decoder 54/encoder 14 is configured to predict a motion vector for the third spatially neighboring portion 100₁₀₆ (and/or for the first spatially neighboring portion 100₁₀₂), use the motion vector to determine an inter-prediction signal Pᵢₙₜₑᵣ within the spatial neighborhood 100, i.e. within the third spatially neighboring portion 100₁₀₆ (and/or for the first spatially neighboring portion 100₁₀₂), and use the determined inter-prediction signal Pᵢₙₜₑᵣ, e.g., as substitute signal, at the generation of the neighborhood signal. Further, the prediction residual signal R within the third spatially neighboring portion 100₁₀₆ (and/or within the first spatially neighboring portion 100₁₀₂) may be disregarded at the generation of the neighborhood signal.

Above, the neighboring blocks, see 102, 104 and 106, are discussed individually in terms of what signals associated with the respective block are considered for the generation of the neighborhood signal. But it is clear that the whole spatial neighborhood 100 is considered at the generation. Optionally, a deblocking filter can be applied within the spatial neighborhood 100, so that edges between areas that contain different signal types, e.g. an edge between the second spatially neighboring portion 100₁₀₄ and the third spatially neighboring portion 100₁₀₆, are smoothened or reduced.

This special generation of the neighborhood enables a parallelization of coding processes and increases therefore a coding efficiency. For example, the substitution of intra-prediction signals within the neighborhood 100 of the current block 18 or the disabling of the TM tool 110₁, if one or more intra-blocks are comprised by the neighborhood 100 or overlap with the neighborhood 100, enables to process TM-blocks independent of a processing of intra-blocks and/or to process TM-blocks parallel to intra-blocks. Further, the disabling of the TM tool 110₁, if one or more TM-blocks are comprised by the neighborhood 100 or overlap with the neighborhood 100, enables to process all TM-blocks of a picture 10 in parallel.

TM is a texture synthesis technique used in digital image processing, which can be applied for intra prediction as well as for inter prediction. A patch of already decoded/encoded samples present above and left of the current block 18 is called the template. TM finds the best match for the template in the reconstructed frame by minimizing the error between the template and its match, usually measured as sum of squared differences (SSD). Finally, in TM-based prediction, the TM block associated with the error minimizing template match is used as the prediction of the current block. This TM-based prediction approach does not require any side information for generating the corresponding prediction signal at the decoder/encoder, because the same search process is performed there as well.

FIG. 12 shows an embodiment of a video decoder 54/encoder 14 configured to decode/encode avideo from/into a data stream using block-based prediction and transform-based prediction residual coding. FIG. 12 shows exemplarily a video decoder 54/encoder 14 configured to perform the block-based prediction by use of motion-compensated prediction for inter-predicted blocks, by use of intra-prediction for intra-predicted blocks and by use of inter-intra prediction for inter-intra predicted blocks, i.e., CIIP-blocks. However, it should be clear that video decoder 54/encoder 14 is, alternatively, configured to perform the block-based prediction by use of one or more of the motion-compensated prediction, the intra-prediction and the inter-intra prediction. Optionally, the video decoder 54/encoder 14 is configured to perform the transform-based prediction residual coding by use of residual sign prediction.

FIG. 12 shows exemplarily a picture area 11 or a picture portion of a current picture 10 with an intra-predicted block 18, an inter-predicted block 102 and an inter-intra predicted block, i.e. an CIIP-block 104. The block indicated by the reference numeral 106 can be an intra-predicted block, an inter-predicted block or a CIIP-block. The block is called an RSP-block 106 in the following, since a residual sign prediction is enabled for the block. The RSP-block 106, the inter-predicted block 102 and the CIIP-block 104 represent neighboring blocks of the intra-predicted block 18, i.e. they are positioned adjacent to the intra-predicted block 18, i.e. on the left and on the top of the intra-predicted block 18. This arrangement of the blocks 102, 104 and 106 is only for illustration purpose and it should be clear that the block types, i.e. intra-predicted block, inter-predicted block, CIIP-block or RSP-block, of neighboring blocks overlapping with a spatial neighborhood of an intra-predicted block 18 depends on the prediction types, i.e. motion-compensated prediction, the intra-prediction and the inter-intra prediction, and or the residual coding types, i.e. residual sign prediction, supported by the video decoder 54/encoder 14. For example, the blocks 102, 104 and 106 may be intra-predicted blocks and/or inter-predicted blocks, if the video decoder 54/encoder 14 is configured to perform the block-based prediction by use of motion-compensated prediction and intra-prediction or the blocks 102, 104 and 106 may be intra-predicted blocks and/or CIIP-blocks, if the video decoder 54/encoder 14 is configured to perform the block-based prediction by use of intra-prediction and inter-intra prediction or the blocks 102, 104 and 106 may be intra-predicted blocks and/or RSP-blocks, if the video decoder 54/encoder 14 is configured to perform the block-based prediction by use of intra-prediction and perform the transform-based prediction residual coding by use of residual sign prediction, wherein the RSP-blocks may belong to the inter-predicted blocks, or the blocks 102, 104 and 106 may be intra-predicted blocks, inter-predicted blocks and RSP-blocks, if the video decoder 54/encoder 14 is configured to perform the block-based prediction by use of motion-compensated prediction and intra-prediction and perform the transform-based prediction residual coding by use of residual sign prediction, wherein the RSP-block may belong to the inter-predicted blocks and/or the intra-predicted blocks, e.g., the inter-predicted blocks and the intra-predicted blocks may comprise RSP-blocks.

In the embodiment shown in FIG. 12 the inter-predicted block 102 overlaps with the spatial neighborhood 100 of the intra-predicted block 18 in a first spatially neighboring portion 100₁₀₂, the CIIP-block 104 overlaps with the spatial neighborhood 100 of the intra-predicted block 18 in a second spatially neighboring portion 100₁₀₄ and the RSP-block 106 overlaps with the spatial neighborhood 100 of the intra-predicted block 18 in a third spatially neighboring portion 100₁₀₆.

The CIIP-block 104 can be reconstructed by a sample-wise combination of an inter-intra prediction signal P_{CIIP} of the CIIP-block 104 and a prediction residual signal of the CIIP-block 104, e.g., obtainable from the data stream. The inter-intra prediction signal P_{CIIP} of the CIIP-block 104 may correspond to a weighted combination of an intra-prediction signal associated with the CIIP-block 104 and an inter-prediction signal P_{inter,104} associated with the CIIP-block 104. For example, the inter-intra prediction signal P_{CIIP} of the CIIP-block 104 may be generated by the CIIP-tool 110₁ in FIG. 9, see P_{CIIP,18}, or by the first decoding tool 110₁/first encoding tool in FIG. 6, e.g., using the generator 114, see

$${C}_{18}^{1} .$$

The RSP-block 106 can be reconstructed by a sample-wise combination of a prediction signal P₁₀₆, e.g. an inter-prediction signal, an intra-prediction signal or an inter-intra prediction signal, of the RSP-block 106 and a prediction residual signal of the RSP block 106 generated by using residual sign prediction. For example, the video decoder 54 may comprise a residual-sign-prediction tool configured to derive residual values for the RSP-block 106 from the data stream, and predict signs of the residual values based on a spatial neighborhood of the RSP-block 16. The encoder 14 may also comprise a residual-sign-prediction tool configured to determine residual values for the RSP-block 106, e.g., by determining a difference between the prediction signal P₁₀₆ and an original signal of the RSP-block 106, and encode same into the data stream, and predict signs of the residual values based on a spatial neighborhood of the RSP-block 16 and optionally, encode differences between the predicted signs and actual signs into the data stream. Optionally, the residual-sign-prediction tool of the decoder 54 is further configured to derive the differences from the data stream and reconstruct the signs of the residual values by combining/summing the predicted signs with the differences. Optionally, the prediction residual signal R of the RSP-block 106 may be generated by the RSP-tool 110₁ in FIG. 10, see R₁₃, or by the first decoding tool 110₁/first encoding tool in FIG. 6, e.g., using the generator 114, see

$${C}_{18}^{1} .$$

The video decoder 54/encoder 14 is configured to inter-predict the inter-predicted block 102 to obtain an inter-prediction signal P_{inter,102} of the inter-predicted block 102. The video decoder 54/encoder 14 may comprise a post-processing tool and the video decoder 54/encoder 14 may be configured to apply the post-processing tool onto the inter-predicted block 102. The post-processing tool is configured to post-process the inter-prediction signal P_{inter,102} of the inter-predicted block 102 to obtain a post-processed inter-prediction signal

$${P}_{i n ter , 102}^{*} .$$

The inter-predicted block 102 can be reconstructed by a sample-wise combination of the post-processed inter-prediction signal

$${P}_{i n ter , 102}^{*} .$$

of the inter-predicted block 102 and a prediction residual signal R, e.g., obtainable from the data stream. Optionally, the post-processing tool may correspond to the STRN-tool 110₁ in FIG. 7, the LIC-tool 110₁ in FIG. 8, or the first decoding tool 110₁/first encoding tool in FIG. 6, e.g., using the post-processor 112.

The video decoder 54/encoder 14 is configured to intra-predict the intra-predicted block 18, i.e. a current block which belongs to the intra-predicted blocks, using a neighborhood signal in a spatial neighborhood 100 of the intra-predicted block 18.

In the following a generation of the neighborhood signal in the spatial neighborhood 100 of the intra-predicted block 18 is described in more detail.

For post-processed inter-predicted blocks, like the inter-predicted block 102, overlapping with the spatial neighborhood 100, see the first spatially neighboring portion 100₁₀₂, the inter-prediction signal P_{inter,102} within the spatial neighborhood 100 may be used for the generation of the neighborhood signal and not the post-processed inter-prediction signal

$${P}_{i n ter , 102}^{*}$$

of the inter-predicted block 102, i.e., the inter-prediction signal P_{inter,102} of the inter-predicted block 102 may be used in a version not post-processed by the post-processing tool for the generation of the neighborhood signal, i.e. the post-processed inter-prediction signal

$${P}_{i n ter , 102}^{*}$$

is substituted by the inter-prediction signal P_{inter,102} of the inter-predicted block 102 for the generation of the neighborhood signal. Optionally, the video decoder 54/encoder 14 is configured to use a sample-wise combination of the inter-prediction signal P_{inter,102} within the spatial neighborhood 100, i.e. within the first spatially neighboring portion 100₁₀₂, with the prediction residual signal R within the spatial neighborhood 100, for the generation of the neighborhood signal.

For CIIP blocks, see CIIP block 104, overlapping with the spatial neighborhood 100, see the second spatially neighboring portion 100₁₀₄, the inter-prediction signal P_{inter,104} within the spatial neighborhood 100 may be used for the generation of the neighborhood signal and not the inter-intra prediction signal P_{CIIP}. In other words, the video decoder 54/encoder 14 may be configured to generate the neighborhood signal by substituting the inter-intra prediction signal P_{CIIP} within the spatial neighborhood 100 by the inter-prediction signal P_{inter,104}. In other words, the video decoder 54/encoder 14 may be configured to use the inter-prediction signal P_{inter,104} of the inter-intra prediction within the spatial neighborhood 100 and not an intra-prediction signal of the inter-intra prediction, i.e. the intra-prediction signal of the inter-intra prediction associated with the CIIP-block is disregarded or left away at the generation of the neighborhood signal.

For RSP-blocks, like the RSP-block 106, overlapping with the spatial neighborhood 100, see the third spatially neighboring portion 100₁₀₆, the prediction signal P₁₀₆ of the RSP-block within the spatial neighborhood 100 may be used for the generation of the neighborhood signal. The prediction signal P₁₀₆ of the RSP-block 106 may be used uncombined with a prediction residual signal R of the RSP-block 106. The prediction residual signal, which is disregarded or left away for the generation of the neighborhood signal, is generated using the residual-sign-prediction tool.

Additionally, it may be noted that it is also possible that an intra-block is at least partially overlapping with the spatial neighborhood 100 and the intra-prediction tool 110 may be configured to use either a reconstructed intra-signal, i.e. a sample wise combination of an intra-prediction signal and a prediction residual signal, within the overlap region of the intra-block and the neighborhood 100, or to use the intra-prediction signal within the overlap region of the intra-block and the neighborhood 100 and disregard the prediction residual signal of the intra-block.

Above, the neighboring blocks, see 102, 104 and 106, are discussed individually in terms of what signals associated with the respective block are considered for the generation of the neighborhood signal. But it is clear that the whole spatial neighborhood 100 is considered at the generation of the neighborhood signal. Optionally, a deblocking filter can be applied within the spatial neighborhood 100, so that edges between areas that contain different signal types, e.g. an edge between the second spatially neighboring portion 100₁₀₄ and the third spatially neighboring portion 100₁₀₆ and or an edge between the first spatially neighboring portion 100₁₀₂ and the second spatially neighboring portion 100₁₀₄, are smoothened or reduced.

This special generation of the neighborhood enables a parallelization of coding processes and increases therefore a coding efficiency. For example, the usage of prediction signals of post-processed blocks, like STRN-blocks and/or LIC-blocks, in a version not post-processed by the respective post-processing tool 110₁, i.e. using P and not P*, within the neighborhood 100, enables to perform an intra prediction of intra-blocks parallel to a post-processing of the post-processed blocks. For example, the usage of only the inter-prediction signals of CIIP-blocks and the disregarding of the intra-prediction signals of the CIIP-blocks within the neighborhood 100 enables to perform an intra prediction of intra-blocks parallel to a prediction of CIIP-blocks. For example, the usage of only the prediction signals of RSP-blocks and the disregarding of the prediction residual signals of the RSP-blocks within the neighborhood 100 enables to perform an intra prediction of intra-blocks parallel to a residual sign prediction.

FIG. 12 shows exemplarily the generation of a neighborhood signal for the intra-predicted block 18. However, it is clear that a neighborhood signal for a CIIP-block can be generated correspondingly, wherein the neighborhood signal is used to generate the intra-prediction signal associated with the CIIP-block, which is combined, e.g., by a weighted combination, with an inter-prediction signal associated with the CIIP-block to obtain an inter-intra prediction signal of the CIIP-block. In other words, the intra-predicted block 18 could instead be a CIIP block, and instead of an intra-prediction tool 110 an inter-intra prediction tool may be used to generate the inter-intra prediction signal.

FIG. 13 shows an embodiment of a picture-processing tool 110₁, which can correspond to the first predetermined decoding/encoding tool described with regard to FIG. 6 and FIG. 7. Therefore, a decoder 54 or encoder 14, as described with regard to FIG. 6 and FIG. 7, may comprise features and or functionalities as described with regard to the picture-processing tool 110, in the following.

The picture-processing tool 110₁ comprises a neural network or a convolution, which are indicated by the reference numeral 130, and is configured to polyphase-wisely split 140 luma samples of a picture portion 11 into polyphase-components to obtain a matrix, see 142₁ to 142₄, per polyphase-component, and form 144 a tensor 146 by cascading the matrices 142₁ to 142₄ of the polyphase-components. The picture-processing tool 110₁ is configured to subject the tensor 146 to the neural network or convolution, see 130, with associating the matrices 142₁ to 142₄ as different channels so as to obtain an output tensor 148 composed of a concatenation of output matrices comprising one output matrix per polyphase-component, and form, by inverse polyphase decomposition 150, a processed picture portion 11′ based on the output tensor 148, i.e. rearrange the samples accordingly back.

FIG. 13 shows exemplarily a polyphase-wise splitting of the picture portion 11 into four polyphase components. However, it is clear that the picture-processing tool 110₁ may alternatively be configured to polyphase-wise split the picture portion 11 into a different number of polyphase components. The luma samples of the picture portion 11 have a two dimensional arrangement along a first direction x and a second direction y, wherein the second direction y is perpendicular to the first direction x. At the polyphase-wisely splitting, the luma samples, for example, are alternatingly split in the first x and second y direction to different ones of the polyphase components. For example, the luma samples are split into even and odd samples, e.g., even and odd in terms of a position index of the luma samples within the picture portion 11, along the first direction x and the second direction y to obtain the polyphase-components. The input signal is, for example, polyphase-wise split in a horizontal and a vertical direction before processing it with the neural network or the convolution, see 130.

The picture portion, for example, comprises a block 18 of a picture accompanied by its spatial neighborhood 100. The picture-processing tool 110₁ is configured to, at the polyphase-wisely splitting, split the luma samples of the block 18 and of the spatial neighborhood 100 into the polyphase-components to obtain the matrix, see 142₁ to 142₄, per polyphase-component. The processed picture portion 11′, for example, has the same dimensions as the picture portion 11. The picture-processing tool 110₁, for example, is configured to combine, sum or add the picture portion with the processed picture portion to obtain an intermediate signal, and crop the intermediate signal to obtain a post-processed picture portion, or the other way around, i.e. performing first the cropping and then the combining. At the cropping, for example, a part associated with the spatial neighborhood 100 is cut away.

The neural network or convolution, see 130, may comprise features and or functionalities as will be described with regard to FIG. 15. The input tensor 146 is larger in the embodiment of FIG. 15, since a picture portion 11 of a current picture, a corresponding picture portion 11₁ in a first reference picture and a corresponding picture portion 11₂ in a second reference picture are polyphase-wisely split 144. Nevertheless, the concepts described with regard to FIG. 15 are also applicable for the picture-processing tool 110₁ in FIG. 13.

The picture-processing tool 110₁ may be a post-processing tool for inter-predicted blocks, see also the example described with regard to FIG. 7, FIG. 14 or FIG. 15. In this case the picture portion 11 may be an inter-prediction of a picture block received from an inter-prediction tool of a video decoder/encoder. For example, the STRN tool of the video decoder 54/encoder 14 described with regard to FIG. 7 can correspond to the picture-processing tool 110₁ receiving from an inter-prediction tool 110₂ the inter-prediction signal P_{inter,18} of the current block 18.

The inter-prediction of a picture block may be obtained by uni-prediction, bi-prediction, etc., wherein at least one predictor within a reference picture is used for the inter-prediction. A predictor, for example, represents a corresponding block, i.e. a block being similar to the picture block within the reference picture. The picture-processing tool 110₁ may receive the inter-prediction of a picture block together with the one or more predictors and polyphase-wisely split 140 the inter-prediction as well as the one or more predictors to obtain the tensor 146. The tensor 146, for example, may be formed out of twelve matrices of the polyphase-components, if the inter-prediction represents a regular bi-prediction, i.e. having two predictors. For uni prediction, the picture-processing tool 110₁ may be configured to fill the input with two times the uni prediction signal, i.e. the tensor 146 is also formed out of twelve matrices of the polyphase-components, since the input is the inter-prediction of the picture block and two times the predictor, i.e. an uni-predictor. The same polyphase-wisely splitting as applied to the picture portion 11 is also applied to the one or more predictors.

Optionally, the picture portion 11 may be a prediction, e.g., an intra-prediction, an inter-intra prediction or the inter-prediction, like bi-prediction, of the picture block accompanied by neighboring reconstructed (i.e., top/left) samples, e.g., with a border extension width B, i.e. accompanied by the spatial neighborhood 100. For bi-prediction, also include the two constituent prediction signals, i.e. the two predictors, correspondingly enlarged in the input of the neural network or convolution, see 130. Generally speaking, if the picture portion 11 is an intra-prediction, the one or more predictors are accompanied by their respective spatial neighborhood. Optionally, the picture portion 11 may be a prediction of the picture block accompanied by a constrained spatial neighborhood 100, i.e. the neighborhood signal 100′, as described with regard to FIG. 6 and FIG. 7. No constraints may apply to the spatial neighborhood of the one or more predictors involved at inter-prediction.

The picture portion, for example, comprises inter-predicted luma samples of the block 18 of a picture accompanied by a spatial neighborhood 100 of the block 18. The picture-processing tool 110₁, for example, is configured to, at the polyphase-wisely splitting, split the inter-predicted luma samples of the block 18 and the luma samples of the spatial neighborhood 100 into the polyphase-components to obtain the matrix, see 142₁ to 142₄, per polyphase-component, and split luma samples of a corresponding reference picture portion comprising a corresponding block and a spatial neighborhood of the corresponding block in a references picture into the polyphase-components to obtain a reference matrix per polyphase-component. The processed picture portion 11′, for example, has the same dimensions as the picture portion 11. The picture-processing tool 110₁, for example, is configured to combine, sum or add the picture portion with the processed picture portion to obtain an intermediate signal, and crop the intermediate signal to obtain a post-processed picture portion, or the other way around, i.e. performing first the cropping and then the combining. At the cropping, for example, a part associated with the spatial neighborhood 100 is cut away.

The picture-processing tool 110₁ may be configured to allow the picture portion 11 to correspond to one of a plurality of picture portion dimensions, e.g., by confining a convolution of the tensor 146 using a kernel 132 of the neural network or convolution, see 130 to a dimension of the picture portion 11 and use the same kernel 132 for each of the plurality of picture dimensions. The neural network or convolution, for example, is applicable for picture portions 11 of different sizes and shapes and for picture portions 11 associated with different quantization parameters.

The neural network or convolution, see 130, for example, comprises exclusively convolutional layers. The neural network or convolution, see 130, for example, comprises N layers. The neural network or convolution, for example, is configured to preform per layer convolutions 134 followed by a rectified linear unit activation 136, except for a last layer of the N layers, at which the rectified linear unit activation 136 is skipped.

FIG. 14 shows an embodiment of a decoder 54/encoder 14 configured to decode/encode a video from/into a data stream 12 using block-based prediction and transform-based prediction residual coding. The decoder 54/encoder 14 is configured to perform the block-based prediction by use of motion-compensated prediction, i.e. inter-prediction, controlled via motion vectors 200, like for block 18. A motion vector 200, for example, indicates for a block of a current picture 10 a corresponding block 210 in a reference picture 11₁. FIG. 14 shows exemplarily three reference pictures 11₁, 11₂ and 11₃ for the block 18 in the current picture 10, wherein a respective corresponding block within the respective reference picture 11₁, 11₂ and 11₃ is indicated by a corresponding motion vector. The motion vector 210 indicates an offset of the corresponding block 210 to a co-located block 220 of the block 18 within the reference picture 11₁. The video encoder 14 is configured to encode one or more motion vectors 200 for inter-predicted blocks, like the block 18, and the video decoder 54 is configured to derive from the data stream one or more motion vectors 200 for the inter-predicted blocks, like the block 18.

The decoder 54/encoder 14 is configured to apply a post-processing tool 110₁ for post-processing an inter-prediction signal of predetermined inter-predicted blocks and identify the predetermined inter-predicted blocks out of the inter-predicted blocks by excluding from the predetermined inter-predicted blocks the following blocks:
First inter-predicted blocks which have, e.g., according to the data stream 12, one or more motion vectors 200 associated therewith among which a number which fulfills a first predetermined criterion is zero. For example, the first predetermined criterion might be that the number has to be at least one, i.e. if one or more of the motion vectors 200 associated with an inter-predicted block are zero-motion-vectors the inter-predicted block represents one of the first inter-predicted blocks. Alternatively, the first predetermined criterion might be that the number is at least two, at least three, etc. A motion vector 200 being zero, i.e. a zero-motion vector, indicates that a co-located block 200 within a reference picture, e.g., within 11₁, 11₂ or 11₃, is used as a predictor for the respective first inter-predicted block 18.
Second inter-predicted blocks which have, e.g., according to the data stream 12, one or more motion vectors 200 associated therewith among which a number which fulfills a second predetermined criterion are full-pel motion vectors. For example, the second predetermined criterion might be that the number has to be at least one, i.e. if one or more of the motion vectors 200 associated with an inter-predicted block are full-pel motion vectors, the inter-predicted block represents one of the second inter-predicted blocks. Alternatively, the second predetermined criterion might be that the number is at least two, at least three, etc.
Third inter-predicted blocks which have, e.g., according to the data stream 12, one out of a set of predetermined inter-prediction modes associated therewith, wherein the set of predetermined inter-prediction modes includes one or more of uni-prediction modes, a merge mode, and a bi-prediction mode using coding unit weights.
Fourth inter-predicted blocks whose block shape fulfills a third predetermined criterion.
Fifth inter-predicted blocks for which the data stream signals a quantization parameter having a value which fulfills a fourth predetermined criterion.

This embodiment avoids gradual signal degradation, based on the finding of the inventors that a repeated application of a post-processing tool 110₁, e.g. a tool using a NN, can lead to a gradual signal degradation and that this is particularly relevant for low-delay prediction structures.

The gradual signal degradation can be mitigated by constraining the set of coding modes for which the post-processing tool 110₁ is applicable. For example, applying the post-processing tool 110₁ could be disabled for any of the following cases:
Motion vectors that are equal to zero (either one or both, including/excluding affine blocks).
Motion vectors that have full-pel accuracy (or resulting in a full-pel position).
Blocks without a signaled residual (i.e., the coded block ag [cbf] is equal to zero).
Specific prediction modes (e.g., Uni prediction, certain merge modes, or Bi-prediction with CU Weights [BCW]).
Certain slices (e.g., implicitly based on the temporal layer or explicitly via an additional syntax element).
Certain block shapes.
Certain Quantization Parameter (QP) values.

According to an embodiment, the post-processing tool 110₁ can comprise features and/or functionalities as described with regard to the picture-processing tool 110₁ in FIG. 13 and/or as described with regard to the first predetermined decoding/encoding tool 110₁ in FIGS. 6, 7 and 8. The post-processing tool 110₁, for example, may be configured to post-process an inter-prediction signal of a block comprised by the predetermined inter-predicted blocks, as described with regard to the block referenced by the reference numeral 18 in FIGS. 6, 7, 8, 13 and 15.

In the following a description of a neural network 130 for enhanced inter prediction is provided. This section introduces the network architecture and the specifics of the training process. The neural network 130 described in the following is referred to as STRN network.

FIG. 15 shows an overview of the proposed STRN network architecture, which is based on the architecture in [14]. Our approach aims at improving the prediction signal of inter blocks, e.g., of P_{inter,18} of the current block 18, in VVC, so that the input and output of the neural network 130 (as depicted in the top-left and top-right of FIG. 15, respectively) represent the interface between the video codec and the STRN domain.

Given an inter block, e.g., the current block 18, of size W×H, bi-prediction in VVC uses the motion-compensated reference blocks 18₁ and 18₂ of size W×H of the two reference pictures, i.e. L0 and L1 prediction signals, i.e. predictors, to compute the prediction signal P_{inter,18} of the current block 18. Accordingly, the STRN input is composed of the sample arrays of the current picture, i.e. the picture portion 11, and the L0 and L1 prediction signals, i.e. the picture portions 11₁ and 11₂. For STRN, however, the block size is extended by an L-shaped B samples wide area along the top/left border, i.e. the spatial neighborhood, see 100, 100₁ and 100₂, resulting in input arrays of size W_{B}×H_{B}=(W+B)×(H+B). Regarding the L0 and L1 prediction signals, the extended motion-compensated reference blocks, i.e. the picture portions 11₁ and 11₂, are derived using the same motion vectors as for regular bi-prediction, so that input arrays C₁ and C₃ contain additional (interpolated) prediction samples along the top/left border, i.e. spatio-temporal reference samples, i.e., the samples within the respective spatial neighborhood 100₁ and 100₂. For the current picture, the input array C₂ contains the regular bi-prediction P, i.e. P_{inter,18}, of the current block 18 in the corresponding W×H area and additional reconstructed samples in the L-shaped B wide area along the top/left border, i.e. spatial reference samples, i.e., samples within the spatial neighborhood 100. Unlike in [14], these reconstructed samples may be subject to certain constraints that allow STRN blocks and intra blocks to be decoded independently and in parallel, e.g., referring to FIG. 7, the intra predicted block 106 and the STRN block 102 can be decoded/encoded in parallel.

Together, the three input arrays form a tensor C=[C₁ C₂ C₃], which is used to derive the actual input tensor 146 of the neural network 130 via polyphase decomposition 144 [38]. Given C with size 3×W_{B}×H_{B} and elements (c; x; y), the polyphase components are obtained by splitting it into even and odd samples along the x and y directions as

$${C}_{00}^{*} ( c , x , y ) = C ( c , 2 x , 2 y ) {C}_{10}^{*} ( c , x , y ) = C ( c , 2 x + 1 , 2 y ) {C}_{01}^{*} ( c , x , y ) = C ( c , 2 x , 2 y + 1 ) {C}_{11}^{*} ( c , x , y ) = C ( c , 2 x + 1 , 2 y + 1 ) , \qquad ( 1 )$$

which needs W_{B} and H_{B} being a multiple of 2. The input tensor 146 of size

$$12 \times \frac{1}{2} {W}_{B} \times \frac{1}{2} {H}_{B}$$

is then formed by joining the four polyphase components as

$${C}^{*} = [ {C}_{00}^{*} {C}_{10}^{*} {C}_{01}^{*} {C}_{11}^{*} ] .$$

Please note that this decomposition only rearranges the tensor elements, but does not change the number of elements or their values. In the context of deep learning, but with respect to the addressing of different issues, such as the addressing of differently sampled color components, such a polyphase operation is sometimes also used but called pixel (un)shuffling [39]. Regarding the neural network structure, the proposed STRN basically consists of N convolution layers. As illustrated in FIG. 15, all layers may perform convolutions 134 with a kernel size of 3×3, followed by a rectified linear unit (ReLU) activation function 136, except for the last layer. The operation of these convolution layers can be defined as

$${L}_{i + 1} = max \{ {W}_{i + 1} {L}_{i} + {b}_{i + 1} , 0 \} , i ∈ [ 0 … N - 1 ] \\ {L}_{N} = {W}_{N} {L}_{N - 1} + {b}_{N} , \qquad ( 2 )$$

with weight matrices Wₖ and bias vectors bₖ, k∈[1 . . . N]. The input to the first layer L₀ may correspond to 12×3×3 subtensors of C*, i.e. of the tensor 146, at positions (x; y). For each layer, the operations of equation (2) are applied to all positions (x; y), using zero padding to preserve the block shape, such that the output of the last layer L_{N} has a size of

$$4 \times \frac{1}{2} {W}_{B} \times \frac{1}{2} {H}_{B} .$$

Each convolution layer may have cᵢₙ×3×3×cₒᵤₜ weights (size of Wₖ) and cₒᵤₜ biases (size of bₖ), with cᵢₙ and cₒᵤₜ being the number of input and output channels of the respective layer. The first layer has 12 input channels and the last layer has 4 output channel, while all intermediate layers have F feature channels. This results in a total of n_{w}=608256 weights and n_{b}=644 biases for STRN with N=6 layers and F=128 feature channels.

As illustrated in FIG. 15, the neural network 130 may have a skip connection 138, where the input array C₂ is added to the output. However, L_{N} is a polyphase representation of the output, where the four output channels correspond to the four polyphase components like in equation (1). Therefore, the elements of L_{N} are rearranged to a W_{B}×H_{B} output array C_{Δ} before the skip connection 138. This means that the four polyphase components are merged into one array by inverse polyphase decomposition 150. The final output, e.g., the processed picture portion 11′, i.e., the post-processed inter-prediction signal

$${P}_{i n ter , 18}^{*}$$

for the current block 18, is then obtained by adding the input array C₂ to the output CA and cropping the L-shaped B samples wide area along the top/left border as

$${P}^{*} = {crop}_{B} ( {C}_{2} + {C}_{Δ} ) , \qquad ( 3 )$$

with P* i.e.

$${P}_{inter , 18}^{*} ,$$

being the refined prediction of the current W×H block 18. The skip connection 138 makes STRN, i.e. the neural network 130, a residual network and has the effect that the convolution layers learn to result in residual or offset values C_{Δ} for improving the regular prediction P, i.e. P_{inter,18}, of the current block 18 (included in input array C₂) with the help of spatial and temporal reference samples, i.e. the samples within the spatial neighborhood 100, also referred to as neighborhood signal.

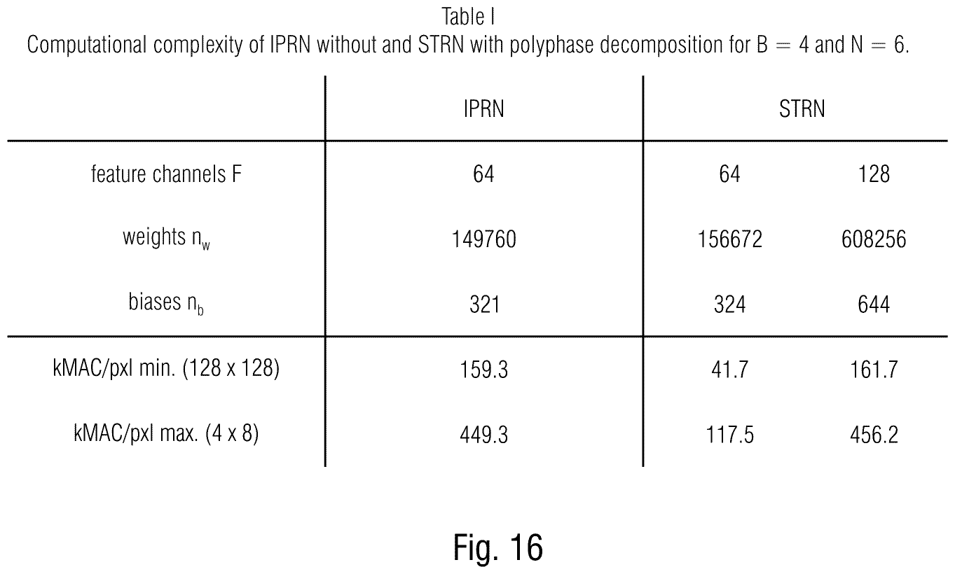

The reason for including the polyphase decomposition 144 in the STRN architecture is that it allows for a considerable complexity reduction. Table I in FIG. 16 shows a comparison between the IPRN architecture [14] without and the STRN architecture with polyphase decomposition 144. The computational complexity of deep learning approaches for video coding is often evaluated in terms of multiply-accumulate (MAC) operations per output luma sample, which is commonly referred to as MAC per pixel (MAC/pxl). For both IPRN and STRN, this value depends on the number of weights and the block shape as

$$\frac{MAC}{pxl} = {n}_{w} \cdot \frac{{W}_{in} \cdot {H}_{in}}{W \cdot H} , \qquad ( 4 )$$

with input tensor shape Wᵢₙ·Hᵢₙ equal to W_{B}·H_{B} for IPRN and

$$\frac{1}{4} \cdot {W}_{B} \cdot {H}_{B}$$

for STRN, respectively. Thus, polyphase decomposition 144 reduces the complexity by reducing the tensor shape of the input and all subsequent layers. The resulting minimum and maximum values in Table I highlight that STRN has about a quarter of the complexity of IPRN for the same number of feature channels or, alternatively, about the same complexity for twice the number of feature channels.

In the following a possible training of the neural network 130 is explained.

The training dataset for STRN consists of a collection of so-called training samples. Like in [14], these samples are derived from decoded VVC bitstreams by generating the three input arrays Cᵢ for inter blocks and storing them together with the corresponding original signal array O of the block, e.g., of the current block 18. The values of these arrays are of integer type in the range [0 . . . 2^{b}−1], with bit depth b, and are converted to floating-point values in the range [−0.5, 0.5[ in the training process. IPRN in [14] and STRN have in common that the architecture is fully independent of the block shape W×H, which means that the same model can be trained and applied for all VVC inter block shapes. Consequently, the dataset contains training samples for various block shapes. During training, each forward and backward propagation cycle processes a batch of training samples at once. While all training samples within a batch need to have the same shape, each batch can have a different shape, so that one single model can be trained with all the block shapes contained in the dataset.

The core of the training process is a gradient descent algorithm with a loss function and a backward propagation of the loss, based on a learning rate and an optimizer. Regarding the loss function, the differences between the commonly used SSD, SAD, and SATD have been studied in [14], with the conclusion that SATD performs better than the other loss functions that are computed in the spatial domain. Therefore, the SATD loss function is also used for STRN, i.e. for the neural network 130: Given output P* and the corresponding original signal O of a W×H block, the loss l equates to the l₁-norm of the two-dimensional DCT-II of the residual as

$$l = {‖ DC T ( {P}^{*} - O ) ‖}_{{ℓ}_{1}} . \qquad ( 5 )$$

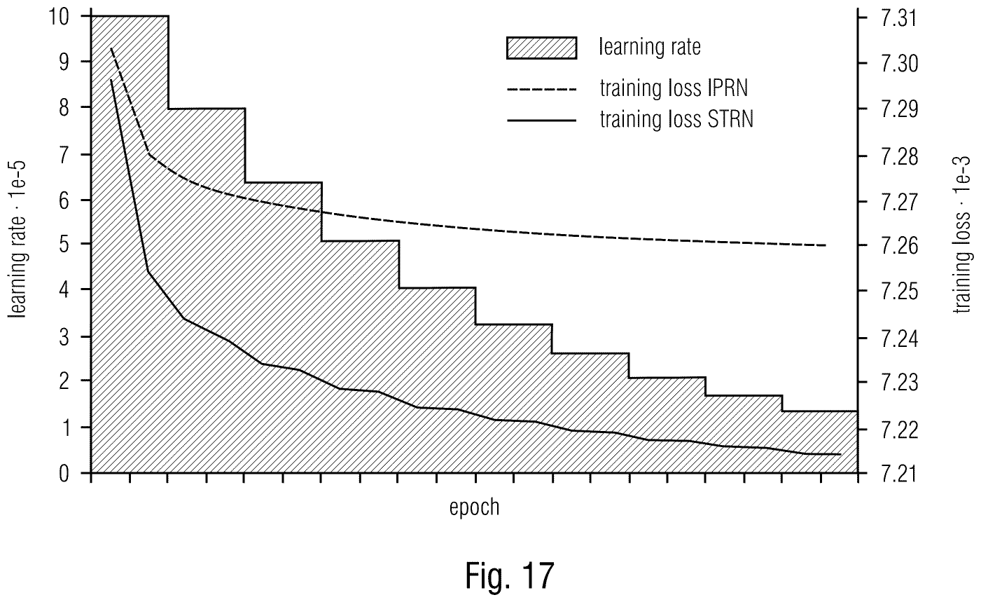

For backward propagation of the loss, the widely-used Adam optimizer [40] is employed together with a learning rate that is decayed exponentially by a factor of 0.8 every two epochs. FIG. 17 shows an example for the relation between learning rate (using an initial value of 10⁻⁴) and the resulting loss for training IPRN and STRN models. Both models have about the same complexity, but due to the polyphase decomposition 144, STRN has twice the number of feature channels and, consequently, a lower loss.

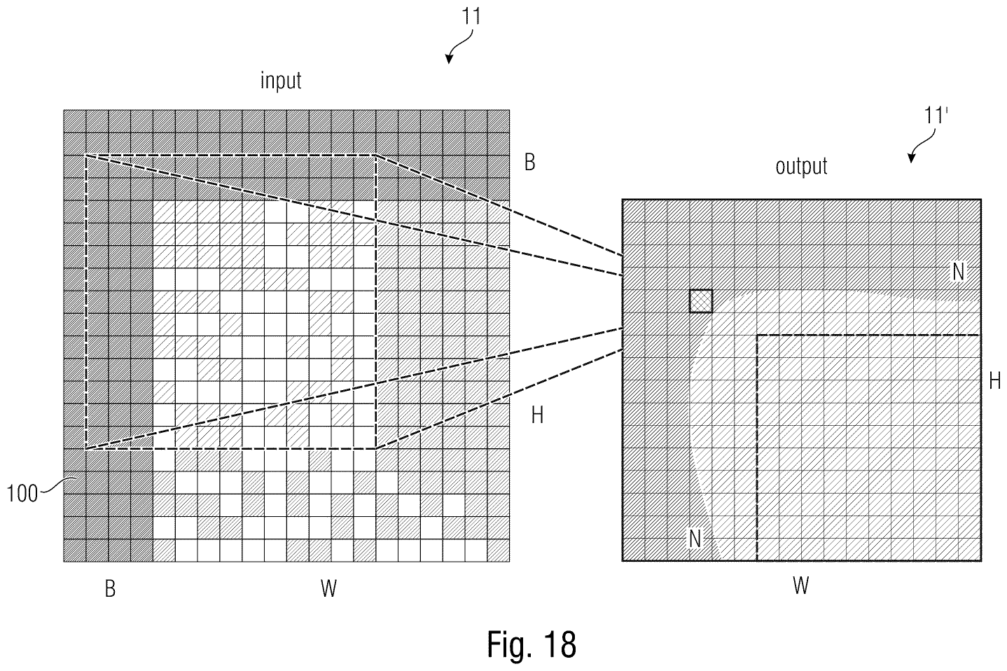

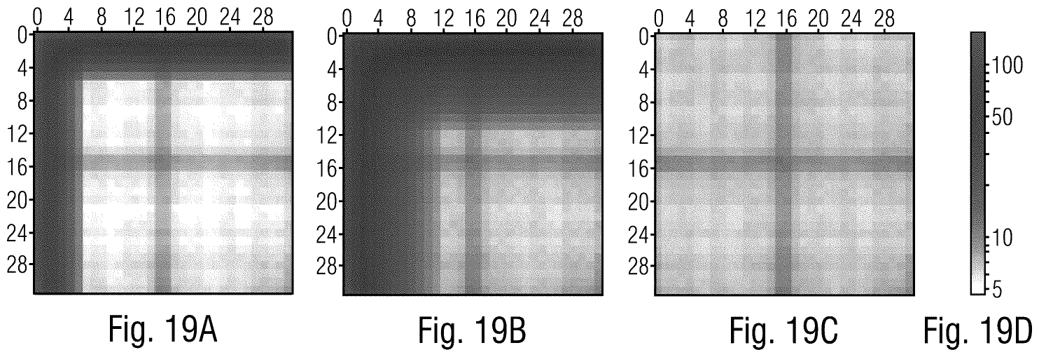

One effect of the architecture being independent of the block shape is that the influence of the spatial reference samples in input C, i.e. the picture portion 11, on output P*, i.e. processed picture portion 11′, is limited: Given a simple CNN like IPRN with N layers and a kernel size of 3×3, the value of an output element only depends on the values of input elements in an (2N+1)×(2N+1) area centered around the position of the output element, as illustrated in FIG. 18. Consequently, the spatial reference samples in the L-shaped B wide area, i.e. the spatial neighborhood 100, along the top/left border of the input only affect the output values in the L-shaped N wide top/left area of the block. For STRN the area of P*, i.e. the processed picture portion 11′, affected by the spatial reference samples in C is actually 2N wide due to the polyphase decomposition 144. FIGS. 19A-D show the results of an experimental evaluation of the described effect, comparing IPRN and STRN with and without spatial reference samples. For each of the three trained models, the position-wise MSE reduction has been evaluated during inference as r(x,y)=[P(x,y)−O(x,y)]²−[P*(x,y)−O(x,y)]² for each position (x, y) of the output P*. The value of r corresponds to the amount of improvement at the respective position and the diagrams in FIGS. 19A-D show the average value over the inference dataset. Comparing the results in FIGS. 19 (A) and (B) with FIG. 19 (C) reveals that the improvement of the prediction signal is considerably higher when spatial reference samples are included in the input. Moreover, the results in FIGS. 19 (A) and (B) confirm that the influence of spatial reference samples is limited to the L-shaped top/left area of the block and that this area is twice as wide for STRN as for IPRN. Note that the cross-shaped structure in FIG. 19 (A)-(C) is caused by the DMVR coding tool of VVC.

The following section describes how STRN is integrated into VVC inter coding, including the interaction with other inter coding tools in the prediction process, the integration in the decoding process with special attention to the intra loop, the compilation of the input arrays for application and training sample collection, and an efficient integration in the encoding process.

Both IPRN in [14] and STRN may be designed as a residual network for improving the prediction signal of inter blocks, e.g., P_{inter,18} of the current block 18, and therefore integrated as a post-processing module, e.g., as the post-processor 112 of the first predetermined decoding tool 110₁ in FIG. 6 or as the STRN tool 110₁ in FIG. 7 or as the picture-processing tool 110₁ in FIG. 13 or as the post-processing tool 110₁ in FIG. 14, to the VVC inter prediction process. Given an inter block and a trained model with fixed weights Wₖ and biases bₖ, the input tensor C is compiled based on the regular VVC inter prediction P and forward propagated through the network, resulting in the refined prediction P*, e.g., see the description above. Like for the training described above, the values of C are converted from integer values in the range [0 . . . 2^{b}−1] to floating-point values in the range [−0.5, 0.5[ before input. Accordingly, the values of P* are converted back to integers in the range [0 . . . 2^{b}−1] after output, which are then used as the final prediction signal of the block in VVC.

In the proposed solution, STRN, i.e. the neural network 130, is only applied to the luma component of a block, e.g., of a current block 18 or picture portion 11, and to all uni- and bi-predicted inter blocks, e.g., the corresponding blocks 18₁ and 18₂ or the picture portions 11₁ and 11₂ in the one or more reference pictures, that
are not coded with CIIP, BCW, GPM, or SbTMVP, and
do not have a motion vector equal to zero, unless they are coded with AMC (this will be referred to as zero-MV constraint in the following).

For all these cases STRN, i.e. the usage of the neural network 130, is mandatory, i.e. it cannot be switched off for individual blocks. Accordingly, no tool flag or other mode data is signaled in the bitstream, i.e. in the data stream 12. Moreover, a single model is used for all applicable inter blocks, including all block shapes and all QP values. The zero-MV constraint is motivated by the observation that repeated application of the CNN, i.e. the neural network 130, can lead to a gradual signal degradation. This is particularly relevant for low-delay prediction structures and will be discussed in more detail below.

The general process of generating and compiling the input tensor C, i.e., the tensor 146, is the same for both the collection of training data and the application of STRN, i.e. the neural network 130, as a coding tool. For the latter, however, the design of the VVC decoding process for inter pictures (or slices) needs to be considered: Achieving realtime decoding for applications with high frame rates and/or high resolutions is very challenging. For intra blocks, on the one hand, the prediction signal is a function of the top/left spatial reference samples, which means that intra blocks can only be decoded after all the respective neighboring blocks in the current picture are decoded. For inter blocks, on the other hand, the prediction signal is a function of the L0 and L1 temporal reference samples, which means that inter blocks can be decoded independently of other blocks in the current picture. This design enables parallel decoding of inter blocks and, thus, a significant reduction in implementation complexity for decoding inter slices. For applications with higher frame rates and/or higher resolutions, all inter blocks can be processed in parallel first and then the remaining intra blocks successively. In this context, CIIP blocks are considered as part of the intra decoding loop, since the final prediction is a weighted combination of planar intra prediction (spatial reference samples) and inter prediction (temporal reference samples).

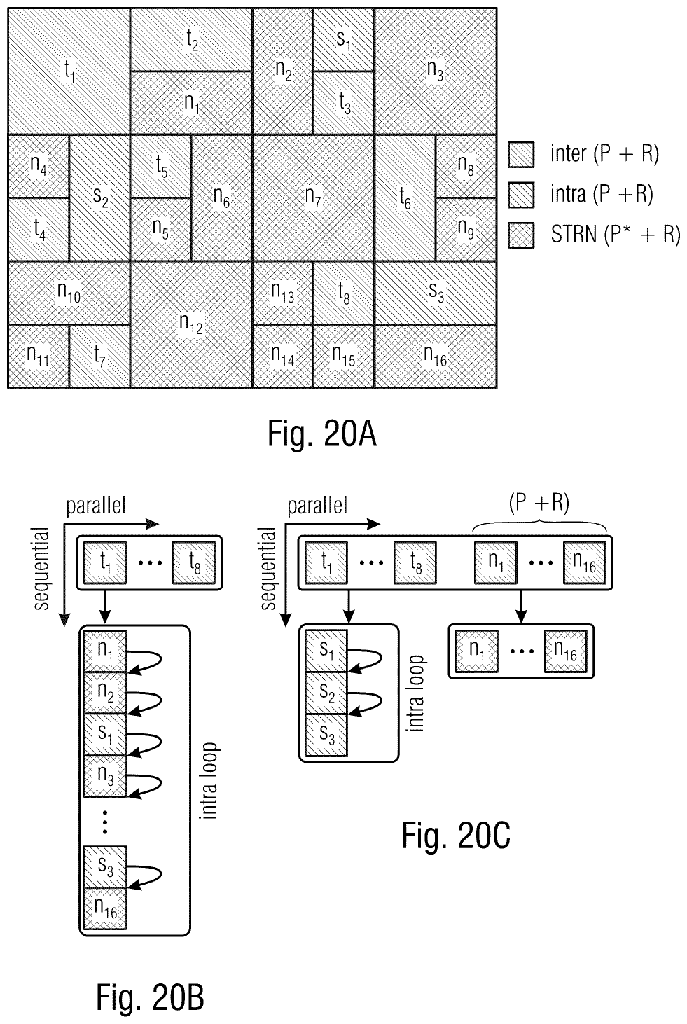

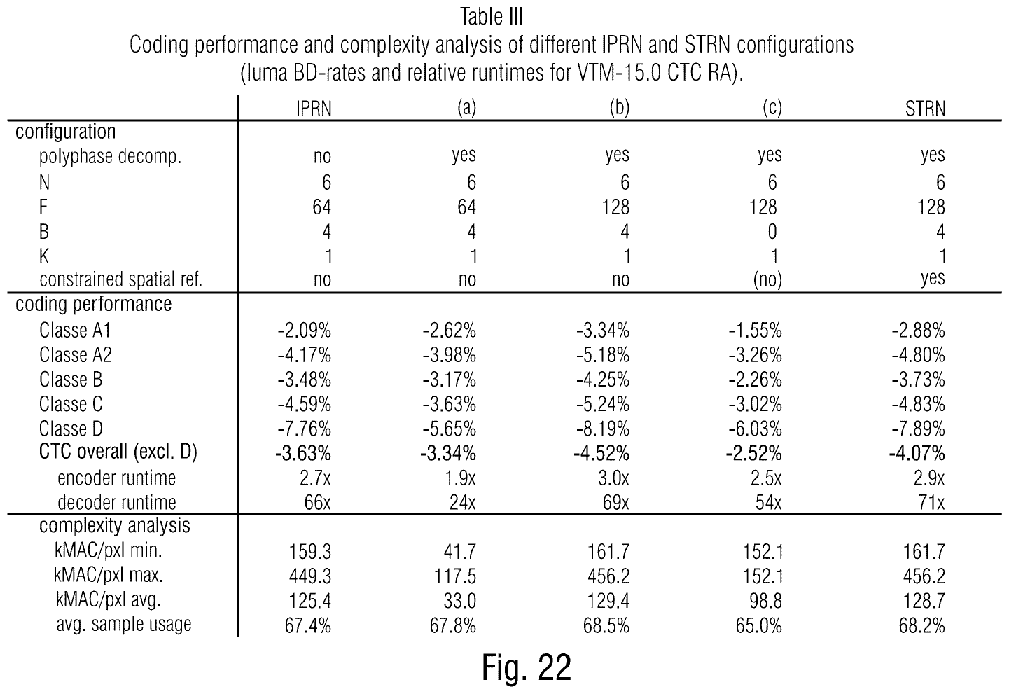

FIGS. 20A-C illustrate the decoding process of an inter slice with inter, intra, and STRN blocks. For STRN, the prediction signal P* is a function of both spatial and temporal reference samples. Consequently, without appropriate modifications, STRN would be part of the intra decoding loop, as shown in FIG. 20 (B): Both STRN and intra blocks depend on reconstructed samples of neighboring STRN and intra blocks, e.g., as shown in FIG. 7, the processing of the current block 18 with the STRN tool 110₁ depends on signals associated with the intra-predicted block 106 and the STRN block 102. This would be a problem for decoder implementations that rely on parallel processing of inter blocks, since STRN post-processing is mandatory for most of the inter coding modes and the computational complexity of forward propagating input C through the neural network 130 is quite high. A straightforward solution would be to remove the spatial reference samples in C by setting B=0, but the corresponding results in FIGS. 19A-D and Table Ill in FIG. 22 show that the potential for improving the prediction signal is limited, if it cannot be adapted to the reconstructed signal of adjacent blocks.

Our solution for B>0 is illustrated in FIG. 20 (C). The STRN post-processing, e.g., performed by the post-processor 112 in FIG. 6, the STRN tool 110₁ in FIG. 7, the picture-processing tool 110₁ in FIG. 13 or the post-processing tool 110₁ in FIG. 14, is decoupled from the intra decoding loop by imposing the following constraints:
For spatial reference samples of STRN blocks that correspond to intra blocks, the extended inter prediction signal of the current block is used instead of the reconstructed signal, i.e. the extended inter-prediction signal

$${P}_{inter , 18}^{e xtended}$$

is used instead of the reconstructed signal Pᵢₙₜᵣₐ+R within the spatial neighborhood, e.g., see 100₁₀₆ in FIG. 6 and FIG. 7.
For spatial reference samples of both STRN and intra blocks that correspond to STRN blocks, an intermediate reconstructed signal without STRN post-processing (P+R) or only a prediction signal P without STRN post-processing is used instead of the real reconstructed signal (P*+R) or P*, with R being the residual transmitted in the bitstream, e.g., referring to FIG. 7, the inter-prediction signal P_{inter,102} or an intermediate reconstructed signal (P_{inter,102}+R) is used by the STRN tool 110₁ and not a post-processed version, i.e. not the post-processed inter-prediction signal

$${P}_{inter , 102}^{*}$$

or the reconstructed signal

$$( {P}_{inter , 102}^{*} + R )$$

of the STRN block 102.

The corresponding results in Table Ill of FIG. 22 show that the coding performance for using constrained spatial reference samples, i.e. the neighborhood signal, e.g., 100′ in FIG. 6, is significantly better than for the straightforward solution with B=0. Now, the inter decoding process can be implemented as follows, see FIG. 20 (C): (1) reconstruct all inter blocks without STRN post-processing in parallel, (2) reconstruct the remaining intra blocks successively, and (3) apply the STRN post-processing for applicable inter blocks in parallel. Steps (1) and (2) are the same as the regular VVC decoding process without STRN, and steps (2) and (3) are independent of each other and may be executed in reverse order or even simultaneously. Moreover, the parallel processing of step (3) allows to make efficient use of a GPU, which would not be the case if STRN was part of the intra decoding loop.

Given a W×H inter block with prediction P, e.g., P_{inter,18}, for which STRN post-processing is applicable, e.g., see the current block 18 in FIG. 6, FIG. 7, FIG. 13 and FIG. 14, the process of generating input arrays Cᵢ depends on the coding mode. Resulting input arrays Cᵢ need to be identical to the respective regular inter prediction signals in the corresponding W×H area. While the prediction process of BDOF, DMVR, and AMC operates on subblocks, STRN is applied to the whole W×H block, which means that input arrays Cᵢ are derived for the whole W_{B}×H_{B} area, including the reference and prediction signals of all subblocks.

For input arrays C₁ and C₃, the L0 and L1 motion vectors available from regular inter prediction are used to obtain the extended W_{B}×H_{B} area from the respective reference picture, including additional spatio-temporal reference samples in the L-shaped B wide area along the top/left border. Except for AMC and DMVR, this step is straightforward, since for each reference picture only one motion vector is used for the whole block. For uni-predicted blocks, which only use reference data of one temporal reference picture, C₁ and C₃ are identical, both containing either L0 or L1 reference data, depending on the selected reference list. AMC and DMVR use individually refined motion vectors for each subblock and, thus, deriving the additional spatio-temporal reference samples needs extending the process accordingly. For AMC, the input arrays C₁ and C₃ are generated without the PROF refinement by applying the motion vectors of 4×4 subblocks along the top/left border to extended subblocks that include the adjacent B wide areas, using the same interpolation filters as for the regular AMC subblocks. For DMVR, the W×H area is divided into subblocks of up to 16×16 samples and the L-shaped B wide area along the top/left border of C₁ and C₃ is derived by introducing additional subblocks that inherit the refined motion vectors and the horizontal and/or vertical dimensions of subblocks along the top/left border, using the same sample padding process as for regular DMVR subblocks.

For input array C₂, the regular prediction P, e.g., P_{inter,18}, is copied to the corresponding W×H area and the remaining L-shaped top/left area, i.e., the spatial neighborhood 100, is filled with spatial reference samples. Depending on the application, namely whether STRN post-processing needs to be decoupled from the intra decoding loop or not, either constrained or regular reconstructed samples are used. For this purpose, a reference sample buffer is continuously filled during the encoding and decoding process, collecting the needed data of already processed blocks. In some cases, spatial reference samples are (partially) unavailable: For blocks located along the top or left border of the picture and for intra reference blocks, in case constrained spatial reference samples are used. These areas of C₂ are then filled with simple bi-prediction without BDOF refinement, i.e. the average of the corresponding sample values in C₁ and C₃.

The VVC encoding process tries to minimize the rate-distortion (RD) cost by testing different combinations of block partitioning and coding modes against the original, uncompressed picture. For a given W×H block in an inter picture, a number of coding mode candidates are tested, including both inter and intra prediction modes. Eventually the coding mode with the lowest RD cost is selected and later used for deciding the block partitioning.

Since STRN is integrated as a post-processing module and the computational complexity of forward propagating the input tensor C, e.g., the tensor 146, through the neural network 130 is quite high, it is, for example, not used for all coding mode candidates, but only for the most promising ones. For this purpose, the best coding mode is first determined using RD costs without STRN refinement. During this step, a list of length K is filled with coding modes for which STRN is applicable, e.g. see the description above. In case STRN is applicable for less than K coding modes, the list is not entirely filled and in case it is applicable for more than K coding modes, the list contains the ones with the lowest RD costs without STRN refinement. In a second step, the RD costs of the up to K coding modes of the list are updated with STRN refinement and the final coding mode of the block is selected between the best coding mode in the list and the best coding mode for which STRN is not applicable.

In the following experimental results and evaluation of STRN are described.

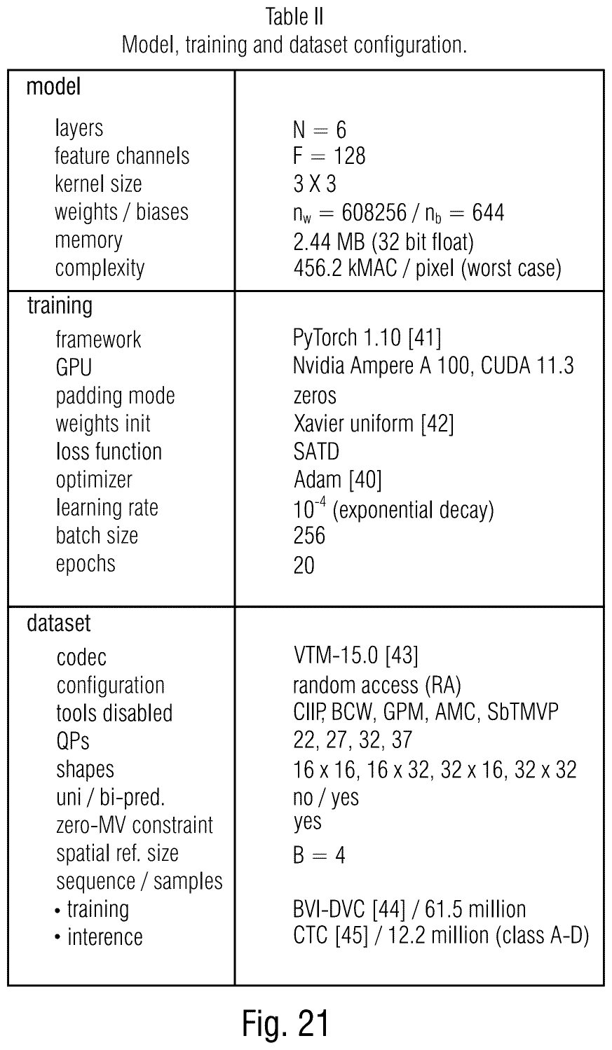

For evaluating the impact of STRN on the VVC coding efficiency, we have used the VVC test model 15 reference software (VTM-15.0) [43] under JVET common test conditions (CTC) [45]. Unless stated otherwise, the STRN model, i.e. the neural network 130, has been trained with the configuration and the dataset specified in Table II in FIG. 21, resulting in a model file that contains the layer structure together with weight and bias values. For application in VTM, STRN post-processing has been integrated into the software, using the LibTorch 1.10 API, which provides the functionality to load the model file and forward propagate input tensor C through the network. All VTM coding experiments have been performed without GPU support, which means that the runtimes presented in this section have been obtained by running both VTM and STRN post-processing single threaded on the CPU. Apart from the fast encoder search described above, our implementation has not been optimized in terms of runtimes. In particular, the decoder operates without the parallel processing described above, which is intended for hardware implementations and real-time applications.

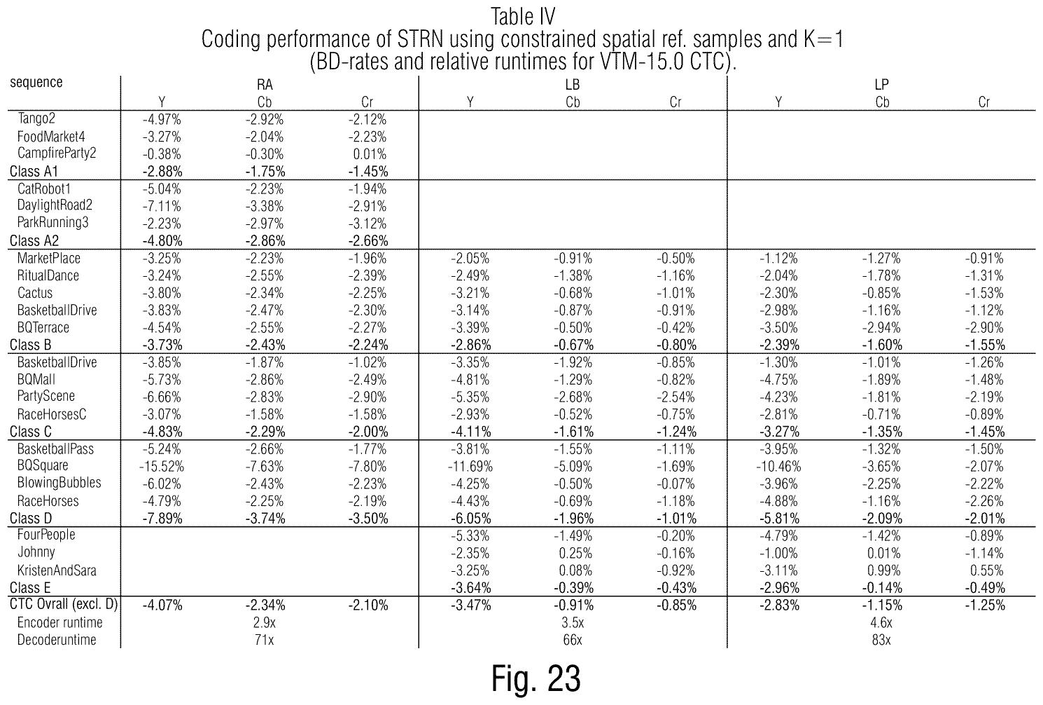

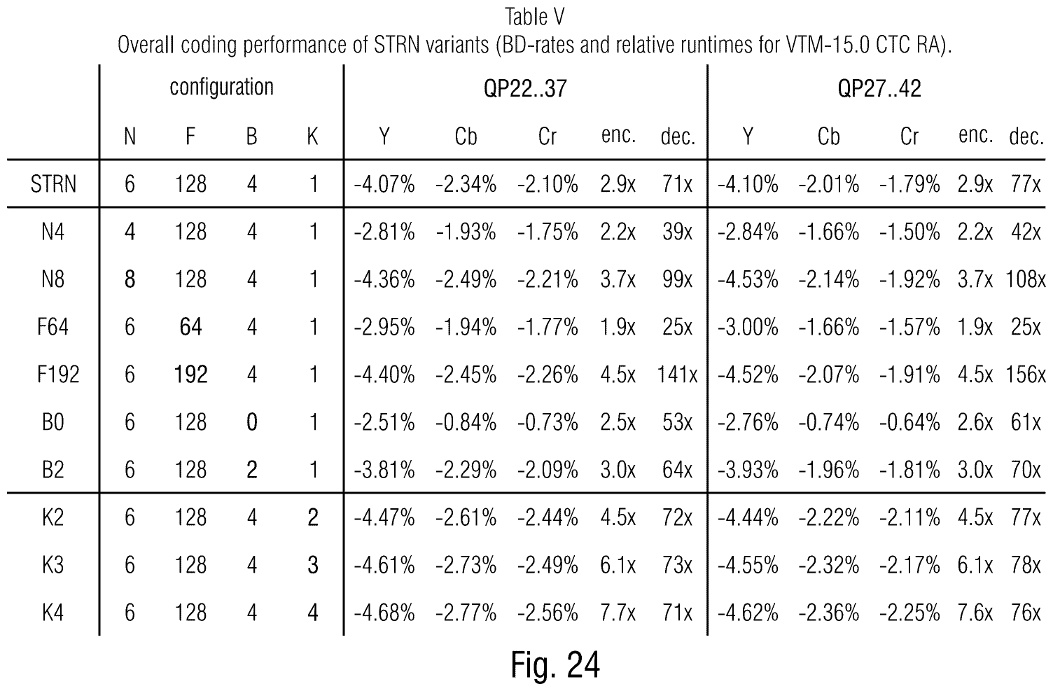

Table IV in FIG. 23 shows the coding gains as the Bjntegaard delta (BD) [46], [47] rate of the CTC sequences and the overall coding performance for the RA, low-delay B (LB), and lowdelay P (LP) configurations. While the training dataset only contains samples for certain block shapes and QPs under RA configuration, the results in Table IV demonstrate that STRN achieves substantial coding gains for different coding structures and for being applied to all block shapes (using the default QP range 22 . . . 37). The additional results in Table V in FIG. 24 show, that STRN performs equally well for the high QP range 27 . . . 42 with an overall luma BD-rate of more than 4%.

Table III in FIG. 22 shows the coding performance of IPRN and STRN together with important intermediate steps during the development of the proposed solution. For assessing the effect of polyphase decomposition 144 and decoupling from the intra decoding loop in more detail, the table additionally contains an analysis of MAC operations and sample usage. The number of MAC operations may depend on the network configuration (number of weights) and on the block shape (if B>0), so that theoretical minimum and maximum values are achieved for the largest and smallest block shapes, respectively. Both the average MAC per pixel and the average sample usage are measured for all blocks and all pictures of decoded CTC bitstreams, with sample usage indicating the portion of luma samples covered by blocks for which IPRN or STRN is applied. Comparing the overall results of IPRN with configurations (a) and (b) in FIG. 22 highlights that polyphase decomposition 144 either leads to a dramatic complexity reduction with a slightly lower coding gain (for the same number of feature channels), or to a significant increase in coding gain with about the same complexity (for twice the number of feature channels). Note that configuration (b) uses the same trained model as STRN, but is still part of the intra decoding loop in VVC, since input array C₂ contains unconstrained spatial reference samples. Configuration (c) in FIG. 22 is a solution for decoupling STRN from the intra decoding loop by completely omitting spatial reference samples, i.e. B=0. Compared to configuration (b), however, this results in a substantial decrease in coding gain. In our proposed solution, STRN uses constrained spatial reference samples instead, which leads to slightly less coding gain than configuration (b), but has the advantage that STRN post-processing is decoupled from the intra decoding loop. All the remaining results described in the following are based on STRN and consequently use constrained spatial reference samples.

The effect of polyphase decomposition 144 and spatial reference samples on improving the prediction signal has already been illustrated by the inference-based evaluation in FIGS. 19A-D. Regarding these results, the cross-shaped structure in the center of the block of all three configurations should not go unmentioned. Further investigation showed that this effect stems from DMVR, namely the 16×16 subblocks that use sample padding instead of reconstructed samples along the border of the L0 and L1 prediction signals. These areas tend to have a higher MSE in prediction P and, consequently, a higher MSE reduction (improvement) after applying IPRN or STRN.

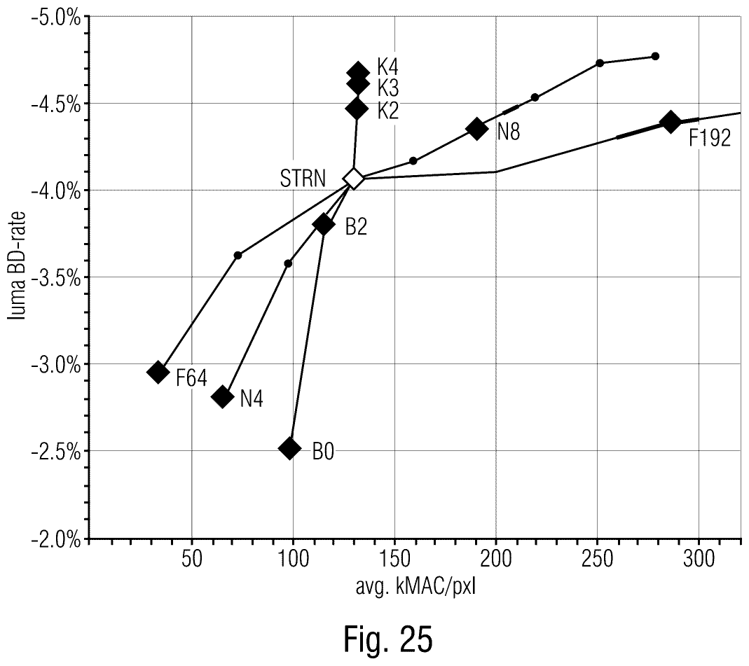

FIG. 25 and Table V in FIG. 24 compare the coding performance of the default STRN configuration with variants that have a different number of layers N, number of feature channels F, spatial reference size B, or encoder list length K. Table V presents BD-rates and relative runtimes for both the default and the high QP range, while the diagram in FIG. 25 shows luma BDrates versus average MAC per pixel and contains additional variants for N and F. Even though decoder runtimes and average MAC per pixel are strongly correlated, only the latter can be exactly reproduced for a given set of bitstreams, as it is independent of the simulation environment. Hence, MAC per pixel is more suitable for assessing the complexity overhead of STRN. The results for varying N, F, and B confirm that our default STRN configuration is a good tradeoff between coding gain and complexity. When targeting a configuration with lower complexity, reducing the number of feature channels F shows a better trade-off than reducing the number of layers N or the spatial reference size B. When targeting a configuration with higher coding gain, however, increasing the encoder list length K shows an interesting trade-off: Additional coding gains are achieved without an appreciable increase in decoding complexity. Increasing K corresponds to testing additional coding modes with STRN post-processing at the encoder, which results in noticeably higher encoder runtimes. For example, the variant with K=2 has about the same coding gain and encoder runtime as the variant with F=192, but only half the decoding complexity.

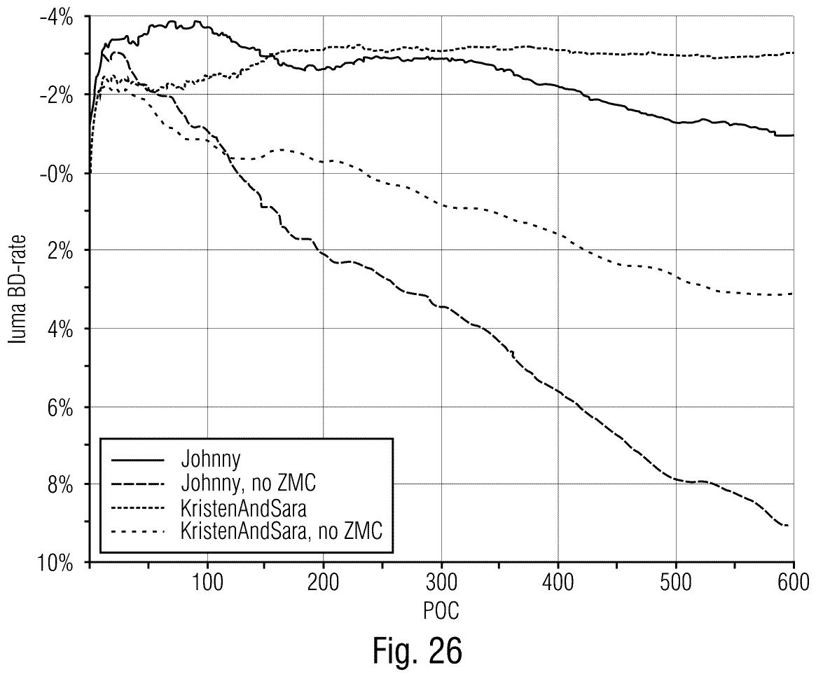

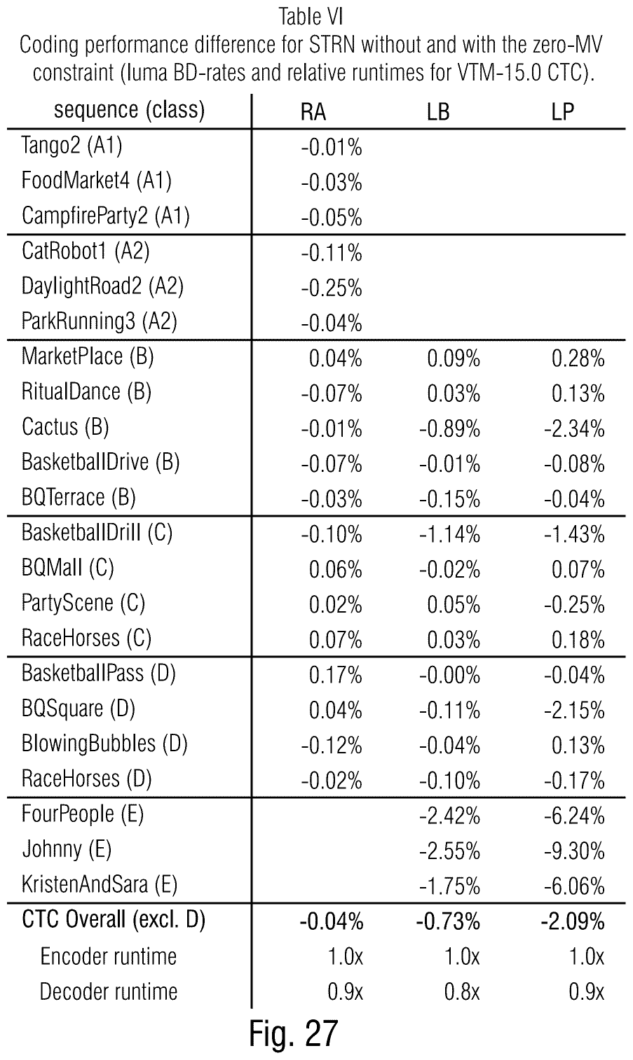

FIG. 26 and Table VI in FIG. 27 study the effect of the zero-MV constraint introduced above, focusing on the low-delay configurations LB and LP. Note that the zero-MV constraint is also considered in the training process by using a dataset that either includes or excludes training samples of blocks that meet the zero-MV condition. Before adding the zero-MV constraint to the conditions for applicable blocks, we observed that STRN leads to a considerable coding loss for the class E sequences when using the LP configuration. Further investigation revealed that STRN post-processing can result in a gradual signal degradation. This effect is illustrated by the diagram in FIG. 26, which shows how the average luma BD-rate changes over the length of the sequence: Both curves without the zero-MV constraint (dashed lines) feature a gradual decrease in coding efficiency that accumulates to considerable losses. The fact that class E sequences are very static and have large areas of constant background and that the LP configuration is limited to uni-prediction, results in situations, where the STRN post-processing is applied to the exact same signal over and over. The examples in FIG. 26 show that this effect is almost completely eliminated by adding the zero-MV constraint, i.e. omitting STRN post-processing for blocks that have a motion vector equal to zero. The results in Table VI in FIG. 27 further confirm that the zero-MV constraint improves the coding performance of the challenging sequences for the low-delay configurations without affecting the coding performance of the other sequences or the RA configuration.

In this application, we presented an approach for refining the prediction signal of inter blocks in state-of-the-art video coding via a spatio-temporal residual CNN (STRN), e.g., the neural network 130 shown in FIG. 13 or FIG. 15. With our previous work in [14] as a starting point, the architecture has been improved by adding polyphase decomposition 144 of the input tensor prior to the first convolution layer. It has been shown theoretically and experimentally that polyphase decomposition 144 increases the area of a block, e.g., the current block 18, that can benefit from the spatial reference samples while reducing the computational complexity (worst case and effective MAC per pixel). Compared to IPRN without polyphase decomposition 144, this results either in almost four times less complexity and slightly lower coding gain or, by doubling the number of feature channels, in about the same complexity and significantly higher coding gain.

STRN has been integrated into the inter coding process of the VVC standard, using the inter prediction signal of a block, i.e. P_{inter,18} of the current block 18, together with spatial and temporal reference samples to compile the input tensor 146, which is then forward propagated through the trained network 130, resulting in the refined prediction signal, i.e.. the post-processed inter-prediction signal

$${P}_{inter , 18}^{*}$$

for the current block 18. The same model, e.g., the neural network 130, is used for all coding modes, block shapes, and QPs. Moreover, STRN is supported for most of the inter prediction modes and mandatory for all applicable blocks, with an average sample usage of about 68%.

Including spatial reference samples in the inter prediction process is challenging: The additional dependency on reconstructed blocks in the same picture would make parallel decoding of STRN blocks impossible. They would become part of the intra decoding loop, which contradicts the fundamental design of the VVC decoding process and is not feasible for real-time decoder implementations. In our solution, STRN has been decoupled from the intra decoding loop by prohibiting reconstructed samples of intra blocks in the input array C₂ and by using a special reference sample buffer that contains intermediate reconstructed samples for STRN blocks. With these constraints, a slightly lower coding gain is achieved, but STRN blocks can be decoded independently of the intra blocks and in parallel.

STRN has been implemented in the VTM reference software and under CTC, an average coding gain of −4.07% luma BD-rate is achieved for the RA configuration with about 3 times the encoder and 70 times the decoder runtime. However, our implementation has not been optimized in terms of runtimes and the coding experiments have been performed single threaded on the CPU. An experimental evaluation confirmed that the default STRN configuration (N=6, F=128, and B=4) is a good trade-off between coding gain and complexity, and that additional coding gains can be achieved for K>1 without an appreciable increase in decoding complexity.

For low-delay prediction structures, a gradual signal degradation effect has been observed with STRN. We have shown that this effect can be mitigated successfully by adding the zero-MV constraint to the conditions for blocks to which STRN is applicable. As a result, STRN achieves consistent and substantial coding gains for all configurations.

Although some aspects have been described as features in the context of an apparatus it is clear that such a description may also be regarded as a description of corresponding features of a method. Although some aspects have been described as features in the context of a method, it is clear that such a description may also be regarded as a description of corresponding features concerning the functionality of an apparatus.

Some or all of the method steps may be executed by (or using) a hardware apparatus, like for example, a microprocessor, a programmable computer or an electronic circuit. In some embodiments, one or more of the most important method steps may be executed by such an apparatus.

Depending on certain implementation requirements, embodiments of the invention can be implemented in hardware or in software or at least partially in hardware or at least partially in software. The implementation can be performed using a digital storage medium, for example a floppy disk, a DVD, a Blu-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. The data carrier, the digital storage medium or the recorded medium are typically tangible and/or non-transitory.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are performed by any hardware apparatus.

The apparatus described herein may be implemented using a hardware apparatus, or using a computer, or using a combination of a hardware apparatus and a computer.

The methods described herein may be performed using a hardware apparatus, or using a computer, or using a combination of a hardware apparatus and a computer.

In the foregoing Detailed Description, it can be seen that various features are grouped together in examples for the purpose of streamlining the disclosure. This method of disclosure is not to be interpreted as reflecting an intention that the claimed examples need more features than are expressly recited in each claim. Rather, as the following claims reflect, subject matter may lie in less than all features of a single disclosed example. Thus the following claims are hereby incorporated into the Detailed Description, where each claim may stand on its own as a separate example. While each claim may stand on its own as a separate example, it is to be noted that, although a dependent claim may refer in the claims to a specific combination with one or more other claims, other examples may also include a combination of the dependent claim with the subject matter of each other dependent claim or a combination of each feature with other dependent or independent claims. Such combinations are proposed herein unless it is stated that a specific combination is not intended. Furthermore, it is intended to include also features of a claim to any other independent claim even if this claim is not directly made dependent to the independent claim.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

### REFERENCES

[1] ITU-T, “H.261: Video codec for audiovisual services at p×384 kbit/s”, March 1993, available from ITU-T at https://www.itu.int/rec/T-REC-H. 261.
[2] ITU-T and ISO/IEC, “Versatile Video Coding”, July 2020, available from ITU-T at https://www.itu.int/rec/T-REC-H.266 and from ISO/IEC at https://www.iso.org/standard/73022.html.
[3]B. Bross, Y.-K. Wang, Y. Ye, S. Liu, J. Chen, G. J. Sullivan, and J.-R. Ohm, “Overview of the Versatile Video Coding (VVC) standard and its applications”, IEEE Transactions on Circuits and Systems for Video Technology, vol. 31, no. 10, pp. 3736-3764, 2021, doi:10.1109/TCSVT.2021.3101953.
[4]B. Girod, “Efficiency analysis of multihypothesis motion-compensated prediction for video coding”, IEEE Transactions on Image Processing, vol. 9, no. 2, pp. 173-183, 2000, doi:10.1109/83.821595.
[5] ISO/IEC JTC/SC29, “Coded representation of picture, audio and multimedia/hypermedia information”, Committee Draft of standard ISO/IEC 11172, December 1991.
[6] ITU-T and ISO/IEC, “Advanced Video Coding”, August 2004, available from ITU-T at https://www.itu.int/rec/T-REC-H.264 and from ISO/IEC at https://www.iso.org/standard/61490.html.
[7]W.-J. Chien, L. Zhang, M. Winken, X. Li, R.-L. Liao, H. Gao, C.-W. Hsu, H. Liu, and C.-C. Chen, “Motion vector coding and block merging in the Versatile Video Coding standard”, IEEE Transactions on Circuits and Systems for Video Technology, vol. 31, no. 10, pp. 3848-3861, 2021, doi:10.1109/TCSVT.2021.3101212.
[8]A. Alshin, E. Alshina, and T. Lee, “Bi-directional optical flow for improving motion compensation”, in 28th Picture Coding Symposium, 2010, pp. 422-425, doi:10.1109/PCS.2010.5702525.
[9]H. Yang, H. Chen, J. Chen, S. Esenlik, S. Sethuraman, X. Xiu, E. Alshina, and J.

Luo, “Subblock-based motion derivation and inter prediction refinement in the Versatile Video Coding standard”, IEEE Transactions on Circuits and Systems for Video Technology, vol. 31, no. 10, pp. 3862-3877, 2021, doi:10.1109/TCSVT.2021.3100744.
[10]H. Liu, Y. Chen, J. Chen, L. Zhang, and M. Karczewicz, “Local illumination compensation”, document VCEG-AZ06, ITU-T Q.6/SG 16 (VCEG), 2015.
[11]C.-W. Seo and J.-K. Han, “Pixel based illumination compensation for inter prediction in HEVC”, Electronics letters, vol. 47, no. 23, pp. 1278-1280, 2011, doi:10.1049/el.2011.2524.
[12] ITU-T and ISO/IEC, “High Efficiency Video Coding”, August 2021, available from ITU-T at https://www.itu.int/rec/T-REC-H.265 and from ISO/IEC at https://www.iso.org/standard/75484.html.
[13]G. Tech, Y. Chen, K. Müller, J.-R. Ohm, A. Vetro, and Y.-K. Wang, “Overview of the multiview and 3D extensions of High Efficiency Video Coding”, IEEE Transactions on Circuits and Systems for Video Technology, vol. 26, no. 1, pp. 35-49, 2016, doi:10.1109/TCSVT.2015.2477935.
[14]P. Merkle, M. Winken, J. Pfaff, H. Schwarz, D. Marpe, and T. Wiegand, “Intra-inter prediction for Versatile Video Coding using a residual convolutional neural network”, in 2022 IEEE International Conference on Image Processing (ICIP), 2022, pp. 1711-1715, doi:10.1109/ICIP46576.2022.9897324.
[15]Y. LeCun, B. Boser, J. S. Denker, D. Henderson, R. E. Howard, W. Hubbard, and L. D. Jackel, “Backpropagation applied to handwritten zip code recognition”, Neural Computation, vol. 1, no. 4, pp. 541-551, December 1989, doi:10.1162/neco.1989.1.4.541.
[16]G. Lu, W. Ouyang, D. Xu, X. Zhang, C. Cai, and Z. Gao, “DVC: An end-to-end deep video compression framework”, in 2019 IEEE/CVF Conference on Computer Vision and Pattern Recognition (CVPR), 2019, pp. 10 998-11 007, doi:10.1109/CVPR.2019.01126.
[17]A. Djelouah, J. Campos, S. Schaub-Meyer, and C. Schroers, “Neural inter-frame compression for video coding”, in 2019 IEEE/CVF International Conference on Computer Vision (ICCV), 2019, pp. 6420-6428, doi:10.1109/ICCV.2019.00652.
[18]E. Agustsson, D. Minnen, N. Johnston, J. Ball, S. J. Hwang, and G. Toderici, “Scale-space flow for end-to-end optimized video compression”, in 2020 IEEE/CVF Conference on Computer Vision and Pattern Recognition (CVPR), 2020, pp. 8500-8509, doi:10.1109/CVPR42600.2020.00853.
[19]N. Yan, D. Liu, H. Li, B. Li, L. Li, and F. Wu, “Convolutional neural network-based fractional-pixel motion compensation”, IEEE Transactions on Circuits and Systems for Video Technology, vol. 29, no. 3, pp. 840-853, 2019, doi:10.1109/TCSVT.2018.2816932.
[20]L. Murn, S. Blasi, A. F. Smeaton, and M. Mrak, “Improved CNN-based learning of interpolation filters for low-complexity inter prediction in video coding”, IEEE Open Journal of Signal Processing, vol. 2, pp. 453-465, 2021, doi:10.1109/OJSP.2021.3089439.
[21]W. Cui, T. Zhang, S. Zhang, F. Jiang, W. Zuo, Z. Wan, and D. Zhao, “Convolutional neural networks based intra prediction for HEVC”, in 2017 Data Compression Conference (DCC), 2017, pp. 436-436, doi:10.1109/DCC.2017.53.
[22]J. Pfaff, P. Helle, D. Maniry, S. Kaltenstadler, W. Samek, H. Schwarz, D. Marpe, and T. Wiegand, “Neural network based intra prediction for video coding,” in Applications of Digital Image Processing XLI, ser. Society of Photo-Optical Instrumentation Engineers (SPIE) Conference Series, vol. 10752, September 2018, p. 1075213, doi:10.1117/12.2321273.
[23]M. M. Alam, T. D. Nguyen, M. T. Hagan, and D. M. Chandler, “A perceptual quantization strategy for HEVC based on a convolutional neural network trained on natural images”, in Applications of Digital Image Processing XXXVIII, A. G. Tescher, Ed., vol. 9599, International Society for Optics and Photonics. SPIE, 2015, p. 959918, doi:10.1117/12.2188913.
[24]Y. Zhang, T. Shen, X. Ji, Y. Zhang, R. Xiong, and Q. Dai, “Residual highway convolutional neural networks for in-loop filtering in HEVC”, IEEE Transactions on Image Processing, vol. 27, no. 8, pp. 3827-3841, 2018, doi:10.1109/TIP.2018.2815841.
[25]C. Jia, S. Wang, X. Zhang, S. Wang, J. Liu, S. Pu, and S. Ma, “Content-aware convolutional neural network for in-loop filtering in High Efficiency Video Coding”, IEEE Transactions on Image Processing, vol. 28, no. 7, pp. 3343-3356, 2019, doi:10.1109/TIP.2019.2896489.
[26]Z. Huang, J. Sun, X. Guo, and M. Shang, “One-for-all: An efficient variable convolution neural network for in-loop filter of VVC”, IEEE Transactions on Circuits and Systems for Video Technology, vol. 32, no. 4, pp. 2342-2355, 2022, doi:10.1109/TCSVT.2021.3089498.
[27]S. Ma, X. Zhang, C. Jia, Z. Zhao, S. Wang, and S. Wang, “Image and video compression with neural networks: A review”, IEEE Transactions on Circuits and Systems for Video Technology, vol. 30, no. 6, pp. 1683-1698, 2020, doi:10.1109/TCSVT.2019.2910119.
[28]D. Ding, Z. Ma, D. Chen, Q. Chen, Z. Liu, and F. Zhu, “Advances in video compression system using deep neural network: A review and case studies”, Proceedings of the IEEE, vol. 109, no. 9, pp. 1494-1520, 2021, doi:10.1109/JPROC.2021.3059994.
[29]S. Huo, D. Liu, F. Wu, and H. Li, “Convolutional neural network-based motion compensation refinement for video coding”, in IEEE International Symposium on Circuits and Systems (ISCAS), 2018, doi:10.1109/ISCAS.2018.8351609.
[30]Y. Wang, X. Fan, C. Jia, D. Zhao, and W. Gao, “Neural network based inter prediction for HEVC”, in IEEE International Conference on Multimedia and Expo (ICME), 2018, doi:10.1109/ICME.2018.8486600.
[31]Y. Wang, X. Fan, R. Xiong, D. Zhao, and W. Gao, “Neural network-based enhancement to inter prediction for video coding”, IEEE Transactions on Circuits and Systems for Video Technology, vol. 32, no. 2, pp. 826-838, 2022, doi:10.1109/TCSVT.2021.3063165.
[32]Z. Zhao, S. Wang, S. Wang, X. Zhang, S. Ma, and J. Yang, “Enhanced bi-prediction with convolutional neural network for High-Efficiency Video Coding”, IEEE Transactions on Circuits and Systems for Video Technology, vol. 29, no. 11, pp. 3291-3301, 2019, doi:10.1109/TCSVT.2018.2876399.
[33]J. Mao, H. Yu, X. Gao, and L. Yu, “CNN-based bi-prediction utilizing spatial information for video coding”, in IEEE International Symposium on Circuits and Systems (ISCAS), 2019, doi:10.1109/ISCAS.2019.8702552.
[34]J. Mao and L. Yu, “Convolutional neural network based bi-prediction utilizing spatial and temporal information in video coding”, IEEE Transactions on Circuits and Systems for Video Technology, vol. 30, no. 7, pp. 1856-1870, 2020, doi:10.1109/TCSVT.2019.2954853.
[35]Z. Zhang, X. Fan, D. Zhao, and W. Gao, “CNN-based inter prediction refinement for AVS3”, in IEEE International Conference on Multimedia Expo Workshops (ICMEW), 2020, doi:10.1109/ICMEW46912.2020.9106017.
[36]J. Zhang, C. Jia, M. Lei, S. Wang, S. Ma, and W. Gao, “Recent development of AVS video coding standard: AVS3”, in Picture Coding Symposium (PCS), 2019, doi:10.1109/PCS48520.2019.8954503.
[37]D. Jin, J. Lei, B. Peng, W. Li, N. Ling, and Q. Huang, “Deep affine motion compensation network for inter prediction in VVC”, IEEE Transactions on Circuits and Systems for Video Technology, vol. 32, no. 6, pp. 3923-3933, 2022, doi:10.1109/TCSVT.2021.3107135.
[38]J. Blackburn and M. N. Do, “Two-dimensional geometric lifting”, in 2009 16th IEEE International Conference on Image Processing (ICIP), 2009, pp. 3817-3820, doi:10.1109/ICIP.2009.5414291.
[39]W. Shi, J. Caballero, F. Huszbr, J. Totz, A. P. Aitken, R. Bishop, D. Rueckert, and Z. Wang, “Real-time single image and video super-resolution using an efficient sub-pixel convolutional neural network”, in 2016 IEEE Conference on Computer Vision and Pattern Recognition (CVPR), 2016, pp. 1874-1883, doi:10.1109/CVPR.2016.207.
[40]D. P. Kingma and J. Ba, “Adam: A method for stochastic optimization”, in 3rd International Conference on Learning Representations (ICLR), May 2015, doi:10.48550/arXiv.1412.6980.
[41]A. Paszke, S. Gross, F. Massa, A. Lerer, J. Bradbury, G. Chanan, T. Killeen, Z. Lin, N. Gimelshein, L. Antiga, A. Desmaison, A. Kopf, E. Yang, Z. DeVito, M. Raison, A. Tejani, S. Chilamkurthy, B. Steiner, L. Fang, J. Bai, and S. Chintala, “PyTorch: An imperative style, high-performance deep learning library”, in Advances in Neural Information Processing Systems 32. Curran Associates, Inc., 2019, pp. 8024-8035, doi:10.48550/arXiv.1912.01703.
[42] X. Glorot and Y. Bengio, “Understanding the difficulty of training deep feedforward neural networks”, in Proceedings of the 13th International Conference on Artificial Intelligence and Statistics (AISTATS), ser. JMLR Proceedings, vol. 9. JMLR.org, May 2010, pp. 249-256, available: http://proceedinqs.mlr.press/v9/qlorot10a/qlorot10a.pdf, [Online; accessed December 2022].
[43]“VVC reference software version 15.0”, Available: https://vcgit.hhi.fraunhofer.de/jvet/VVCSoftware VTM, [Online; accessed December 2022].
[44]F. Zhang, D. Ma, and D. Bull, “BVI-DVC: A training database for deep video compression”, April 2020, doi:10.5523/bris.3hj4t64fkbrgn2ghwp9en4vhtn.
[45]F. Bossen, J. Boyce, K. Suehring, X. Li, and V. Seregin, “VTM common test conditions and software reference configurations for SDR video”, document JVET-T2010, ITU-T/ISO/IEC Joint Video Experts Team (JVET), October 2020.
[46]G. Bjontegaard, “Calculation of average PSNR differences between RDcurves”, document VCEG-M33, ITU-T Q.6/SG 16 (VCEG), April 2001.
[47] ITU-T and ISO/IEC, “Working practices using objective metrics for evaluation of video coding efficiency experiments”, July 2020, available from ITU-T at http://handle.itu.int/11.1002/pub/8160e8da-en and from ISO/IEC at https://www.iso.org/standard/81591.html.

1. Picture-processing tool configured to
polyphase-wisely split luma samples of a picture portion into polyphase-components to acquire a matrix per polyphase-component, and
form a tensor by cascading the matrices of the polyphase-components, and
subject the tensor to a neural network or a convolution with associating the matrices as different channels so as to acquire an output tensor composed of a concatenation of output matrices comprising one output matrix per polyphase-component, and
form, by inverse polyphase decomposition, a processed picture portion based on the output tensor.

2. Picture-processing tool according to claim 1, configured to combine the picture portion with the processed picture portion to acquire a post-processed picture portion.

3. Picture-processing tool according to claim 1, wherein the picture portion comprises a block of a picture accompanied by its spatial neighborhood, and
wherein the picture-processing tool is configured to, at the polyphase-wisely splitting, split the luma samples of the block and of the spatial neighborhood into the polyphase-components to acquire the matrix per polyphase-component.

4. Picture-processing tool according to claim 3,
wherein the processed picture portion comprises the same dimensions as the picture portion, and
wherein the picture-processing tool is configured to
combine the picture portion with the processed picture portion to acquire an intermediate signal, and
crop the intermediate signal to acquire a post-processed picture portion.

5. Picture-processing tool according to claim 3,
wherein the processed picture portion comprises the same dimensions as the picture portion, and
wherein the picture-processing tool is configured to
crop the picture portion and the processed picture portion to acquire a cropped picture portion and a cropped processed picture portion, and
combine the cropped picture portion and the cropped processed picture portion to acquire a post-processed picture portion.

6. Picture-processing tool according to claim 1, wherein the picture-processing tool is a post-processing tool for inter-predicted blocks, the picture portion being an inter-prediction of a picture block received from an inter-prediction tool of a video decoder.

7. Picture-processing tool according to claim 6, configured to,
at the polyphase-wisely splitting, further split luma samples of a corresponding portion in a reference picture into the polyphase-components to further acquire a reference matrix per polyphase-component, and
at the forming of the tensor, form the tensor by cascading the matrices and the reference matrices of the polyphase-components.

8. Picture-processing tool according to claim 1, wherein the picture portion comprises inter-predicted luma samples of a block of a picture accompanied by a spatial neighborhood of the block, and
wherein the picture-processing tool is configured to, at the polyphase-wisely splitting,
split the inter-predicted luma samples of the block and the luma samples of the spatial neighborhood into the polyphase-components to acquire the matrix per polyphase-component, and
split luma samples of a reference picture portion comprising a corresponding block and a spatial neighborhood of the corresponding block in a references picture into the polyphase-components to acquire a reference matrix per polyphase-component.

9. Picture-processing tool according to claim 8,
wherein the processed picture portion comprises the same dimensions as the picture portion, and
wherein the picture-processing tool is configured to
combine the picture portion with the processed picture portion to acquire an intermediate signal, and
crop the intermediate signal to acquire a post-processed picture portion.

10. Picture-processing tool according to claim 8,
wherein the processed picture portion comprises the same dimensions as the picture portion, and
wherein the picture-processing tool is configured to
crop the picture portion and the processed picture portion to acquire a cropped picture portion and a cropped processed picture portion, and
combine the cropped picture portion and the cropped processed picture portion to acquire a post-processed picture portion.

11. Picture-processing tool according to claim 8, wherein the luma samples of the spatial neighborhood of the block comprise intra-predicted samples and inter-predicted samples, and
wherein the picture-processing tool is configured to, before performing the polyphase-wisely splitting,
substitute the intra-predicted samples of the spatial neighborhood of the block with first substitute samples generated by inter-prediction, and/or
use the inter-predicted samples of the spatial neighborhood of the block in a version not post-processed by the picture-processing tool.

12. Picture-processing tool according to claim 1, wherein the luma samples of the picture portion comprise a two dimensional arrangement along a first direction and a second direction, wherein the second direction is perpendicular to the first direction, and
wherein the picture-processing tool is configured to, at the polyphase-wisely splitting, splitting the luma samples alternatingly in the first and second direction to different ones of the polyphase components.

13. Picture-processing tool according to claim 12, wherein the luma samples are split into four polyphase components at the polyphase-wisely splitting.

14. Picture-processing tool according to claim 1, wherein the luma samples of the picture portion comprise a two dimensional arrangement along a first direction and a second direction, wherein the second direction is perpendicular to the first direction, and
wherein the picture-processing tool is configured to, at the polyphase-wisely splitting, splitting the luma samples into even and odd samples along the first direction and the second direction to acquire four polyphase-components.

15. Picture-processing tool according to claim 1, configured to allow the picture portion to correspond to one of a plurality of picture portion dimensions.

16. Picture-processing tool according to claim 1, configured to perform a convolution of the tensor using a kernel of the neural network or the convolution, wherein the kernel does not differ for different quantization parameter values among which one is associated with the picture portion.

17. Picture-processing tool according to claim 1, wherein the neural network or the convolution comprises N layers and wherein the neural network or the convolution is configured to preform per layer convolutions followed by a rectified linear unit activation, except for a last layer of the N layers, at which the rectified linear unit activation is skipped.

18. Picture-processing tool of claim 1, configured to select
the neural-network out of a set of two or more neural-networks or
the convolution out of a set of two or more convolutions.

19. Picture-processing tool of claim 18, configured to select, controlled by a data stream, the neural-network or the convolution.

20. Picture-processing tool of claim 18, configured to select the neural-network or the convolution dependent on
a shape of the picture portion, and/or
a prediction mode associated with the picture portion, and/or
a temporal-layer of a picture comprising the picture portion, and/or
a quantization parameter value associated with the picture portion or the picture comprising the picture portion, and/or
a prediction residual signal associated with the picture portion, and/or
a picture order count difference between a reference picture and the picture comprising the picture portion, if the picture portion is associated with an inter-prediction mode, and/or
a motion vector associated with the picture portion, if the picture portion is associated with an inter-prediction mode.

21. Picture-processing tool of claim 18, wherein neural-networks of the set of two or more neural-networks differ among each other in terms of weights, biases, number of layers, type of layers and/or an input tensor format.

22. Picture-processing tool of claim 18, wherein convolutions of the set of two or more convolutions differ among each other in terms of weights, biases, type of convolution and/or an input tensor format.

23. Picture-processing tool of claim 1, configured to derive the neural-network or the convolution from a data stream.

24. Method for processing a picture, comprising
polyphase-wisely splitting luma samples of a picture portion into polyphase-components to acquire a matrix per polyphase-component, and
forming a tensor by cascading the matrices of the polyphase-components, and
subjecting the tensor to a neural network or a convolution with associating the matrices as different channels so as to acquire an output tensor composed of a concatenation of output matrices comprising one output matrix per polyphase-component, and
forming, by inverse polyphase decomposition, a processed picture portion based on the output tensor.

25. A non-transitory digital storage medium having a computer program stored thereon to perform the method for processing a picture, the method comprising
polyphase-wisely splitting luma samples of a picture portion into polyphase-components to acquire a matrix per polyphase-component, and
forming a tensor by cascading the matrices of the polyphase-components, and
subjecting the tensor to a neural network or a convolution with associating the matrices as different channels so as to acquire an output tensor composed of a concatenation of output matrices comprising one output matrix per polyphase-component, and
forming, by inverse polyphase decomposition, a processed picture portion based on the output tensor,
when said computer program is run by a computer.
